(19) United States
(12) Patent Application Publication
(10) Pub. No.: US 2014/0175247 A1
(43) Pub. Date: Jun. 26, 2014

(54) EXHAUST PIPE TETHER

(71) Applicant: John Eric Churilla, Austin, TX (US)

(72) Inventor: John Eric Churilla, Austin, TX (US)

(21) Appl. No.: 13/726,518

(22) Filed: Dec. 24, 2012

(51) Int. Cl. F16M 13/02

(52) U.S. Cl. CPC F16M 13/02
USPC 248/317

(57) ABSTRACT

An exhaust pipe tether includes a body defining a first end and a second end and at least one end piece removably engaged with at least one of the first and second ends. The body comprises a dimension, d_{b}, measured through a longest portion of the body along a central axis or through a widest portion of the body along an axis perpendicular to the central axis, and d_{b} is ≧0.5 dₑₓ, wherein dₑₓ is an exhaust pipe dimension measured through a longest portion of a cross-section of the exhaust pipe along a central axis or through a widest portion of a cross-section of the exhaust pipe along an axis perpendicular to the central axis.

### FIELD OF THE DISCLOSURE

The present disclosure relates generally to automobile accessories and more specifically, to a tether for an exhaust pipe.

### DESCRIPT OF THE RELATED ART

The automobile aftermarket accessory industry is a multi-billion dollar per year industry. Many different accessories can be found for a variety of uses. Some of these accessories are functional, some are decorative, and some are both functional and decorative.

Accordingly, new automobile accessories continue to be of interest.

### BRIEF DESCRIPTION OF THE DRAWINGS

So that the manner in which the features and advantages of the embodiments are attained and can be understood in more detail, a more particular description briefly summarized above may be had by reference to the embodiments thereof that are illustrated in the appended drawings. However, the drawings illustrate only some embodiments and therefore are not to be considered limiting of its scope as the disclosure may admit to other equally effective embodiments and uses.

FIGS. 1a-1i include various views of an exhaust pipe tether in accordance with an embodiment.

FIGS. 2a-2f include various views of another exhaust pipe tether in accordance with an embodiment.

FIGS. 3a-3d include various views of an exhaust tip assembly in accordance with an embodiment.

FIGS. 4a-4e include various views of another exhaust pipe tether in accordance with an embodiment.

FIGS. 5a-5f include various views of another exhaust pipe tether in accordance with an embodiment.

FIG. 6 includes a perspective view of another exhaust tip assembly in accordance with an embodiment.

FIGS. 7a-7e include various views of another exhaust pipe tether in accordance with an embodiment.

FIGS. 8a-8f include various views of another exhaust pipe tether in accordance with an embodiment.

FIG. 9 includes a perspective view of another exhaust tip assembly in accordance with an embodiment.

FIGS. 10a-10d include various views of an exhaust pipe tether in accordance with still another embodiment.

FIGS. 11a-11f include various views of another exhaust pipe tether in accordance with an embodiment.

FIG. 12 includes a perspective view of another exhaust tip assembly in accordance with an embodiment.

FIGS. 13a-13d include various views of another exhaust pipe tether in accordance with an embodiment.

FIG. 14a-14f include various views of another exhaust pipe tether in accordance with an embodiment.

FIG. 15 includes a perspective view of another exhaust tip assembly in accordance with an embodiment.

FIGS. 16a-16d include various views of another exhaust pipe tether in accordance with an embodiment.

FIGS. 17a-17d include various views of another exhaust pipe tether in accordance with an embodiment.

FIG. 18 includes a perspective view of another exhaust tip assembly in accordance with an embodiment.

FIGS. 19a-19d include various views of another exhaust pipe tether in accordance with an embodiment.

FIGS. 20a-20d include various views of another exhaust pipe tether in accordance with an embodiment.

FIG. 21 includes a perspective view of another exhaust tip assembly in accordance with an embodiment.

FIGS. 22a-22d include various views of an exhaust pipe tether in accordance with still another embodiment.

FIGS. 23a-23d include various views of another exhaust pipe tether in accordance with an embodiment.

FIG. 24 includes a perspective view of another exhaust tip assembly in accordance with an embodiment.

FIGS. 25a-25d include various views of another exhaust pipe tether in accordance with an embodiment.

FIGS. 26a-26d include various views of another exhaust pipe tether in accordance with an embodiment.

FIG. 27 includes a perspective view of another exhaust tip assembly in accordance with an embodiment.

FIGS. 28a-28d include various views of another exhaust pipe tether in accordance with an embodiment.

FIGS. 29a-29d include various views of another exhaust pipe tether in accordance with an embodiment.

FIG. 30 includes a perspective view of another exhaust tip assembly in accordance with an embodiment.

FIGS. 31a-31e include various views of another exhaust pipe tether in accordance with an embodiment.

FIGS. 32a-32e include various views of another exhaust pipe tether in accordance with an embodiment.

FIG. 33 includes a perspective view of another exhaust tip assembly in accordance with an embodiment.

FIGS. 34a-34b include various views of another exhaust pipe tether in accordance with an embodiment.

FIGS. 35a-35d include various views of another exhaust pipe tether in accordance with an embodiment.

FIG. 36 includes a perspective view of another exhaust tip assembly in accordance with an embodiment.

FIGS. 37a-37d include various views of another exhaust pipe tether in accordance with an embodiment.

FIGS. 38a-38d include various views of another exhaust pipe tether in accordance with an embodiment.

FIGS. 39a-39d include various views of another exhaust pipe tether in accordance with an embodiment.

FIGS. 40a-40d include various views of another exhaust pipe tether in accordance with an embodiment.

FIG. 41 includes a perspective view of another exhaust tip assembly in accordance with an embodiment.

FIGS. 42a-42h include various views of another exhaust pipe tether in accordance with an embodiment.

FIG. 43 includes a perspective view of another exhaust tip assembly in accordance with an embodiment.

FIG. 44 includes a perspective view of another exhaust tip assembly in accordance with an embodiment.

FIG. 45 includes a perspective view of another exhaust tip assembly in accordance with an embodiment.

FIGS. 46a-46d include various views of an end piece for an exhaust pipe tether in accordance with an embodiment.

FIGS. 47a-47c include various views of an end piece for an exhaust pipe tether in accordance with another embodiment.

FIGS. 48a-48c include various views of another end piece in accordance with an embodiment.

FIGS. 49a-49d include various views of yet another end piece in accordance with an embodiment.

FIGS. 50a-50d include various views of still another end piece in accordance with an embodiment.

FIGS. 51a-51c include various views of yet still another end piece in accordance with an embodiment.

FIGS. 52a-52c include various views of another end piece in accordance with an embodiment.

FIGS. 53a-53c include various views of another end piece in accordance with an embodiment.

FIGS. 54a-54c include various views of another end piece in accordance with an embodiment.

FIGS. 55a-55c include various views of another end piece in accordance with an embodiment.

FIGS. 56a-56c include various views of another end piece in accordance with an embodiment.

FIGS. 57a-57c include various views of another end piece in accordance with an embodiment.

FIGS. 58a-58c include various views of another end piece in accordance with an embodiment.

FIGS. 59a-59c include various views of another end piece in accordance with an embodiment.

FIGS. 60a-60c include various views of another end piece in accordance with an embodiment.

FIGS. 61a-61c include various views of another end piece in accordance with an embodiment.

FIGS. 62a-62c include various views of another end piece in accordance with an embodiment.

FIGS. 63a-63d include various views of another end piece in accordance with an embodiment.

FIGS. 64a-64d include various views of another end piece in accordance with an embodiment.

FIGS. 65a-65d include various views of another end piece in accordance with an embodiment.

FIGS. 66a-66c include various views of another end piece in accordance with an embodiment.

FIGS. 67a-67c include various views of another end piece in accordance with an embodiment.

FIGS. 68a-68c include various views of another end piece in accordance with an embodiment.

FIGS. 69a-69c include various views of another end piece in accordance with an embodiment.

FIGS. 70a-70c include various views of another end piece in accordance with an embodiment.

FIGS. 71a-71c include various views of another end piece in accordance with an embodiment.

FIGS. 72a-72f include various views of another end piece in accordance with an embodiment.

FIGS. 73a-73f include various views of another end piece in accordance with an embodiment.

FIGS. 74a-74f include various views of another end piece in accordance with an embodiment.

FIGS. 75a-75c include various views of another end piece in accordance with an embodiment.

FIGS. 76a-76c include various views of another end piece in accordance with an embodiment.

FIGS. 77a-77d include various views of another end piece in accordance with an embodiment.

FIGS. 78a-78d include various views of another end piece in accordance with an embodiment.

FIGS. 79a-79d include various views of another end piece in accordance with an embodiment.

FIGS. 80a-80d include various views of another end piece in accordance with an embodiment.

FIGS. 81a-81c include various views of another end piece in accordance with an embodiment.

FIGS. 82a-82f include various views of another end piece in accordance with an embodiment.

FIGS. 83a-83e include various views of another end piece in accordance with an embodiment.

FIGS. 84a-84c include various views of another end piece in accordance with an embodiment.

FIGS. 85a-85c include various views of another end piece in accordance with an embodiment.

FIGS. 86a-86f include various views of another end piece in accordance with an embodiment.

FIGS. 87a-87f include various views of another end piece in accordance with an embodiment.

FIGS. 88a-88e include various views of another end piece in accordance with an embodiment.

FIGS. 89a-80d include various views of another end piece in accordance with an embodiment.

FIGS. 90a-90d include various views of another end piece in accordance with an embodiment.

FIGS. 91a-91d include various views of another end piece in accordance with an embodiment.

FIGS. 92a-92d include various views of another end piece in accordance with an embodiment.

FIGS. 93a-93d include various views of another end piece in accordance with an embodiment.

FIGS. 94a-94d include various views of another end piece in accordance with an embodiment.

FIGS. 95a-95d include various views of another end piece in accordance with an embodiment.

FIGS. 96a-96d include various views of another end piece in accordance with an embodiment.

FIGS. 97a-97d include various views of another end piece in accordance with an embodiment.

FIGS. 98a-98d include various views of another end piece in accordance with an embodiment.

FIGS. 99a-99d include various views of another end piece in accordance with an embodiment.

FIGS. 100a-100d include various views of another end piece in accordance with an embodiment.

FIGS. 101a-101d include various views of another end piece in accordance with an embodiment.

FIGS. 102a-102d include various views of another end piece in accordance with an embodiment.

FIGS. 103a-103d include various views of another end piece in accordance with an embodiment.

FIGS. 104a-104d include various views of another end piece in accordance with an embodiment.

FIGS. 105a-105d include various views of another end piece in accordance with an embodiment.

FIGS. 106a-106d include various views of another end piece in accordance with an embodiment.

FIGS. 107a-107d include various views of another end piece in accordance with an embodiment.

FIGS. 108a-108d include various views of another end piece in accordance with an embodiment.

FIGS. 109a-109d include various views of another end piece in accordance with an embodiment.

FIGS. 110a-110d include various views of another end piece in accordance with an embodiment.

FIGS. 111a-111d include various views of another end piece in accordance with an embodiment.

FIGS. 112a-112d include various views of another end piece in accordance with an embodiment.

FIGS. 113a-113d include various views of another end piece in accordance with an embodiment.

FIGS. 114a-114d include various views of another end piece in accordance with an embodiment.

FIGS. 115a-115d include various views of another end piece in accordance with an embodiment.

FIGS. 116a-116d include various views of another end piece in accordance with an embodiment.

FIGS. 117a-117d include various views of another end piece in accordance with an embodiment.

FIGS. 118a-118d include various views of another end piece in accordance with an embodiment.

FIGS. 119a-119d include various views of another end piece in accordance with an embodiment.

FIGS. 120a-120d include various views of another end piece in accordance with an embodiment.

FIGS. 121a-121d include various views of another end piece in accordance with an embodiment.

FIGS. 122a-122d include various views of another end piece in accordance with an embodiment.

FIGS. 123a-123f include various views of another end piece in accordance with an embodiment.

FIGS. 124a-124f include various views of another end piece in accordance with an embodiment.

FIGS. 125a-125f include various views of another end piece in accordance with an embodiment.

FIGS. 126a-126f include various views of another end piece in accordance with an embodiment.

FIGS. 127a-127f include various views of another end piece in accordance with an embodiment.

FIGS. 128a-128f include various views of another end piece in accordance with an embodiment.

FIGS. 129a-129e include various views of another end piece in accordance with an embodiment.

FIGS. 130a-130d include various views of another end piece in accordance with an embodiment.

FIGS. 131a-131f include various views of another end piece in accordance with an embodiment.

FIGS. 132a-132d include various views of another end piece in accordance with an embodiment.

FIGS. 133a-133f include various views of another end piece in accordance with an embodiment.

FIGS. 134a-134f include various views of another end piece in accordance with an embodiment.

FIGS. 135a-135e include various views of another end piece in accordance with an embodiment.

FIGS. 136a-136f include various views of another end piece in accordance with an embodiment.

FIGS. 137a-137f include various views of another end piece in accordance with an embodiment.

FIGS. 138a-138f include various views of another end piece in accordance with an embodiment.

FIGS. 139a-139d include various views of another end piece in accordance with an embodiment.

FIGS. 140a-140d include various views of another end piece in accordance with an embodiment.

FIGS. 141a-141f include various views of another end piece in accordance with an embodiment.

FIGS. 142a-142f include various views of another end piece in accordance with an embodiment.

FIGS. 143a-143f include various views of another end piece in accordance with an embodiment.

FIGS. 144a-144d include various views of another end piece in accordance with an embodiment.

FIGS. 145a-145e include various views of another end piece in accordance with an embodiment.

FIGS. 146a-146d include various views of another end piece in accordance with an embodiment.

FIGS. 147a-147f include various views of another end piece in accordance with an embodiment.

FIGS. 148a-148f include various views of another end piece in accordance with an embodiment.

FIGS. 149a-149f include various views of another end piece in accordance with an embodiment.

FIGS. 150a-150f include various views of another end piece in accordance with an embodiment.

FIGS. 151a-151d include various views of another end piece in accordance with an embodiment.

FIGS. 152a-152d include various views of another end piece in accordance with an embodiment.

FIGS. 153a-153d include various views of another end piece in accordance with an embodiment.

FIGS. 154a-154d include various views of another end piece in accordance with an embodiment.

FIGS. 155a-155d include various views of another end piece in accordance with an embodiment.

FIGS. 156a-156d include various views of another end piece in accordance with an embodiment.

FIGS. 157a-157e include various views of another end piece in accordance with an embodiment.

FIGS. 158a-158d include various views of another end piece in accordance with an embodiment.

FIGS. 159a-159d include various views of another end piece in accordance with an embodiment.

FIGS. 160a-160e include various views of another end piece in accordance with an embodiment.

FIGS. 161a-161e include various views of another end piece in accordance with an embodiment.

FIGS. 162a-162e include various views of another end piece in accordance with an embodiment.

FIGS. 163a-163d include various views of another end piece in accordance with an embodiment.

FIGS. 164a-164d include various views of another end piece in accordance with an embodiment.

FIGS. 165a-165d include various views of another end piece in accordance with an embodiment.

FIGS. 166a-166f include various views of another end piece in accordance with an embodiment.

FIGS. 167a-167d include various views of another end piece in accordance with an embodiment.

FIGS. 168a-168d include various views of another end piece in accordance with an embodiment.

FIGS. 169a-169d include various views of another end piece in accordance with an embodiment.

FIGS. 170a-170d include various views of another end piece in accordance with an embodiment.

FIGS. 171a-171d include various views of another end piece in accordance with an embodiment.

FIGS. 172a-172e include various views of another end piece in accordance with an embodiment.

FIGS. 173a-173d include various views of another end piece in accordance with an embodiment.

FIGS. 174a-174d include various views of another end piece in accordance with an embodiment.

FIGS. 175a-175f include various views of another end piece in accordance with an embodiment.

FIGS. 176a-176d include various views of another end piece in accordance with an embodiment.

FIGS. 177a-177f include various views of another end piece in accordance with an embodiment.

FIGS. 178a-178d include various views of another end piece in accordance with an embodiment.

FIGS. 179a-179f include various views of another end piece in accordance with an embodiment.

FIGS. 180a-180d include various views of another end piece in accordance with an embodiment.

FIGS. 181a-181f include various views of another end piece in accordance with an embodiment.

FIGS. 182a-182d include various views of another end piece in accordance with an embodiment.

FIGS. 183a-183d include various views of another end piece in accordance with an embodiment.

FIGS. 184a-184d include various views of another end piece in accordance with an embodiment.

FIGS. 185a-185f include various views of another end piece in accordance with an embodiment.

FIGS. 186a-186f include various views of another end piece in accordance with an embodiment.

FIGS. 187a-187f include various views of another end piece in accordance with an embodiment.

FIGS. 188a-188d include various views of another end piece in accordance with an embodiment.

FIGS. 189a-189f include various views of another end piece in accordance with an embodiment.

FIGS. 190a-190f include various views of another end piece in accordance with an embodiment.

FIGS. 191a-191f include various views of another end piece in accordance with an embodiment.

FIGS. 192a-192f include various views of another end piece in accordance with an embodiment.

FIGS. 193a-193d include various views of another end piece in accordance with an embodiment.

FIGS. 194a-194f include various views of another end piece in accordance with an embodiment.

FIGS. 195a-195d include various views of another end piece in accordance with an embodiment.

FIGS. 196a-196c include various views of another end piece in accordance with an embodiment.

FIGS. 197a-197e include various views of another end piece in accordance with an embodiment.

FIGS. 198a-198f include various views of another end piece in accordance with an embodiment.

FIGS. 199a-199d include various views of another end piece in accordance with an embodiment.

FIGS. 200a-200d include various views of a body for an exhaust pipe tether in accordance with an embodiment.

FIGS. 201a-201d include various views of another body in accordance with an embodiment.

FIGS. 202a-202d include various views of another body in accordance with an embodiment.

FIGS. 203a-203d include various views of another body in accordance with an embodiment.

FIGS. 204a-204f include various views of another body in accordance with an embodiment.

FIGS. 205a-205f include various views of another body in accordance with an embodiment.

FIGS. 206a-206f include various views of another body in accordance with an embodiment.

FIGS. 207a-207f include various views of another body in accordance with an embodiment.

FIGS. 208a-208f include various views of another body in accordance with an embodiment.

FIGS. 209a-209f include various views of another body in accordance with an embodiment.

FIGS. 210a-210f include various views of another body in accordance with an embodiment.

### DETAILED DESCRIPTION

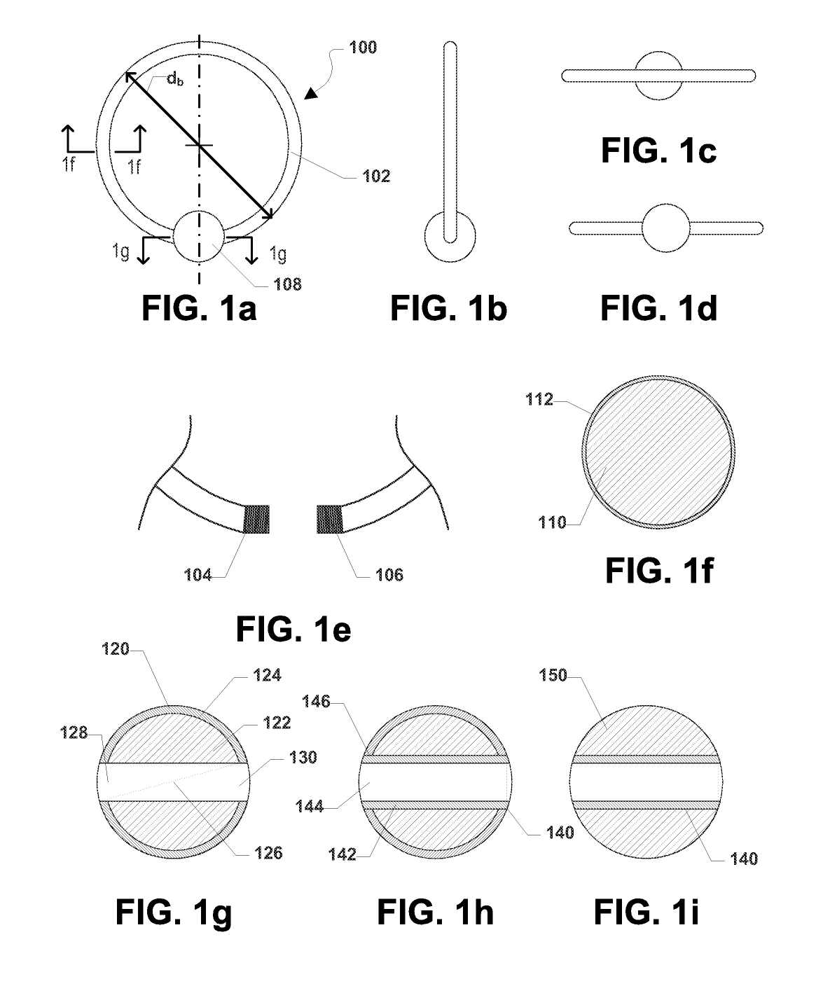

Referring initially to FIG. 1a through FIG. 1i, an embodiment of an exhaust pipe tether is shown and is generally designated 100. FIG. 1a includes a front/rear plan view of the exhaust pipe tether 100. FIG. 1b includes a left/right side plan view of the exhaust pipe tether 100. FIG. 1c includes a top plan view of the exhaust pipe tether 100 and FIG. 1d includes a bottom plan view of the exhaust pipe tether 100.

As illustrated in FIG. 1a through FIG. 1e, the exhaust pipe tether 100 can include a body 102 having a first end 104 and a second end 106. An end piece 108 can connect the ends 104, 106 of the exhaust pipe tether 100.

FIG. 1f illustrates a cross-section of the body 102 of the exhaust pipe tether 100 taken along 1f-1f in FIG. 1a. The body 102 can include a core 110 and an outer coating 112 can be disposed on the core 110 of the body 102. In a particular aspect, the outer coating 12 can include a metal coating, a polymer coating, a ceramic coating, or a vitreous coating. The metal coating can be applied using a plating process and can include chrome, nickel, copper, gold, silver, some other metal, or combination thereof. The polymer coating can be applied via a powder coating process, a dip coating process, a spray coating process, a brush coating process, or a similar process. After application of the polymer coating, the polymer coating can cured by exposing the polymer coating to an energy source such as heat or light. The light source can be infrared (IR) light or ultra-violet (UV) light. In another aspect, the polymer coating can be allowed to cure at room temperature, or ambient temperature. The ceramic coating can be applied using a pressing process, a molding process, or a similar process. The vitreous coating can be applied using a dipping process, a molding process, or another process.

Referring to FIG. 1g, a cross-section of the end piece 108 taken along line 1g-1g in FIG. 1a is illustrated. As illustrated in FIG. 1g, the end piece 108 can include a body 120. The body 120 of the end piece 108 can include a core 122 and an outer coating 124 disposed thereon. In a particular aspect, the core 122 of the body 120 of the end piece 108 can be machined, or otherwise formed, so that the body 120 of the end piece 108 can include a central bore 126. The central bore 126 formed in the body 120 of the end piece 108 can include a first end 128 and a second end 130.

In a particular aspect, as indicated in FIG. 1e, while the majority of the body 102 is curved, the first and second ends 104, 106 of the body 102 of the exhaust pipe tether 100 can be generally straight (i.e., linear) and can extend along a straight axis that is substantially perpendicular to a central axis 132 defined by the exhaust pipe tether 100 about which the exhaust pipe tether 100 can be substantially symmetrical from left-to-right.

As further indicated in FIG. 1e, the first end 104 of the body 102 of the exhaust pipe tether 100 can be machined, or otherwise formed, so that the first end 104 of the body 102 can include left-handed male threads. The second end 106 of the body 102 can be machined, or otherwise formed, so that the second end 106 of the body 102 can include right-handed male threads. The first end 128 of the central bore 126 within the body 120 of the end piece 108 can be machined, or otherwise formed, so that the first end 128 of the central bore 126 can include left-handed female threads. Further, the second end 130 of the central bore 126 within the body 120 of the end piece 108 can be machined, or otherwise formed, so that the second end 130 of the central bore 126 can include right-handed female threads. Accordingly, the central bore 126 formed within the body 120 of the end piece 108 can include left-handed internal threads and right-handed internal threads.

As such, the end piece 108, e.g., the ends 128, 130 of the central bore 126 formed in the body 120 of the end piece 108, can be simultaneously threaded, and installed, on the ends 104, 106 of the body 102 of the exhaust pipe tether 100. As the end piece 108 is threadably engaged with the ends 104, 106 of the body 102 of the exhaust pipe tether 100, the end piece 108 can draw the ends 104, 106 of the body 102 together—similar to a turn buckle.

In a particular aspect, in a resting state, before the end piece 108 is installed on the body 102 of the exhaust pipe tether 100, the ends 104, 106 of the body 102 of the tether 100 can be spaced apart a first distance, d₁. In order to accommodate the end piece 108, the body 102 of the tether 100 can be opened up slightly so that the ends 104, 106 of the body 102 of the tether 100 can be spaced apart a second distance, d₂, and d₂ can be >d₁. For example, d₂ can be ≧1.25 d₁, such as ≧1.5 d₁, ≧1.75 d₁, or ≧2 d₁. Further, d₂ can be ≦4 d₁, such as ≦3.5 d₁, or ≦3 d₁. Moreover, d₂ can be within a range between and including any of the maximum or minimum values of d₂ described herein. For example, d₂ can be ≧1.25 d₁ and ≦4 d₁ such as ≧1.25 d₁ and ≦3.5 d₁, or ≧1.25 d₁ and ≦3 d. Further, d₂ can be ≧1.5 d₁ and ≦4 d₁ such as ≧1.5 d₁ and ≦3.5 d₁ or ≧1.5 d₁ and ≦3 d₁. Moreover, d₂ can be ≧1.75 d₁ and ≦4 di, such as ≧1.75 d₁ and ≦3.5 d₁, or ≧1.75 d₁ and ≦3 d₁. Still further, d₂ can be ≧2 d₁ and ≦4 d₁, such as ≧2 d₁ and ≦3.5 d₁, or ≧2 d₁ and ≦3 d₁.

In a particular aspect, the outer coating 124 of the body 120 of the end piece 108 can include a metal coating, a polymer coating, a ceramic coating, or a vitreous coating. The metal coating can be applied to the core 122 of the body 120 of the end piece 108 using a plating process and can include chrome, nickel, copper, gold, silver, some other metal, or combination thereof. The polymer coating can be applied via a powder coating process, a dip coating process, a spray coating process, a brush coating process, or a similar process. After application of the polymer coating, the polymer coating can cured by exposing the polymer coating to an energy source such as heat or light. The light source can be infrared (IR) light or ultra-violet (IN) light. In another aspect, the polymer coating can be allowed to cure at room temperature, or ambient temperature, by allowing the passage of time. The ceramic coating can be applied using a pressing process, a molding process, or a similar process. The vitreous coating can be applied using a dipping process, a molding process, or another process. The outer coating 124 on core 122 of the body 120 of the end piece 108 can be the same as, or different from, the outer coating 112 on the core 110 of the body 102 of the exhaust pipe tether 100.

In another aspect, as illustrated in FIG. 1h, the end piece 108 can include a threaded insert 140 that can be press-fitted, or otherwise installed, within the bore 126 formed in the body 120 of the end piece. The threaded insert 140 can be generally cylindrical and can include a sidewall 142. The sidewall 142 can include an inner surface 144 that can be formed with left-handed internal threads and right-handed internal threads, as described above in conjunction with the threaded bore. The sidewall 142 can also include an outer surface 146 that can be knurled, or otherwise machined to include projections or keying features can prevent the threaded insert 140 from rotating within the core 122 of the body 120 of the end piece 108. In another aspect, as illustrated in FIG. 1i, the end piece 108 can include a polymeric body 150 that can be molded, or otherwise formed, around the threaded insert. The end piece 108 including the threaded insert 140 can be installed on the ends 104, 106 of the body 102 of the exhaust pipe tether 100 as described above.

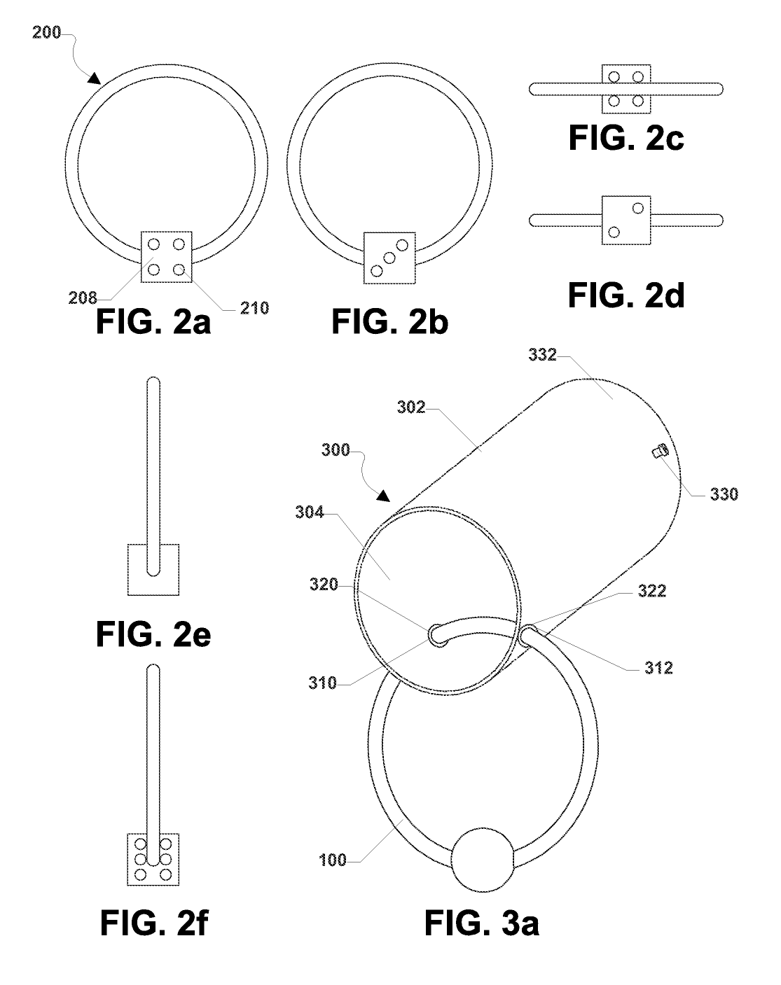

In a particular aspect, as shown in FIG. 1a through FIG. 1i, the end piece 108 can be generally spherical. However, in another aspect, as depicted in FIG. 2a through FIG. 2f, an exhaust pipe tether 200 can include an end piece 208 that is generally cubic. Further, the end piece 208 can include a plurality of pips 210 so that the end piece 208 can resemble a die. Any of the end pieces described herein can include polymer molded around a core or a threaded insert.

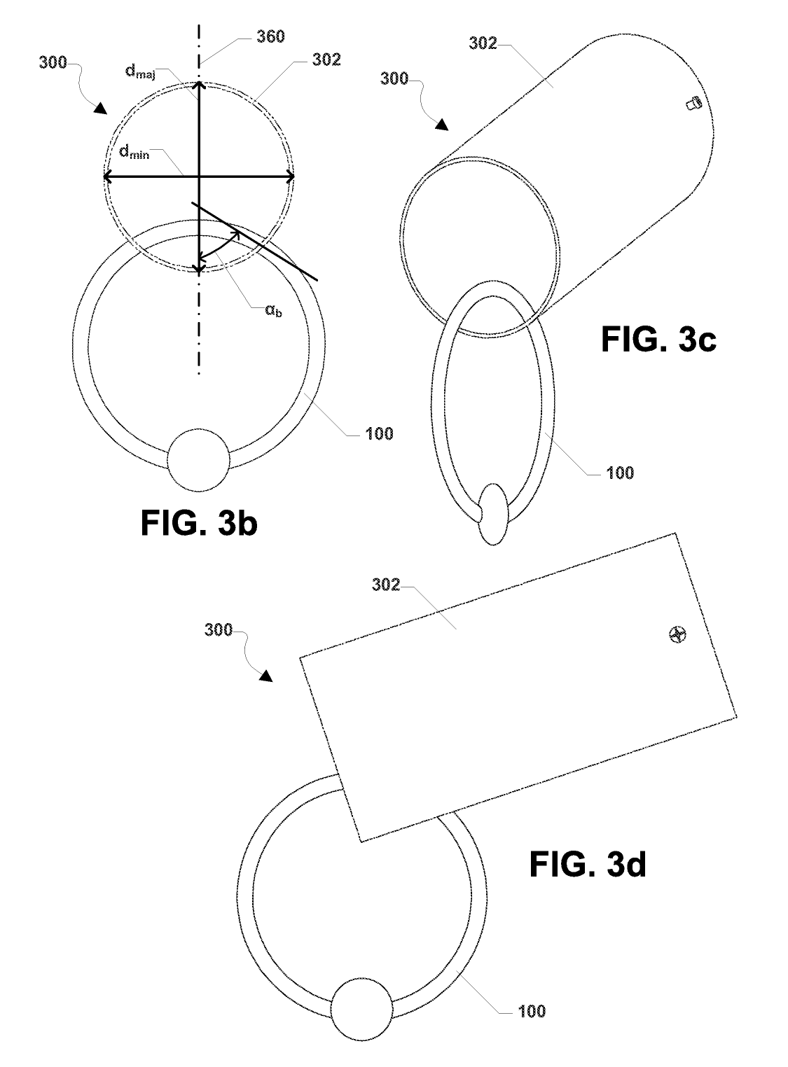

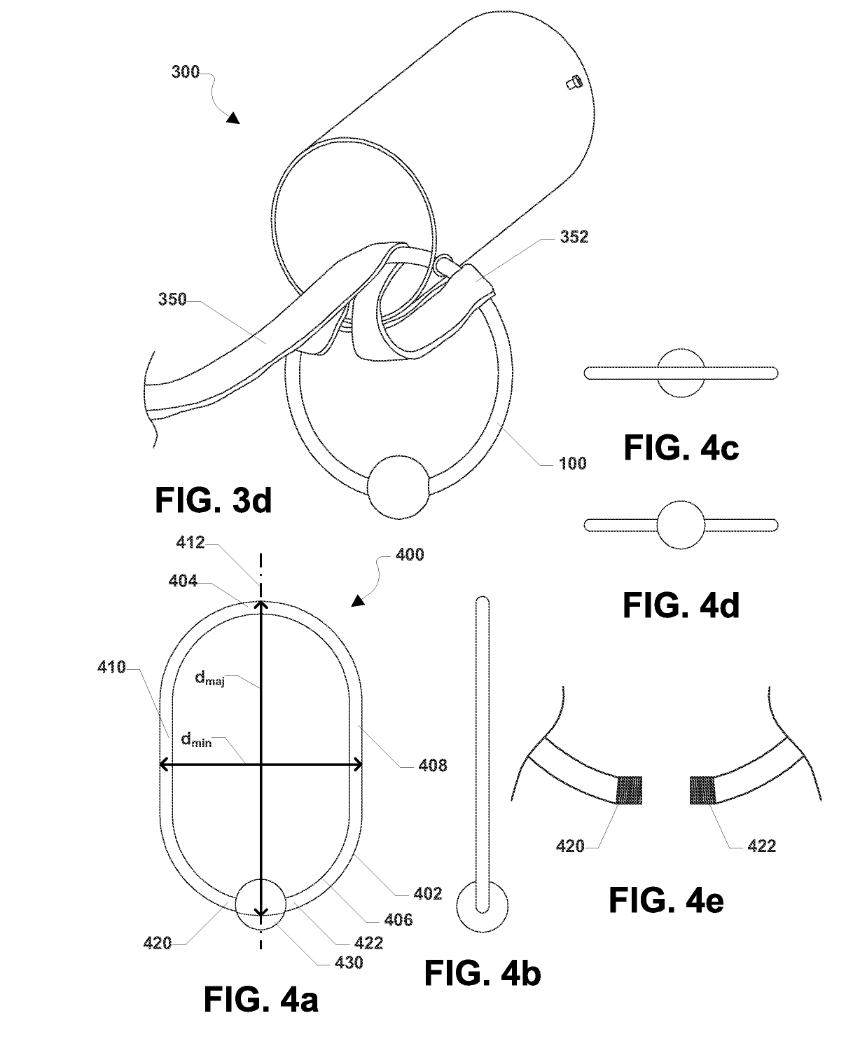

FIG. 3a through FIG. 3d illustrate an exhaust tip assembly that is generally designated 300. The exhaust tip assembly 300 can include an exhaust tip 302 having an outlet end 304. Moreover, the exhaust tip 302 can include an outer wall 306 that can be drilled, machined, punched, or otherwise formed, with a first bore 310 and a second bore 312 near the outlet end 304 of the exhaust tip 302. A first grommet 320 can be installed, or otherwise disposed, in the first bore 310 and a second grommet 322 can be installed, or otherwise disposed, in the second bore 312. Each grommet 320, 322 can be made from a polymer such as a high temperature silicone. Further, each grommet 320, 322 can be clear or opaque. In another aspect, each grommet 320, 322 can be any color.

FIG. 3a through 3d indicate that the exhaust tip 302 can include a plurality of fasteners 330 installed in an end 332 of the exhaust tip 302 opposite the outlet end 304. The fasteners can be screws, bolts, nut/bolt combinations, rivets, other fasteners, or a combination thereof. The exhaust tip assembly 300 can be fitted over, or onto, an end of a vehicle exhaust pipe (not shown) and the fasteners 330 can be used to secure the exhaust tip assembly 300 to the vehicle exhaust pipe.

As depicted in FIG. 3, an exhaust pipe tether, e.g., the exhaust pipe tether 100 illustrated in FIG. 1a through FIG. 1i, or any of the other embodiments of an exhaust pipe tether described herein, can be installed in the exhaust tip 302 near the outlet end 304 of the exhaust tip 302. Specifically, the body 102 of the exhaust pipe tether 100 can be inserted, or otherwise installed, through the first bore 310 and the second bore 312 such that the exhaust pipe tether 100 is substantially perpendicular to a long axis of the exhaust tip 302. More particularly, the body 102 of the exhaust pipe tether 100 can be installed through the first grommet 320 disposed in the first bore 310 and through the second grommet 322 disposed in the second bore 312. Thereafter, the end piece 108 can be threadably engaged with the ends 104, 106 of the body 102 of the end piece 108. It can be appreciated that in lieu of threads, the ends 104, 106 of the body 102 can be press fitted into the end piece 108 or slip fitted into the end piece 108 and welded thereto. Further, the threads formed on the body 102 of the exhaust pipe tether 100 and/or the threads formed in the end piece 108 can be coated with a thread locking adhesive to decrease the likelihood of the end piece 108 disengaging from the body 102 of the exhaust pipe tether 100.

It can be appreciated that the grommets 320, 322 can be prevent any rattle or noise caused by a loose fit between the exhaust pipe tether 100 and the bores 310, 312 formed in the exhaust tip 302. However, the grommets 320, 322 can be eliminated by reducing the fit between the exhaust pipe tether 100 and the bores 310, 312 formed in the exhaust tip 302. In another aspect, if the outer coating 112 on the body 102 of the exhaust pipe tether 100 is polymeric, the outer coating 112 may also reduce any noise or rattle between the body 102 of the exhaust pipe tether 100 and the exhaust tip 302 and in such an aspect, the grommets 320, 322 may be eliminated from the exhaust tip assembly 300.

As depicted in FIG. 3c and FIG. 3d, the exhaust pipe tether 100 can be installed through a single hole formed near the bottom of the exhaust tip 302 such that the exhaust pipe tether 100 is substantially parallel to the long axis of the exhaust tip 302. The single hole can also include a grommet.

As described and illustrated in greater detail below, in various aspects and depending on the style of the exhaust pipe tether, the exhaust pipe tether can be installed in the bottom half of the exhaust tip, in the top half of the exhaust tip, horizontally through a horizontal midpoint of the exhaust tip, horizontally through a line that is offset, or distanced, from the midpoint of the exhaust tip either above or below the horizontal midpoint, vertically through a vertical midpoint of the exhaust tip, and/or vertically through a line that is offset, or distanced, from the vertical midpoint of the exhaust tip either above or below the horizontal midpoint.

Depending on the orientation of the exhaust pipe tether on the exhaust tip, the bore, or bores, formed in the tail pipe 302 can be perpendicular to the sidewall of the exhaust tip 302 or slightly angled with respect to the sidewall of the tail pipe. Specifically, each bore can form and angle, α_{b}, with respect to a central axis 360 of the exhaust tip 302. In a particular aspect, at, can be ≧40°, such as ≧45°, ≧50°, or ≧60′. Moreover, α_{b} can be ≦90°, such as ≦85°, or ≦70° In another aspect, α_{b} can be within a range between and including any of the maximum and minimum values of α_{b} described herein. For example, α_{b} can be ≧40° and ≦90°, such as ≧40° and ≦85°, or ≧40° and ≦70°. Further, α_{b} can be ≧50° and ≦90°, such as ≧50° and ≦8.5°, or ≧50° and ≦70°. Additionally, α_{b} can be ≧60° and ≦90°, such as ≧60° and ≦85°, or ≧60° and ≦70°.

Accordingly, the exhaust pipe tether 100 can hang from the exhaust tip 302, or extend through the exhaust tip 302, near the outlet end 304 of the exhaust tip 302. Moreover, as illustrated in FIG. 3d, the exhaust pipe tether 100 can provide a convenient place to secure an animal leash, e.g., a dog leash 350, when a vehicle on which the exhaust tip assembly 300 is installed is parked. In a particular non-limiting aspect, as shown in FIG. 3d, a handle end 352 of the dog leash 350 can be looped around the exhaust pipe tether 100 to secure the dog leash 350 to the exhaust pipe tether 100 without having to tie the handle end 352 of the dog least 350 to the exhaust pipe tether 100. The shape of the exhaust pipe tether 100, the size of the exhaust pipe tether 100, the shape of end piece 108, the size of the end piece 108 relative to the body 102 of the exhaust pipe tether 100, or a combination thereof can substantially prevent the handle end 352 of the dog leash 350 from slipping off the exhaust pipe tether 100 and disengaging from the exhaust pipe tether 100.

In another aspect (not shown), the handle end 352 of the dog leash 350 can be tied around the body 102 of the exhaust pipe tether 100 and then, the handle end 352 can be looped over the exhaust pipe tether 100 to substantially prevent the dog leash 350 from become untied and disengaged from the exhaust pipe tether 100. Again, the shape of the exhaust pipe tether 100, the size of the exhaust pipe tether 100, the shape of end piece 108, the size of the end piece 108 relative to the body 102 of the exhaust pipe tether 100, or a combination thereof can substantially prevent the handle end 352 of the dog leash 350 from slipping off the exhaust pipe tether 100.

It can be appreciated that the exhaust pipe tether 100 can be installed directly on an outlet end of a vehicle exhaust pipe without using the exhaust tip 302 by drilling the exhaust pipe near the outlet end of the exhaust pipe, installing one or more grommets within the holes drilled in the exhaust pipe, and inserting the exhaust pipe tether 100 through the holes drilled in the exhaust pipe or through the grommets installed in the holes drilled in the exhaust pipe. In such an embodiment, the vehicle exhaust pipe can have cross-sectional shapes and dimensions similar to the cross-sectional shapes and dimensions described herein for the exhaust tip.

In particular aspect, the exhaust tip 302 can have a diameter, dₑₓ, and dₑₓ can be ≧1.0 inches, such as ≧1.5 inches, ≧2.0 inches, ≧2.5 inches, ≧3.0 inches, ≧3.5 inches, or ≧4.0 inches. In another aspect, dₑₓ can be ≦8.0 inches, ≦7.5 inches, ≦7.0 inches, ≦6.5 inches, or ≦6.0 inches. It can be appreciated that dₑₓ can be within a range between and including of any of the minimum or maximum values of dₑₓ described herein. For example, dₑₓ can be ≧1.0 inches and ≦8.0 inches, such as ≧1.0 inches and ≦7.5 inches, ≧1.0 inches and ≦7.0 inches, ≧1.0 inches and ≦6.5 inches, or ≧1.0 inches and ≦6.0 inches. In another aspect, dₑₓ can be ≧1.5 inches and ≦8.0 inches, such as ≧1.5 inches and ≦7.5 inches, ≧1.5 inches and ≦7.0 inches, ≧1.5 inches and ≦6.5 inches, or ≧1.5 inches and ≦6.0 inches. Further, dₑₓ can be ≧2.0 inches and ≦8.0 inches, such as ≧2.0 inches and ≦7.5 inches, ≧2.0 inches and ≦7.0 inches, ≧2.0 inches and ≦6.5 inches, or ≧2.0 inches and ≦6.0 inches. In yet another aspect, dₑₓ can be ≧2.5 inches and ≦8.0 inches, such as ≧2.5 inches and ≦7.5 inches, ≧2.5 inches and ≦7.0 inches. ≧2.5 inches and ≦6.5 inches, or ≧2.5 inches and ≦6.0 inches, dₑₓ can also be ≧3.0 inches and ≦8.0 inches, such as ≧3.0 inches and ≦7.5 inches, ≧3.0 inches and ≦7.0 inches, ≧3.0 inches and ≦6.5 inches, or ≧3.0 inches and ≦6.0 inches. Moreover, dₑₓ can be ≧3.5 inches and ≦8.0 inches, such as ≧3.5 inches and ≦7.5 inches, ≧3.5 inches and ≦7.0 inches, ≧3.5 inches and ≦6.5 inches, or ≧3.5 inches and ≦6.0 inches. In still another aspect, dₑₓ can be ≧4.0 inches and ≦8.0 inches, such as ≧4.0 inches and ≦7.5 inches, ≧4.0 inches and ≦7.0 inches, ≧4.0 inches and ≦6.5 inches, or ≧4.0 inches and ≦6.0 inches.

In a particular aspect, the exhaust tip 302 can be made of aluminum tubing, mild steel tubing, galvanized steel tubing, stainless steel tubing, titanium tubing, another appropriate metal or a combination thereof. Further, the exhaust tip 302 can have a wall thickness, tₑₓ, and tₑₓ, can be ≧24 gauge, ≧22 gauge, ≧20 gauge, ≧18 gauge. ≧16 gauge, ≧14 gauge, or ≧12 gauge. In another aspect, tₑₓ can be ≦4 gauge, ≦6 gauge, ≦8 gauge, or ≦10 gauge. It can be appreciated that tₑₓ can be within a range between and including of any of the maximum or minimum gauges described herein.

For example, in one aspect, t, can be ≧24 gauge and ≦4 gauge, such as ≧24 gauge and ≦6 gauge, ≧24 gauge and ≦8 gauge, or ≧24 gauge and ≦10 gauge. In another aspect, tₑₓ can be ≧22 gauge and ≦4 gauge, such as ≧22 gauge and ≦6 gauge, ≧22 gauge and ≦8 gauge, or ≧22 gauge and ≦10 gauge. In still another aspect, tₑₓ can be ≧20 gauge and ≦4 gauge, such as ≧20 gauge and ≦6 gauge, ≧20 gauge and ≦8 gauge, or ≧20 gauge and ≦10 gauge. In yet another aspect, tₑₓ can be ≧18 gauge and ≦4 gauge, such as ≧18 gauge and ≦6 gauge, ≧18 gauge and ≦8 gauge, or ≧18 gauge and ≦10 gauge. Further, tₑₓ can be ≧16 gauge and ≦4 gauge, such as ≧16 gauge and ≦6 gauge, ≧16 gauge and ≦8 gauge, or ≧16 gauge and ≦10 gauge. Moreover, tₑₓ can be ≧14 gauge and ≦4 gauge, such as ≧14 gauge and ≦6 gauge, ≧14 gauge and ≦8 gauge, or ≧14 gauge and ≦≦10 gauge. In another aspect, tₑₓ can be ≧12 gauge and ≦4 gauge, such as ≧12 gauge and ≦6 gauge, ≧12 gauge and ≦8 gauge, or ≧12 gauge and ≦10 gauge.

As indicated in FIG. 3, the exhaust tip 302 can have a cross section that is generally circular. However, the exhaust tip 302 can also have a cross section that is generally oval, generally rectangular, generally square, or some other shape. In the case of an oval exhaust tip, a rectangular exhaust tip, a square exhaust tip, or other shaped exhaust tip, the exhaust tip (or exhaust pipe) can have a dimension, dₑₓ, e.g., a length measured through a longest portion of the cross-section of the exhaust tip (or exhaust pipe) along a central axis or a width measured through a widest portion of the cross-section of the exhaust tip (or exhaust pipe) along an axis perpendicular to the central axis, that is substantially the same as dₑₓ.

FIG. 1a through FIG. 1i indicate that the body 102 of the exhaust pipe tether 100 can be generally ring-shaped, or circular. Further, the body 102 of the exhaust pipe tether 100 can have a major dimension, d_{b}, e.g., a diameter, a length measured through a longest portion along a central axis, or a width measured through a widest portion along an axis perpendicular to the central axis. In a particular aspect, d_{b}, can be ≧0.5 dₑₓ, such as ≧1.0 dₑₓ, ≧1.5 dₑₓ, or ≧2.0 dₑₓ. In another aspect, d_{b} can be ≦4.0 dₑₓ, ≦3.5 dₑₓ, or ≦3.0 dₑₓ. It can be appreciated that dc can be within a range between and including any of the d_{b} values described herein. For example, d_{b} can be ≧0.5 dₑₓ and ≦4.0 dₑₓ, such as ≦0.5 dₑₓ and ≦3.5 dₑₓ, or ≧0.5 dₑₓ and ≦3.0 dₑₓ. Further, d_{b} can be ≧1.0 dₑₓ and ≦4.0 dₑₓ, such as ≧1.0 dₑₓ and ≦3.5 dₑₓ, or ≧1.0 dₑₓ and ≦3.0 dₑₓ. In another aspect, d_{b} can be ≧1.5 dₑₓ and ≦4.0 dₑₓ, such as ≧1.5 dₑₓ and ≦3.5 dₑₓ, or ≧1.5 dₑₓ and ≦3.0 dₑₓ. Additionally, ≧2.0 dₑₓ and ≦4.0 dₑₓ, such as ≧2.0 dₑₓ and ≦3.5 dₑₓ, or ≧2.0 dₑₓ and ≦3.0 dₑₓ.

As described in detail and illustrated in the appended drawings, each tether can include a body having various shapes. Each of the tether bodies can have a major dimension that can be substantially the same as d_{b}. Further, each of these embodiments can have a minor dimension that can be substantially the same as d_{b}. In a particular aspect, the major dimension can be the overall dimension taken along the long axis of the end piece and the minor dimension can be the overall dimension taken along the axis perpendicular to the long axis of the end piece. In certain cases, the major dimension is the same as the minor dimension.

The body 102 of the exhaust pipe tether 100 can have a cross-sectional dimension, d_{csb}, e.g., a diameter measured through a center of the body 102, a length measured along a central axis of the body 102, or a width measured along an axis perpendicular to the central axis, and d_{csb}≧tₑₓ. For example, d_{csb}≧2 tₑₓ, such as ≧4 tₑₓ, or ≧8 tₑₓ. Moreover, d_{csb} can be ≦64 to, such as =32 tₑₓ, or ≦16 tₑₓ. It can be appreciated that d_{csb} can be within a range between and including any of the d_{csb} values described herein. For example, d_{csb} can be ≧2 tₑₓ and ≦64 tₑₓ, such as ≧2 tₑₓ and ≦32 tₑₓ, or ≧2 tₑₓ and ≦16 tₑₓ. In another aspect, d_{csb} can be ≧4 tₑₓ and ≦64 tₑₓ, such as ≧4 tₑₓ and ≦32 tₑₓ, or ≧4 tₑₓ and ≦16 tₑₓ. In another aspect, d_{csb} can be ≧8 tₑₓ and ≦64 to such as ≧8 tₑₓ and ≦32 tₑₓ, or ≧8 tₑₓ and ≦16 tₑₓ.

In another aspect, d_{csb} can be ≧⅛ inches, such as ≧ 3/16 inches, or ≧¼ inches. Further, d_{csb} can be ≦⅝ inches, such as ≦½ inches, or ≦⅜ inches. It can be appreciated that d_{csb} can be within a range between and including any of the maximum and minimum values of d_{csb} described herein. For example, d_{csb} can be ≧⅛ inches and ≦⅝ inches, such as ≧⅛ inches and ≦½ inches, or ≧⅛ inches and ≦⅜ inches. In another aspect, d_{csb} can be ≧ 3/16 inches and ≦⅝ inches, such as ≧ 3/16 inches and ≦½ inches, or ≧ 3/16 inches and ≦⅜ inches. Further, d_{csb} can be ≧¼ inches and ≦⅝ inches, such as ≧¼ inches and ≦½ inches, or ≧¼ inches and ≦⅜ inches.

As illustrated in FIG. 1f, the cross-section of the body 102 of the exhaust pipe tether 100 is generally circular. However, it can be appreciated that the cross-section of the body 102 can be generally oval, generally triangular, generally square, generally rectangular, or generally n-side polygonal. The alternative cross-sectional shapes can have a major dimension, or a minor dimension, that is generally the same as d_{csb}.

In a particular aspect, the end piece 108 can have a major dimension, dₑₚ, e.g., a diameter measured through a center of the end piece, a length measured through a longest portion of the end piece 108 along a central axis (or an axis parallel to the central axis), or a width measured through a widest portion of the end piece 108 along an axis perpendicular to the central axis, and dₑₚ can be ≧0.04 d_{b}, such as ≧0.08 d_{b}, ≧0.12 d_{b}, ≧0.16 d_{b}, ≧0.2 d_{b}, ≧0.25 d_{b}, or ≧0.33 d_{b}. Further, dₑₚ can be ≦20 d_{b}, such as ≦1.5 d_{b}, ≦1.0 d_{b}, ≦0.75 d_{b}, or ≦0.5 d_{b}. It can be appreciated that dₑₚ can be within a range between and including any of the maximum or minimum values of dₑₚ described herein.

For example, dₑₚ can be ≧0.04 d_{b} and ≦2.0 d_{b}, such as ≧0.08 d_{b} and ≦2.0 d_{b}, ≧0.12 d_{b} and ≦2.0 d_{b}, ≧0.16 d_{b} and ≦2.0 d_{b}, ≧0.2 d_{b} and ≦2.0 d_{b}, ≧0.25 d_{b} and ≦2.0 d_{b}, or ≧0.33 d_{b} and ≦2.0 d_{b}. Further, dₑₚ can be ≧0.04 d_{b} and ≦1.5 d_{b}, such as 0.08 d_{b} and ≦1.5 d_{b}, ≧0.12 d_{b} and ≦1.5 d_{b}, ≧0.16 d_{b} and ≦1.5 d_{b}, ≧0.2 d_{b} and ≦1.5 d_{b}, ≧0.25 d_{b} and ≦1.5 d_{b}, or ≧0.33 d_{b} and ≦1.5 d_{b}. In another aspect, dₑₚ can be ≧0.04 d_{b} and ≦1.0 d_{b}, such as ≧0.08 d_{b} and ≦1.0 d_{b}, ≧0.12 d_{b} and ≦1.0 d_{b}, 0.16 d_{b} and ≦1.0 d_{b}, ≧0.2 d_{b} and ≦1.0 d_{b}, ≧0.25 d_{b} and ≦1.0 d_{b}, or ≧0.33 dr, and ≦1.0 d_{b}. In still another aspect, dₑₚ can be ≧0.04 d_{b} and ≦0.75 d_{b}, such as ≧0.08 d_{b} and ≦0.75 d_{b}, ≧0.12 d_{b} and ≦0.75 d_{b}, ≧0.16 d_{b} and ≦0.75 d_{b}, ≧0.2 d_{b} and ≦0.75 d_{b}, ≧0.25 d_{b} and ≦0.75 d_{b}, or ≧0.33 d_{b} and ≦0.75 d_{b}. Moreover, dₑₚ can be ≧0.04 d_{b} and ≦0.5 d_{b}, such as ≧0.08 d_{b} and ≦0.5 d_{b}, ≧0.12 d_{b} and ≦0.5_{b}, ≧0.16 d_{b} and ≦0.5 d_{b}, ≧0.2 d_{b} and ≦0.5 d_{b}, ≧0.25 d_{b} and ≦0.5 d_{b}, or ≧0.33 d_{b} and ≦0.5 d_{b}.

In another aspect, dₑₚ, can be >d_{csb}. For example, dₑₚ, can be ≧2 d_{csb}, such as ≧4 d_{csb}, or ≧6 d_{csb}. Conversely, dₑₚ, can be ≦16 d_{b}, such as ≦14 d_{b}, or ≦12 d_{b}. Further, dₑₚ, can be within a range between and including any of the maximum and minimum values of dₑₚ described herein. For example, dₑₚ, can be ≧2 d_{csb} and ≦16 d_{csb}, such as ≧2 d_{csb} and ≦14 d_{csb}, or ≧2 d_{csb}, and ≦12 d_{csb}. In another aspect, dₑₚ can be ≧4 d_{csb}, and ≦16 d_{csb}, such as ≧4 d_{csb}, and ≦14 d_{csb}, or ≧4 d_{csb}, and ≦12 d_{csb}. Moreover, dₑₚ can be ≧6 d_{csb} and ≦16 d_{csb}, such as ≧6 d_{csb} and ≦14 d_{csb}, or ≧6 d_{csb} and ≦12 d_{csb}.

In another aspect, dₑₚ can be ≧½ inches, such as ≦¾ inches, or ≧1 inches. Further, dₑₚ can be ≦4 inches, ≦3½ inches, ≦3 inches, ≦2½ inches, or ≦2 inches. It can be appreciated that dₑₚ can be within a range between and including any of the maximum and minimum values of dₑₚ described herein.

For example, dₑₚ can be ≧½ inches and ≦4 inches, such as ≧½ inches and ≦3½ inches, ≧½ inches and ≦3 inches, ≧½ inches and ≦2½ inches, or ≧½ inches and ≦2 inches. In another aspect, dₑₚ can be 2¾ inches and ≦4 inches, such as ≧¾ inches and ≦3½ inches, ≧¾ inches and ≦3 inches, ≧¾ inches and ≦2½ inches, or ≧¾ inches and ≦2 inches. Further, dₑₚ can be ≧1 inches and ≦4 inches, such as ≧1 inches and ≦3½ inches, ≧1 inches and ≦3 inches, ≧1 inches and ≦2½ inches, or ≧1 inches and ≦2 inches.

In a particular aspect, as best illustrated in FIG. 3b, the opening of the exhaust tip 302 (or exhaust pipe) can have a cross-sectional area, Aₑₓ, perpendicular to a longitudinal axis. The exhaust pipe tether 100, when installed in the exhaust tip 302, can block a portion of Aₑₓ. In a particular aspect, as illustrated in FIG. 3b, the body 102 of the exhaust pipe tether 100 can block a portion of Aₑₓ. However, in other embodiments, a body may not extend completely through the exhaust tip, an end piece can be installed on an end of the body within the exhaust tip to prevent the body from disengaging from the exhaust tip. In such embodiments, the tail pipe tether may hang vertically from the exhaust tip.

The area of the portion blocked by the exhaust pipe tether 100, A_{b}, can be ≦20% Aₑₓ, such as ≦15% Aₑₓ, or ≦10% Aₑₓ. However, A_{b}, can be ≧1% Aₑₓ, such as ≧2.5% Aₑₓ, or ≧5% Aₑₓ. Further, A_{b} can be within a range between and including any of the maximum and minimum values of A_{b} described herein.

For example, A_{b}, can be ≦20% Aₑₓ and ≧1% Aₑₓ, such as ≦20 Aₑₓ and ≧2.5% Aₑₓ or ≦20% Aₑₓ and ≧5% Aₑₓ. A_{b}, can be ≦15% Aₑₓ and ≧1% Aₑₓ, such as 15% Aₑₓ and ≧2.5% Aₑₓ, or ≦10% Aₑₓ and ≧5% Aₑₓ. Further, A_{b}, can be ≦10% Aₑₓ, and ≧1% Aₑₓ, such as ≦10% Aₑₓ, and ≧2.5% Aₑₓ, or ≦10% Aₑₓ, and ≧5% Aₑₓ.

In another aspect, the exhaust pipe tether 100 can be installed at a distance, d, measured from the center of a bore formed in the exhaust pipe 302 and the end face of the exhaust pipe 302. In this aspect, d>d_{csb}. For example, d, can be ≧2 d_{csb}, such as ≧4 d_{csb}, or ≧6 d_{csb}. Conversely, d can be ≦12 d_{csb}, such as ≦10 d_{csb}, or ≦8 d_{csb}. Further, d, can be within a range between and including any of the maximum and minimum values of d described herein.

For example, d can be ≧2 d_{csb}, and ≦12 d_{csb}, such as ≧2 d_{csb} and ≦10 d_{csb}, or ≧2 d_{csb} and ≦8 d_{csb}. In another aspect, d can be ≧4 d_{csb} and ≦12 d_{csb}, such as ≧4 d_{csb} and ≦10 d_{csb}, or ≧4 d_{csb}, and ≦8 d_{csb}. Moreover, d can be ≧6 d_{csb} and ≦12 d_{csb}, such as ≧6 dub and ≦10 d_{csb}, or ≧6 d_{csb} and ≦8 d_{csb}.

As illustrated in FIG. 1a through FIG. 1i and in FIG. 2a-FIG. 2f, and further described below, the end piece can have a variety of shapes. Each of the various end pieces can have a major dimension that can be substantially the same as dₑₚ. Further, each of these embodiments can have a minor dimension that can be substantially the same as dₑₚ. In a particular aspect, the major dimension can be the overall dimension taken along the long axis of the end piece and the minor dimension can be the overall dimension taken along the axis perpendicular to the long axis of the end piece. In certain cases, the major dimension is the same as the minor dimension.

Referring now to FIG. 4a through FIG. 4d, another embodiment of an exhaust pipe tether is shown and is generally designated 400. FIG. 4a includes a front/rear plan view of the exhaust pipe tether 400. FIG. 4b includes a left/right side plan view of the exhaust pipe tether 400. FIG. 4c includes a top plan view of the exhaust pipe tether 400 and FIG. 4d includes a bottom plan view of the exhaust pipe tether 400.

As illustrated, the exhaust pipe tether 400 includes a generally paperclip-shaped body 402 that includes a first rounded portion 404, a second rounded portion 406, and first and second sides 408, 410 extending between the ends 404, 406. The body 402 of the exhaust pipe tether 400 can also include a first end 420 and a second end 422 that are shaped and machine similar to the ends 104, 106 of the body 102 of the exhaust pipe tether 100 illustrated in FIG. 1e and described above.

In this aspect, the body 402 can include a long axis 412 and the first side 408 and the second side 410 can be parallel to the long axis 412. Further, the body 402 can include a major dimension, dₘₐⱼ, measured along the long axis 412, or an axis parallel thereto, and a minor dimension, dₘᵢₙ, measured along an axis perpendicular to the long axis 412.

In a particular aspect, dₘₐⱼ can be dₘᵢₙ, such as ≧1.25 dₘᵢₙ, ≧1.5 dₘᵢₙ, ≧1.75 dₘᵢₙ, or ≧2.0 dₘᵢₙ. Further, in another particular aspect, dₘₐⱼ can be ≦10.0 dₘᵢₙ, such as ≦7.5 dₘᵢₙ, ≦5.0 dₘᵢₙ, or ≦4.0 dₘᵢₙ. In another aspect, dₘₐⱼ can be within a range between and including any of the dₘₐⱼ values described herein.

For example, dₘₐⱼ can be ≧1.25 dₘᵢₙ and ≦10.0 dₘᵢₙ, such as ≧1.25 dₘᵢₙ and ≦7.5 dₘᵢₙ, ≧1.25 dₘᵢₙ, and ≦5.0 dₘᵢₙ, or ≧1.25 dₘᵢₙ and ≦4.0 dₘᵢₙ. Further, dₘₐⱼ can be ≧1.5 dₘᵢₙ and ≦10.0 dₘᵢₙ, such as ≧1.5 dₘᵢₙ and ≦7.5 dₘᵢₙ, ≧1.5 dₘᵢₙ and ≦5.0 dₘᵢₙ, or ≧1.5 dₘᵢₙ, and ≦4.0 dₘᵢₙ. In another aspect, dₘₐⱼ can be ≧1.75 dₘᵢₙ, and ≦10.0 dₘᵢₙ, such as ≧1.75 dₘᵢₙ and ≦7.5 dₘᵢₙ, ≧1.75 dₘᵢₙ and ≦5.0 dₘᵢₙ, or ≧1.75 dₘᵢₙ and ≦4.0 dₘᵢₙ. In yet another aspect, dₘₐⱼ can be ≧2.0 dₘᵢₙ and ≦10.0 dₘᵢₙ, such as ≧2.0 dₘᵢₙ and ≦7.5 dₘᵢₙ, ≧2.0 dₘᵢₙ and ≦5.0 dₘᵢₙ or ≧2.0 dₘᵢₙ and ≦4.0 dₘᵢₙ.

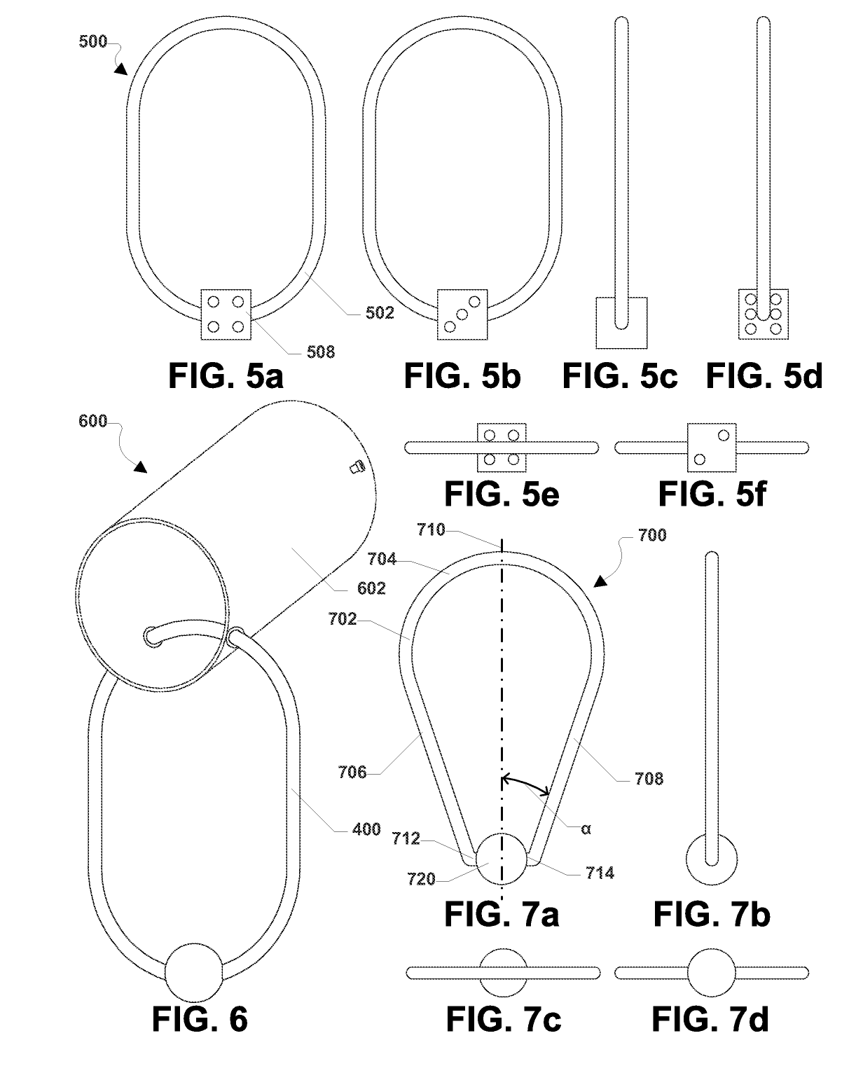

FIG. 5a through FIG. 5d illustrate another embodiment of an exhaust pipe tether that is generally designated 500. FIG. 5a includes a front plan view of the exhaust pipe tether 500. FIG. 5b includes a rear plan view of the exhaust pipe tether 500. FIG. 5c includes a left side plan view of the exhaust pipe tether 500. FIG. 5d includes a right side plan view of the exhaust pipe tether 500. FIG. 5e includes a top plan view of the exhaust pipe tether 500 and FIG. 5f includes a bottom plan view of the exhaust pipe tether 500.

As illustrated, the exhaust pipe tether 500 can include a generally paperclip-shaped body 502 similar to the body 402 described in conjunction with FIG. 4a through FIG. 4d. Further, the exhaust pipe tether 500 can include a generally cubic end piece 508 shaped to resemble a die, as described in conjunction with FIG. 2a through FIG. 2f.

FIG. 6 depicts another exhaust tip assembly that is generally designated 600. The exhaust tip assembly 600 can include an exhaust tip 602 similar to the exhaust tip 302 illustrated in FIG. 3a through FIG. 3d and described above. The exhaust tip assembly 600 can include an exhaust pipe tether, e.g., the exhaust pipe tether 400 illustrated in FIG. 4a through FIG. 4d, the exhaust pipe tether 500 shown in FIG. 5a through FIG. 5f, or any of the other embodiments of an exhaust pipe tether described herein, that can be installed in the same manner described above in conjunction with FIG. 3a through FIG. 3d. The exhaust pipe tether 400 can also be used to secure a leash as described herein.

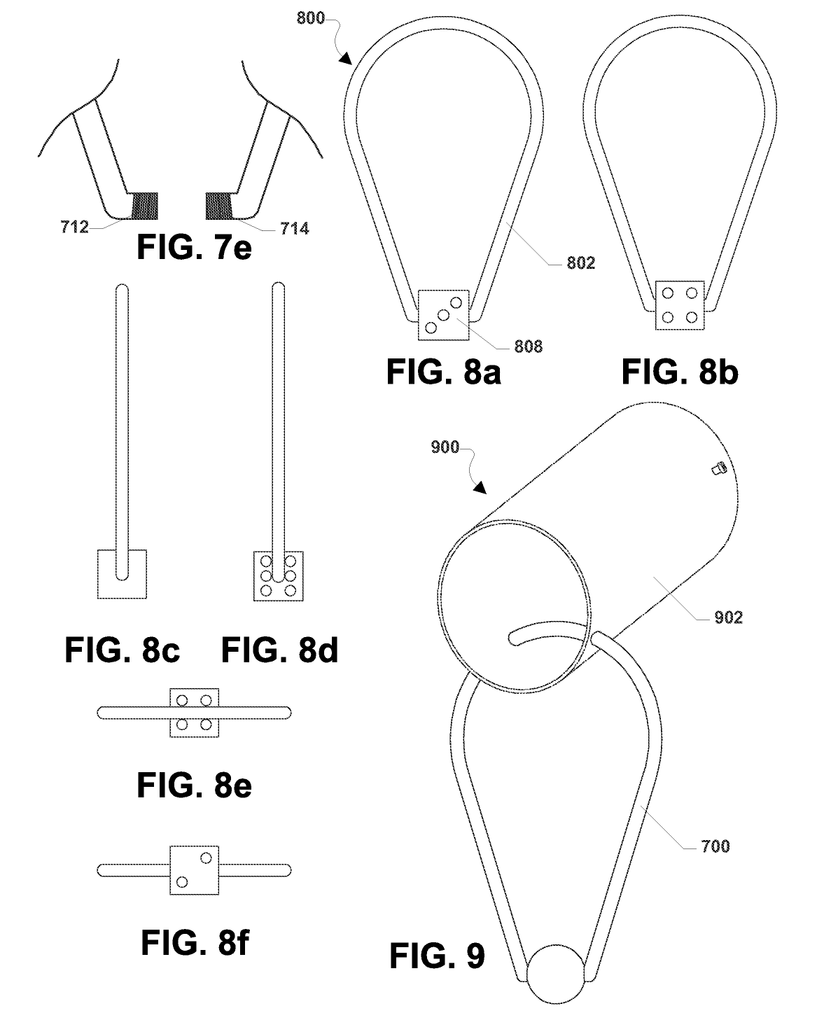

Referring now to FIG. 7a through FIG. 7d, still another embodiment of an exhaust pipe tether is shown and is generally designated 700 FIG. 7a includes a front/rear plan view of the exhaust pipe tether 700. FIG. 7b includes a left/right side plan view of the exhaust pipe tether 700. FIG. 7c includes a top plan view of the exhaust pipe tether 700 and FIG. 7d includes a bottom plan view of the exhaust pipe tether 700.

As illustrated, the exhaust pipe tether 700 includes a generally teardrop-shaped body 702 that includes a rounded portion 704. A first elongated arm 706 and a second elongated arm 708 can extend from the rounded portion 704. Each elongated arm 706, 708 can be angled inward with respect to a central long axis 710. Further, each elongated arm 706, 708 can include a distal end 712, 714 that can be generally perpendicular to the central axis 710. As shown in FIG. 7e, the distal end 712, 714 of each elongated arm 706, 708 can be formed with male threads. In particular, similar to the embodiment shown in FIG. 1e, the distal end 712 of the first elongated arm 706 can be formed with left-handed external threads, i.e., left-handed male threads. Moreover, the distal end 714 of the second elongated arm 708 can be formed with right-handed external threads, i.e., right handed male threads. As such, the ends 712, 714 of the elongated arms 706, 708 can be engaged with an end piece 720 in a manner that is substantially similar to the embodiment depicted in FIG. 1a through 1i. Specifically, the end piece 720 can draw the ends 712, 714 of the body 702 together—similar to a turn buckle.

As indicated in FIG. 7a through FIG. 7e, each elongated arm 706, 708 can form an angle, α, with respect to the central long axis 710 or an axis parallel to the central long axis 710. In a particular embodiment, α, can be ≧5.0°, such as ≧7.5°, ≧10.0°, ≧12.5°, ≧15.00, or ≧17.5°. Further, α can be ≧45.0°, such as ≦40.0°, ≦35.0°, ≦30.0°, ≦25.0°, or ≦20.0°. In another aspect, α can be within a range between and including any of the maximum or minimum values of α described herein.

For example, α can be ≧5.0° and ≦45.0°, such as ≧5.0° and ≦40.0°, ≧5.0° and ≦35.0°, ≧5.0° and ≦30.0, ≧5.0° and ≦25.0°, or ≧5.0° and ≦20.0°. Further, α can be ≧7.5° and ≦45.0°, such as ≧7.5° and ≦40.0°, ≧7.5° and ≦35.0°, ≧7.5° and ≧30.0°, ≧7.5° and ≦25.0°, or ≧7.5° and ≦20.0°. In another aspect, α can be ≧10.0° and ≦45.0°, such as ≧10.0° and ≦40.0°, ≧10.0° and ≦35.0°, ≧10.0° and ≦30.0°, ≧10° and ≦25.0°, or ≧10.0° and ≦20.0°. Moreover, α can be 12.5° and ≦45.0°, such as ≧12.5° and ≦40.0°, ≧12.5° and ≦35.0°, ≧12.5° and ≦30.0°, ≧12.5° and ≦25.0°, or ≧12.5° and ≦20.0°. In yet another aspect α can be ≧15.0° and ≦45.0°, such as ≧15.0° and ≦40.0°, ≧15.0 and ≦35.0°, ≧15.0° and ≦30.0°, ≧15.0° and ≦25.0°, or ≧15.0° and 20.0°. In yet still another aspect, α can be ≧17.5° and ≦45.0°, such as ≧17.5° and ≦40.0°, ≧17.5° and ≦35.0°, ≧17.5° and ≦30.0°, ≧17.5° and ≦25.0°, or ≧17.5° and ≦20.0°.

In this aspect, the body 702 can include a major dimension, dₘₐⱼ, measured along the long axis 710, or an axis parallel thereto, and a minor dimension, dₘᵢₙ, measured along an axis perpendicular to the long axis 710.

In a particular aspect, dₘₐⱼ can be ≧dₘᵢₙ, such as ≧1.25 dₘᵢₙ, ≧1.5 dₘᵢₙ, ≧1.75 dₘᵢₙ, or ≧2.0 dₘᵢₙ. Further, in another particular aspect, dₘₐⱼ can be ≦10.0 dₘᵢₙ, such as ≦7.5 dₘᵢₙ, ≦5.0 dₘᵢₙ, or ≦4.0 dₘᵢₙ. In another aspect, dₘₐⱼ can be within a range between and including any of the dₘₐⱼ values described herein.

For example, dₘₐⱼ can be 1.25 dₘᵢₙ and ≦10.0 dₘᵢₙ such as ≧1.25 dₘᵢₙ and ≦7.5 dₘᵢₙ, ≧1.25 dₘᵢₙ and ≦5.0 dₘᵢₙ, or ≧1.25 dₘᵢₙ and ≧4.0 dₘᵢₙ. Further, dₘₐⱼ can be ≧1.5 dₘᵢₙ and ≦10.0 dₘᵢₙ, such as ≧1.5 dₘᵢₙ and ≦7.5 dₘᵢₙ, ≧1.5 dₘᵢₙ and ≦5.0 dₘᵢₙ or ≧1.5 dₘᵢₙ, and ≦4.0 dₘᵢₙ. In another aspect, dₘₐⱼ can be ≧1.75 dₘᵢₙ and ≦10.0 dₘᵢₙ, such as ≧1.75 dₘᵢₙ and ≧7.5 dₘᵢₙ, ≧1.75 dₘᵢₙ and ≦5.0 dₘᵢₙ, or ≧1.75 dₘᵢₙ and ≦4.0 dₘᵢₙ. In yet another aspect, dₘₐⱼ can be ≧2.0 dₘᵢₙ and ≦10.0 dₘᵢₙ, such as ≧2.0 dₘᵢₙ and ≧7.5 dₘᵢₙ, ≧2.0 dₘᵢₙ and ≦5.0 dₘᵢₙ, or ≧2.0 dₘᵢₙ and ≦4.0 dₘᵢₙ.

FIG. 8a through FIG. 8f depict yet another embodiment of an exhaust pipe tether, generally designated 800. FIG. 8a includes a front plan view of the exhaust pipe tether 800. FIG. 8b includes a rear plan view of the exhaust pipe tether 800. FIG. 8c includes a left side plan view of the exhaust pipe tether 800. FIG. 8d includes a right side plan view of the exhaust pipe tether 800. FIG. 8e includes a top plan view of the exhaust pipe tether 800 and FIG. 8f includes a bottom plan view of the exhaust pipe tether 800.

As illustrated, the exhaust pipe tether 800 can include a generally teardrop-shaped body 802 similar to the body 702 described in conjunction with FIG. 7a through FIG. 7e. Further, the exhaust pipe tether 800 can include a generally cubic end piece 808 shaped to resemble a die, as described in conjunction with FIG. 2a through FIG. 2f.

FIG. 9 depicts still another exhaust tip assembly that is generally designated 900. The exhaust tip assembly 900 can include an exhaust tip 902 similar to the exhaust tip 302 illustrated in FIG. 3a through FIG. 3d and described above. Further, the exhaust tip assembly 900 can include an exhaust pipe tether, e.g., the exhaust pipe tether 700 illustrated in FIG. 7a through FIG. 7e, the exhaust pipe tether 800 shown in FIG. 8a through FIG. 8f, or any of the other embodiments of an exhaust pipe tether described herein, that can be installed in the same manner described above in conjunction with FIG. 3a through FIG. 3d. The exhaust pipe tether 700 can also be used to secure a leash as described herein.

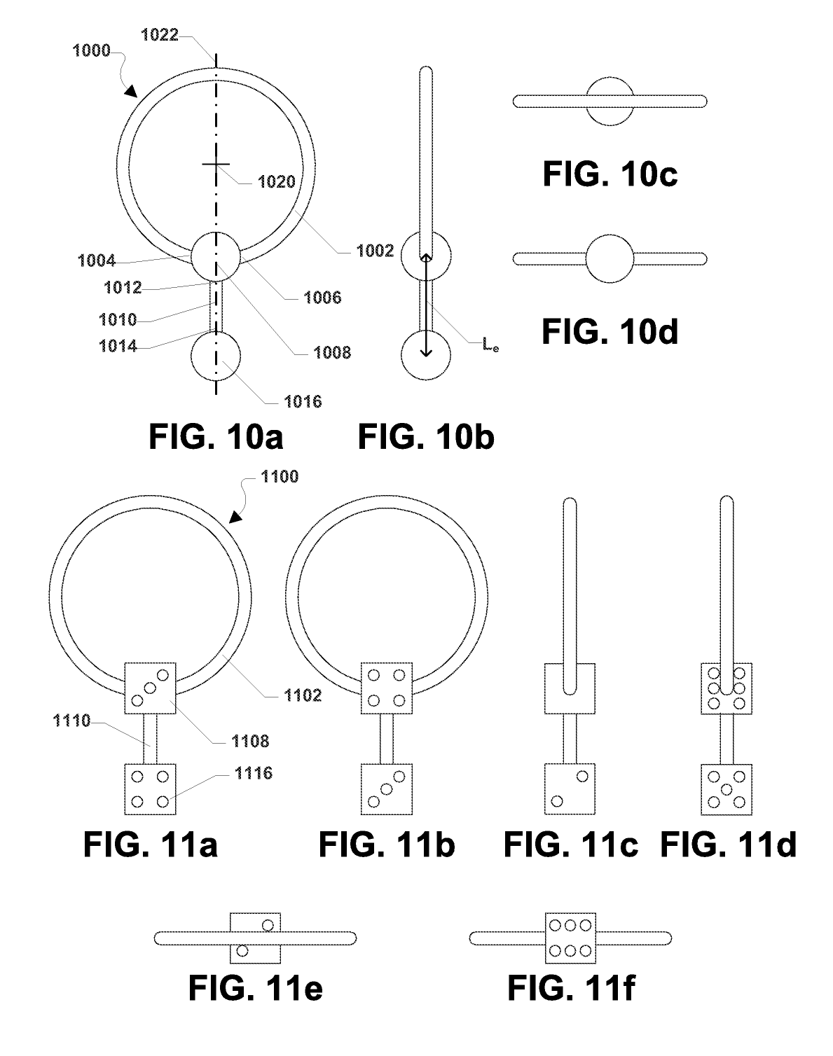

Referring initially to FIG. 10a through FIG. 10d, another embodiment of an exhaust pipe tether is shown and is generally designated 1000. FIG. 10a includes a front/rear plan view of the exhaust pipe tether 1000. FIG. 10b includes a left/right side plan view of the exhaust pipe tether 1000. FIG. 10c includes a top plan view of the exhaust pipe tether 1000 and FIG. 10d includes a bottom plan view of the exhaust pipe tether 1000.

As illustrated in FIG. 10a through FIG. 10e, the exhaust pipe tether 1000 can include a body 1002 having a first end 1004 and a second end 1006. A first end piece 1008 can connect the ends 1004, 1006 of the exhaust pipe tether 1000. In a particular aspect, the body 1002, the ends 1004, 1006, and the first end piece 1008 can be sized, shaped, machined, coated, etc., in a manner similar to the body 102, the ends 104, 106 and the end piece 108 described in conjunction with FIG. 1a through FIG. 1i.

FIG. 10a and FIG. 10b indicate that the exhaust pipe tether 1000 can further include an extension 1010 that can extend from the first end piece 1008. Specifically, the extension 1010 can include a first end 1012 and a second end 1014. The first end 1012 can be threaded to engage a threaded bore formed in the first end piece 1008. The threaded bore can be substantially perpendicular to an axis passing through the ends 1004, 1006 of the body 1002. The second end 1014 of the extension 1010 can be also be threaded and a second end piece 1016 that can be machined, or otherwise formed, with a threaded bore can be threaded onto the second end 1014 of the extension 1010 opposite the first end piece 1008.

In a particular aspect, the extension 1010 can extend downward, away from a center 1020 of the body 1002, along a center axis 1022 of the exhaust pipe tether 1000. Further, the extension 1010 can have a length, Lₑ, measured from a center of the first end piece 1008 to a center of the second end piece 1016, Lₑ can be < a diameter of the body, d_{b}. For example, Lₑ can be ≦0.75 d_{b}, such as ≦0.66 d_{b}, or ≦0.5 d_{b}. In another aspect, Lₑ can be ≧0.0625 d_{b}, such as ≧0.125 d_{b}, or ≧0.25 d_{b}. Further, Lₑ can be within a range between and including any of the values of Lₑ described herein.

For example, Lₑ can be ≦0.75 d_{b} and ≧0.0625 d_{b}, such as ≦0.75 d_{b} and ≧0.125 d_{b}, or ≦0.75 d_{b} and ≧0.25 d_{b}. In another aspect, Lₑ can be ≦0.66 d_{b} and ≧0.0625 d_{b}, such as ≦0.66 d_{b} and ≧0.125 d_{b}, or ≦0.66 d_{b} and ≧0.25 d_{b}. Moreover, Lₑ can be ≦0.5 d_{b} and ≧0.0625 d_{b}, such as ≦0.5 d_{b} and ≧0.125 d_{b}, or ≦0.5 d_{b} and ≧0.25 d_{b}.

FIG. 11a through FIG. 11f depict still yet another embodiment of an exhaust pipe tether, generally designated 1100. FIG. 11a includes a front plan view of the exhaust pipe tether 1100. FIG. 11b includes a rear plan view of the exhaust pipe tether 1100. FIG. 11c includes a left side plan view of the exhaust pipe tether 1100. FIG. 11d includes a right side plan view of the exhaust pipe tether 1100. FIG. 11e includes a top plan view of the exhaust pipe tether 1100 and FIG. 11f includes a bottom plan view of the exhaust pipe tether 1100.

As illustrated, the exhaust pipe tether 1100 can include a generally circular body 1102 similar to the body 102 described in conjunction with FIG. 1a. Further, the exhaust pipe tether 1100 can include a generally cubic first end piece 1108 and a generally cubic second end piece 1116 shaped to resemble a dice, i.e., similar to the end piece 208 described in conjunction with FIG. 2a through FIG. 2f. The exhaust pipe tether 1100 can also include an extension 1110 that is similar to the extension 1010 illustrated in FIG. 10a and FIG. 10b.

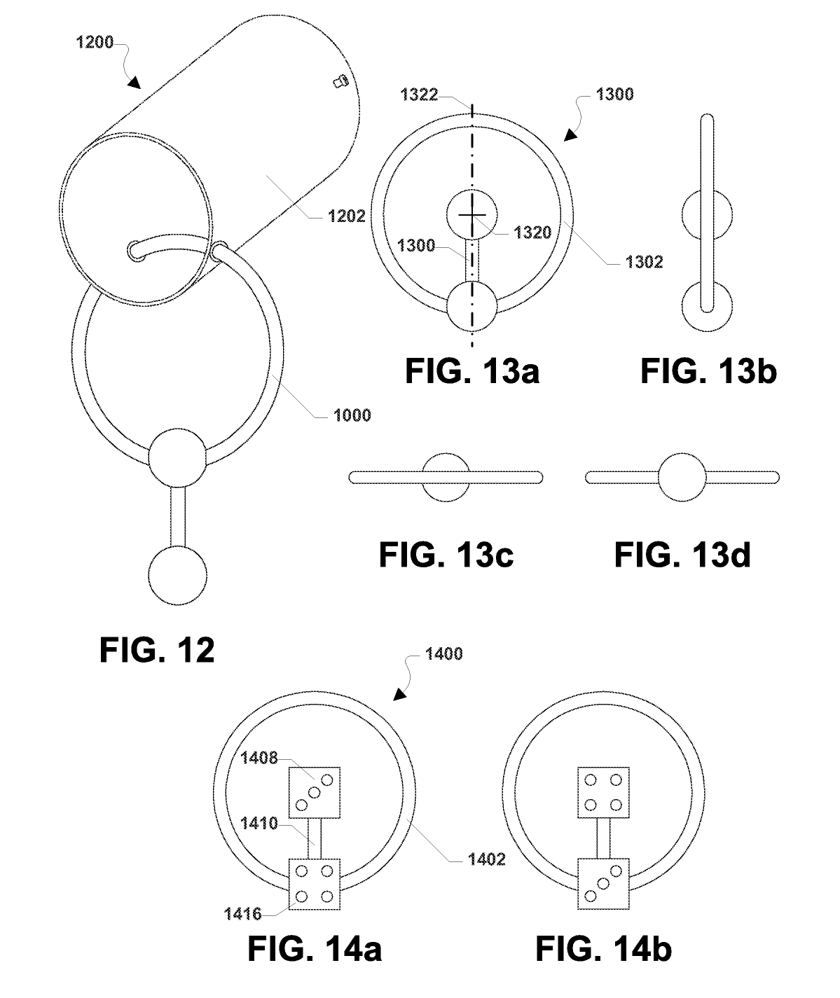

FIG. 12 depicts yet another exhaust tip assembly that is generally designated 1200. The exhaust tip assembly 1200 can include an exhaust tip 1202 similar to the exhaust tip 302 illustrated in FIG. 3a through FIG. 3d and described herein. Further, the exhaust tip assembly 1200 can include an exhaust pipe tether, e.g., the exhaust pipe tether 1000 illustrated in FIG. 10a through FIG. 10d, the exhaust pipe tether 1100 shown in FIG. 11a through FIG. 11f, or any of the other embodiments of an exhaust pipe tether described herein, that can be installed in the same manner described above in conjunction with FIG. 3a through FIG. 3d. The exhaust pipe tether 1000 can also be used to secure a leash as described herein.

FIG. 13a through FIG. 13d illustrate another aspect of an exhaust pipe tether that is generally designated 1300. FIG. 13a includes a front/rear plan view of the exhaust pipe tether 1300. FIG. 13b includes a left/right side plan view of the exhaust pipe tether 1300. FIG. 13c includes a top plan view of the exhaust pipe tether 1300 and FIG. 13d includes a bottom plan view of the exhaust pipe tether 1300.

The exhaust pipe tether 1300 shown in FIG. 13 a through FIG. 13d is essentially the same as the exhaust pipe tether 1000 illustrated in FIG. 10a through FIG. 10d. However, the exhaust pipe tether 1300 can include an extension 1310 that extends upward, toward a center 1320 of the body 1302, along a center axis 1322 of the exhaust pipe tether 1300. The extension 1310 can be dimensioned substantially the same as the extension 1010 illustrated in FIG. 10a through 10d.

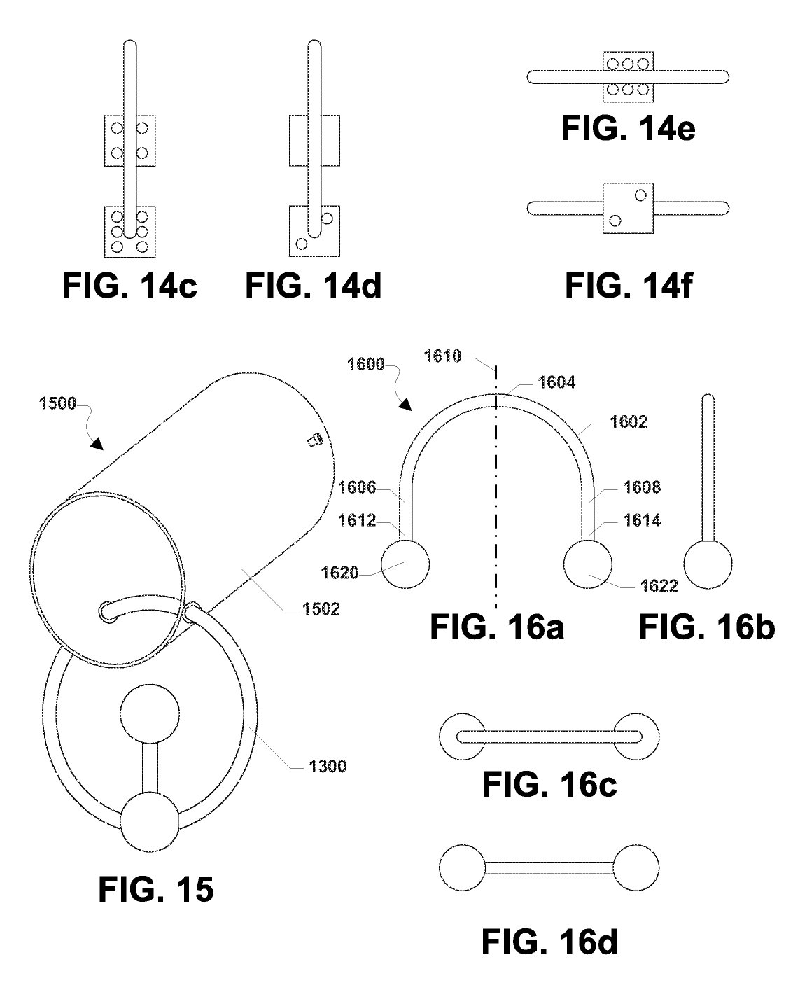

Referring now to FIG. 14a through FIG. 14f, another embodiment of an exhaust pipe tether is illustrated and is generally designated 1400. FIG. 14a includes a front plan view of the exhaust pipe tether 1400. FIG. 14b includes a rear plan view of the exhaust pipe tether 1400. FIG. 14c includes a left side plan view of the exhaust pipe tether 1400. FIG. 14d includes a right side plan view of the exhaust pipe tether 1400. FIG. 14e includes a top plan view of the exhaust pipe tether 1400 and FIG. 14f includes a bottom plan view of the exhaust pipe tether 1400.

As indicated, the exhaust pipe tether 1400 can include a generally circular body 1402 similar to the body 102 described in conjunction with FIG. 1a. Further, the exhaust pipe tether 1400 can include a generally cubic first end piece 1408 and a generally cubic second end piece 1416 shaped to resemble a dice, i.e., similar to the end piece 208 described in conjunction with FIG. 2a through FIG. 2f. The exhaust pipe tether 1400 can also include an extension 1410 that is similar to the extension 1310 illustrated in FIG. 13a and FIG. 13b.

FIG. 15 includes yet another exhaust tip assembly designated 1500. The exhaust tip assembly 1500 can include an exhaust tip 1502 similar to the exhaust tip 302 illustrated in FIG. 3a through FIG. 3d and described herein. Further, the exhaust tip assembly 1500 can include an exhaust pipe tether. e.g., the exhaust pipe tether 1300 illustrated in FIG. 13a through FIG. 13d, the exhaust pipe tether 1400 shown in FIG. 14a through FIG. 14f, or any of the other embodiments of an exhaust pipe tether described herein, that can be installed in the same manner described above in conjunction with FIG. 3a through FIG. 3d. The exhaust pipe tether 1300 can also be used to secure a leash as described herein.

Referring to FIG. 16a through FIG. 16d, another embodiment of an exhaust pipe tether is shown and is generally designated 1600. FIG. 16a includes a front/rear plan view of the exhaust pipe tether 1600. FIG. 16b includes a left/right side plan view of the exhaust pipe tether 1600. FIG. 16c includes a top plan view of the exhaust pipe tether 1600 and FIG. 16d includes a bottom plan view of the exhaust pipe tether 1600.

As depicted, the exhaust pipe tether 1600 can include a generally U-shaped body 1602 that includes a rounded portion 1604. A first elongated arm 1606 and a second elongated arm 1608 can extend from the rounded portion 1604. Each elongated arm 1606, 1608 can be substantially parallel to a central long axis 1610. Further, each elongated arm 1606, 1608 can include a distal end 1612, 1614. The distal end 1612, 1614 of each elongated arm 1606, 1608 can be formed with male threads. A first end piece 1620 can be formed with a bore having internal threads and can be engaged with the distal end 1612 of the first elongated arm 1606. A second end piece 1622 can also be formed with a bore having internal threads and can be engaged with the distal end 1614 of the second elongated arm 1608

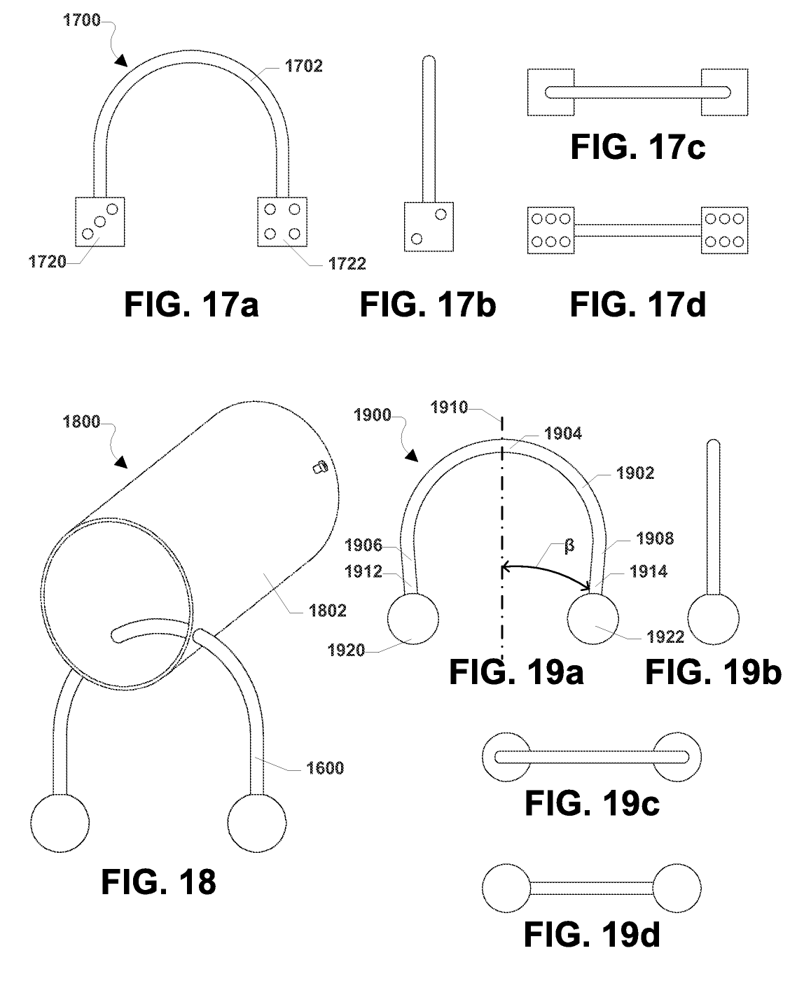

FIG. 17a through FIG. 17d illustrate another embodiment of an exhaust pipe tether 1700. FIG. 17a includes a front/rear plan view of the exhaust pipe tether 1700. FIG. 17b includes a left/right side plan view of the exhaust pipe tether 1700. FIG. 17c includes a top plan view of the exhaust pipe tether 1700 and FIG. 17d includes a bottom plan view of the exhaust pipe tether 1700.

As indicated, the exhaust pipe tether 1700 can include a generally U-shaped body 1702 similar to the body 1602 described in conjunction with FIG. 16a through 16d. Moreover, the exhaust pipe tether 1700 can include a generally cubic first end piece 1720 and a generally cubic second end piece 1722 shaped to resemble dice, i.e., similar to the end piece 208 described in conjunction with FIG. 2a through FIG. 2f.

Referring to FIG. 18, another exhaust tip assembly is illustrated and is designated 1800. The exhaust tip assembly 1800 can include an exhaust tip 1802 similar to the exhaust tip 302 illustrated in FIG. 3a through FIG. 3d and described herein. Further, the exhaust tip assembly 1800 can include an exhaust pipe tether, e.g., the exhaust pipe tether 1600 illustrated in FIG. 16a through FIG. 16d, the exhaust pipe tether 1700 shown in FIG. 17a through FIG. 17d, or any of the other embodiments of an exhaust pipe tether described herein, that can be installed in the same manner described above in conjunction with FIG. 3a through FIG. 3d. The exhaust pipe tether 1600 can also be used to secure a leash as described herein.

FIG. 19a through FIG. 19d include still another embodiment of an exhaust pipe tether that is designated 1900. FIG. 19a includes a front/rear plan view of the exhaust pipe tether 1900. FIG. 19b includes a left/right side plan view of the exhaust pipe tether 1900. FIG. 19c includes a top plan view of the exhaust pipe tether 1900 and FIG. 19d includes a bottom plan view of the exhaust pipe tether 1900.

As illustrated, the exhaust pipe tether 1900 can include a generally horseshoe-shaped body 1902 that includes a rounded portion 1904. A first elongated arm 1906 and a second elongated arm 1908 can extend from the rounded portion 1904. Each elongated arm 1906, 1908 can be angled inward with respect to a central long axis 1910. Further, each elongated arm 1906, 1908 can include a distal end 1912, 1914. The distal end 1912, 1914 of each elongated arm 1906, 1908 can be formed with male threads. A first end piece 1920 can be formed with a bore having internal threads and can be engaged with the distal end 1912 of the first elongated arm 1906. A second end piece 1922 can also be formed with a bore having internal threads and can be engaged with the distal end 1914 of the second elongated arm 1908.

As indicated in FIG. 19a, each elongated arm 1906, 1908 can form an angle, β, with respect to the central axis 1910, or an axis parallel to the central axis. In a particular embodiment, β, can be ≧2.5°, such as ≧5.0°, ≧7.5°, ≧10.0°, ≧12.5 °, ≧15.0°, or ≧17.5°. Further, β can be ≦45.0°, such as ≦40.0°, ≦35.0, ≦30.0°, ≦25.0°, or ≦20.0°. In another aspect, β can be within a range between and including any of the maximum or minimum values of β described herein.

For example, β can be ≧2.5° and ≦45.0°, such as ≧2.5° and ≦40.0°, ≧2.5° and ≦35.0°, ≧2.5° and ≦30.0°, ≧2.5° and ≦25.0°, or ≧2.50 and ≦20.0°. In another aspect, β can be ≧5.0° and ≦45.0°, such as ≧5.0° and ≦40.0°, ≧5.0° and ≦35.0°, ≧5.0° and ≦30.0°, ≧5.0° and ≦25.0°, or ≧5.0° and ≦20.0°. Further, β can be ≧7.5° and ≦45.0°, such as ≧7.5° and ≦40.0°, ≧7.5° and ≦35.0°, ≧7.5° and ≦30.0°, ≧7.5° and ≦25.0°, or ≧7.5° and ≦20.0°. In yet another aspect, β can be ≧10.0° and ≦45.0°, such as ≧10.0° and ≦40.0°, ≧10.0° and ≦35.0, ≧10.0° and ≦30.0°, ≧10.0° and ≦25.0°, or ≧10.0° and ≦20.0°. Moreover, β can be ≧12.5° and ≦45.0°, such as ≧12.5° and ≦40.0°, ≧12.5° and ≦35.0, ≧12.5° and ≦30.0°, ≧12.5° and ≦25.0°, or ≧12.5° and ≦20.0°. In still another aspect, β can be ≧15.0° and ≦45.0°, such as ≧15.0° and ≦40.0°, ≧15.0° and ≦35.0°, ≧15.0° and ≦30.0°, ≧15.0° and ≦25.0°, or ≧15.0° and ≦20.0°. In yet still another aspect, β can be ≧17.5° and ≦45.0°, such as ≧17.5° and ≦40.0°, ≧17.5° and ≦35.0°, ≧17.5° and ≦30.0°, ≧17.5° and ≦25.0°, or ≧17.5° and ≦20.0°.

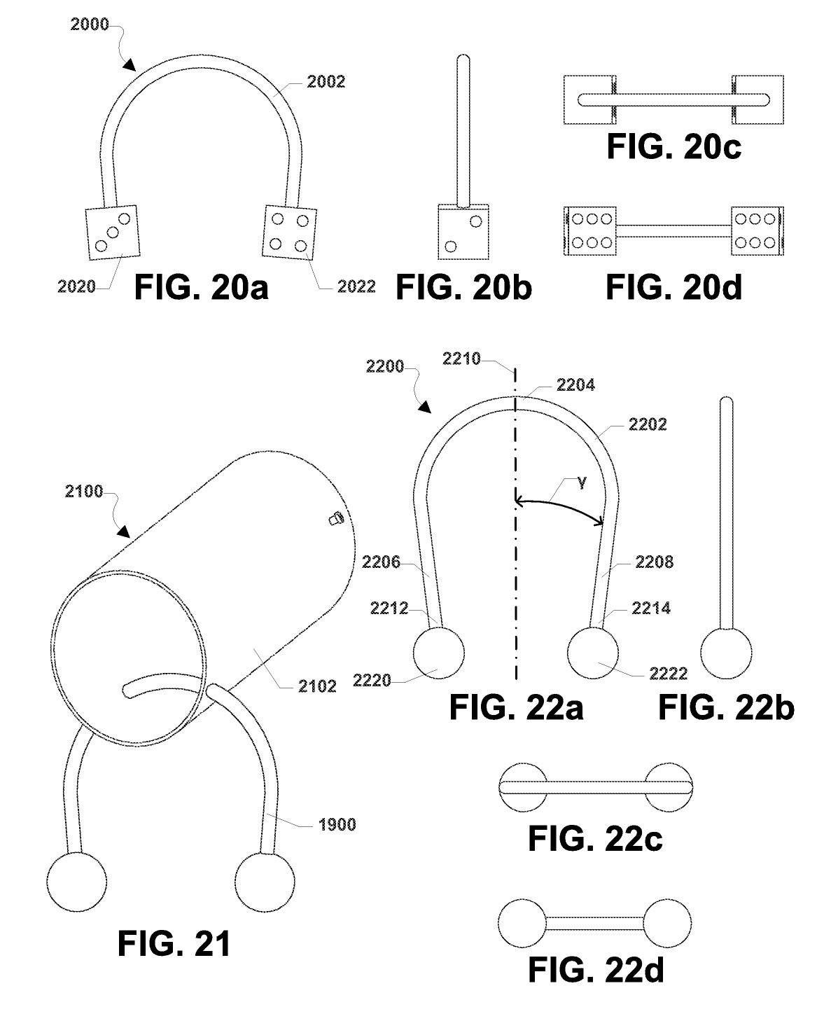

FIG. 20a through FIG. 20d include another embodiment of an exhaust pipe tether 2000. FIG. 20a includes a front/rear plan view of the exhaust pipe tether 2000. FIG. 20b includes a left/right side plan view of the exhaust pipe tether 2000. FIG. 20c includes a top plan view of the exhaust pipe tether 2000 and FIG. 20d includes a bottom plan view of the exhaust pipe tether 2000.

As shown, the exhaust pipe tether 2000 can include a generally horseshoe-shaped body 2002 similar to the body 1902 described in conjunction with FIG. 19a through 19d. Moreover, the exhaust pipe tether 2000 can include a generally cubic first end piece 2020 and a generally cubic second end piece 2022 shaped to resemble dice, i.e., similar to the end piece 208 described in conjunction with FIG. 2a through FIG. 2f.

FIG. 21 includes another embodiment of an exhaust tip assembly that is designated 2100. The exhaust tip assembly 2100 can include an exhaust tip 2102 similar to the exhaust tip 302 illustrated in FIG. 3a through FIG. 3d and described herein. Further, the exhaust tip assembly 2100 can include an exhaust pipe tether, e.g., the exhaust pipe tether 1900 illustrated in FIG. 19a through FIG. 19d, the exhaust pipe tether 2000 shown in FIG. 20a through FIG. 20d, or any of the other embodiments of an exhaust pipe tether described herein, that can be installed in the same manner described above in conjunction with FIG. 3a through FIG. 3d. The exhaust pipe tether 1900 can also be used to secure a leash as described herein.

FIG. 22a through FIG. 22d illustrate another embodiment of an exhaust pipe tether 2100. FIG. 22a includes a front/rear plan view of the exhaust pipe tether 2200. FIG. 22b includes a left/right side plan view of the exhaust pipe tether 2200. FIG. 22c includes a top plan view of the exhaust pipe tether 2200 and FIG. 22d includes a bottom plan view of the exhaust pipe tether 2200.

As illustrated, the exhaust pipe tether 2200 can include a generally elongated horseshoe-shaped body 2202 that includes a rounded portion 2204. A first elongated arm 2206 and a second elongated arm 2208 can extend from the rounded portion 2204. Each elongated arm 2206, 2208 can be angled inward with respect to a central long axis 2210. Further, each elongated arm 2206, 2208 can include a distal end 2212, 2214. The distal end 2212, 2214 of each elongated arm 2206, 2208 can be formed with male threads. A first end piece 2220 can be formed with a bore having internal threads and can be engaged with the distal end 2212 of the first elongated arm 2206. A second end piece 2222 can also be formed with a bore having internal threads and can be engaged with the distal end 2214 of the second elongated arm 2208.

As indicated in FIG. 22a, each elongated arm 2206, 2208 can form an angle, γ, with respect to the central long axis 2210 or an axis parallel to the central long axis 2210. In a particular embodiment, γ, can be ≧2.5°, such as ≧5.0°, ≧7.5°, ≧10.0°, ≧12.5°, ≧15.0°, or ≧17.5°. Further, γ can be ≦45.0°, such as ≦40.0°, ≦35.0°, 30.0°, ≦25.0°, or ≦20.0°. In another aspect, γ can be within a range between and including any of the maximum or minimum values of γ described herein.

For example, γ can be ≧2.5° and ≦45.0°, such as ≧2.5° and ≦40.0°, ≧2.5° and ≦35.0°, ≧2.5° and ≦30.0°, ≧2.5° and ≦25.0°, or ≧2.5° and ≦20.0°. Moreover, γ can be ≧5.0° and ≦45.0°, such as ≧5.0° and ≦40.0°, ≧5.0° and ≦35.0°, ≧5.0° and ≦30.0°, ≧5.0° and ≦25.0°, or ≧5.0° and ≦20.0°. Further, γ can be ≧7.5° and ≦45.0°, such as ≧7.5° and ≦40.0°, ≧7.5° and ≦35.0°, ≧7.5° and ≦30.0°, ≧7.5 and ≦25.0°, or ≧7.5° and ≦20.0°. In yet another aspect, γ can be ≧10.0° and ≦45.0°, such as 10.0° and ≦40.0°, ≧10.0° and ≦35.0°, ≧10.0° and ≦30.0, ≧10.0° and ≦25.0°, or ≧10.0° and ≦320.0. Moreover, γ can be ≧12.5° and ≦45.0° such as ≧12.5° and ≦40.0°, ≧12.5° and ≦35.0°, ≧12.5° and ≦30.0°, ≦12.5° and ≦25.0°, or ≧12.5° and ≦20.0°. In still another aspect, γ can be ≧15.0° and ≦45.0°, such as ≧15.0° and ≦40.0°, ≧15.0° and ≦35.0°, ≧15.0° and ≦30.0°, ≧15.0° and ≦25.00, or ≧15.0° and ≦20.0°. In yet still another aspect, γ can be ≧17.5° and ≦45.0°, such as ≧17.5° and ≦40.0°, ≧17.5° and ≦35.0°, ≧17.5° and ≦30.0°, ≧17.5° and ≦25.0°, or ≧17.5° and ≦20.0°.

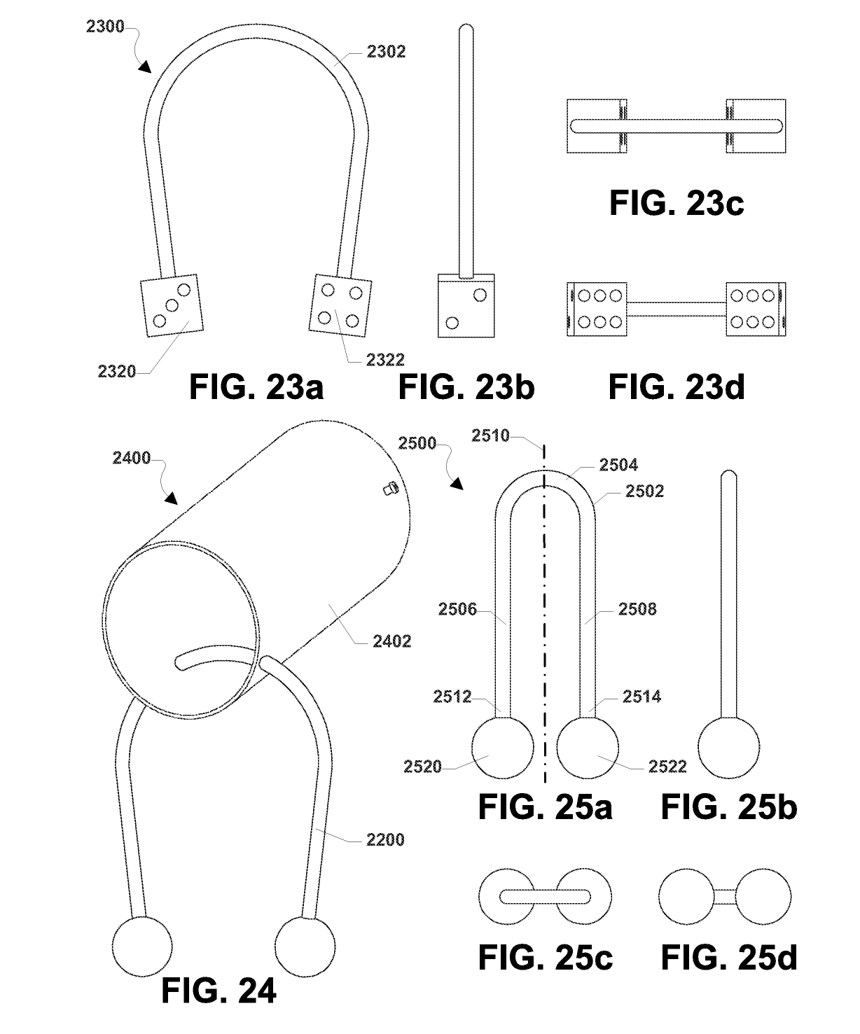

FIG. 23a through FIG. 23d depict another embodiment of an exhaust pipe tether 2300. FIG. 23a includes a front/rear plan view of the exhaust pipe tether 2300. FIG. 23h includes a left/right side plan view of the exhaust pipe tether 2300. FIG. 23c includes a top plan view of the exhaust pipe tether 2300 and FIG. 23d includes a bottom plan view of the exhaust pipe tether 2300.

As shown, the exhaust pipe tether 2300 can include a generally elongated horseshoe-shaped body 2302 similar to the body 2202 described in conjunction with FIG. 22a through 22d. Moreover, the exhaust pipe tether 2300 can include a generally cubic first end piece 2320 and a generally cubic second end piece 2322 that can be shaped to resemble dice, i.e., similar to the end piece 208 described in conjunction with FIG. 2a through FIG. 2f.

FIG. 24 includes another embodiment of an exhaust tip assembly that is designated 2400. The exhaust tip assembly 2400 can include an exhaust tip 2402 similar to the exhaust tip 302 illustrated in FIG. 3a through FIG. 3d and described herein. Further, the exhaust tip assembly 2400 can include an exhaust pipe tether, e.g. the exhaust pipe tether 2200 illustrated in FIG. 22a through FIG. 22d, the exhaust pipe tether 2300 shown in FIG. 23a through FIG. 23d, or any of the other embodiments of an exhaust pipe tether described herein, that can be installed in the same manner described above in conjunction with FIG. 3a through FIG. 3d. The exhaust pipe tether 2200 can also be used to secure a leash as described herein.

Referring now to FIG. 25a through FIG. 25d, yet another embodiment of an exhaust pipe tether is shown and is generally designated 2500. FIG. 25a includes a front/rear plan view of the exhaust pipe tether 2500. FIG. 25b includes a left/right side plan view of the exhaust pipe tether 2500. FIG. 25c includes a top plan view of the exhaust pipe tether 2500 and FIG. 25d includes a bottom plan view of the exhaust pipe tether 2500.

FIG. 25a and FIG. 25b indicate that the exhaust pipe tether 2500 can include a generally elongated U-shaped body 2502 that includes a rounded portion 2504. A first elongated arm 2506 and a second elongated arm 2508 can extend from the rounded portion 2504. Each elongated arm 2506, 2508 can be substantially parallel to a central long axis 2510. Further, each elongated arm 2506, 2508 can include a distal end 2512, 2514. The distal end 2512, 2514 of each elongated arm 2506, 2508 can be formed with male threads. A first end piece 2520 can be machined, or otherwise formed, to include a bore having internal threads and the first end piece 2520 can be threadably engaged with the distal end 2512 of the first elongated arm 2506. A second end piece 2522 can also be machined, or otherwise formed, with a bore having internal threads. The second end piece 2522 can be threadably engaged with the distal end 2514 of the second elongated arm 2508.

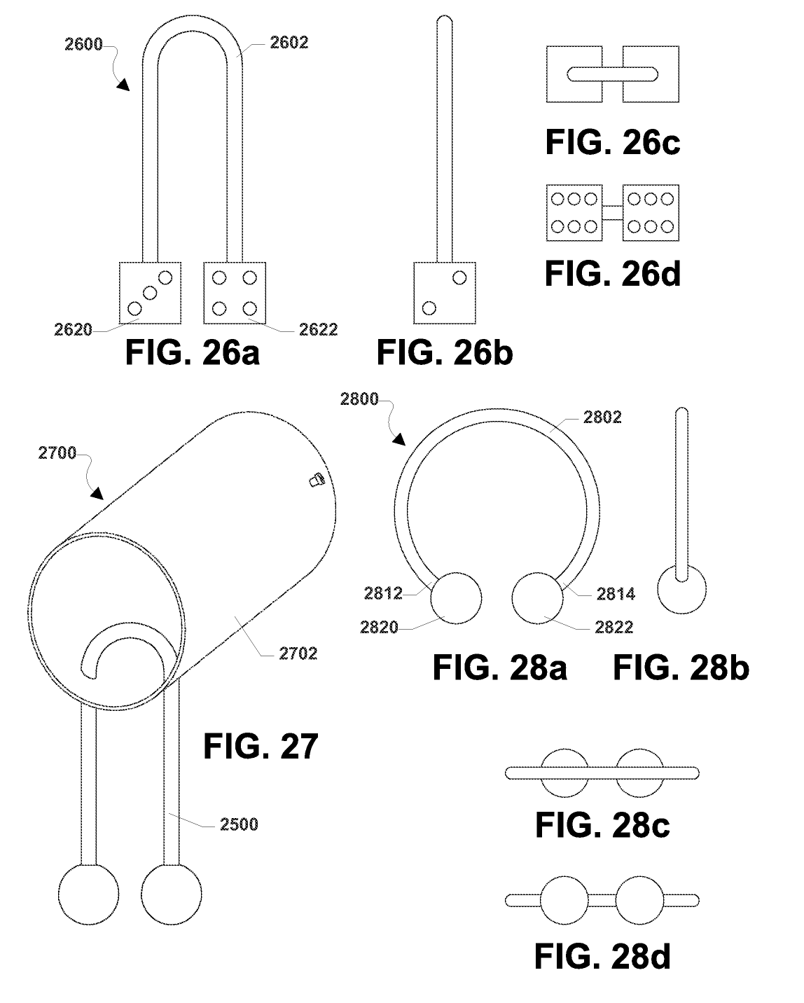

FIG. 26a through FIG. 26d illustrate another embodiment of an exhaust pipe tether 2600. FIG. 26a includes a front/rear plan view of the exhaust pipe tether 2600. FIG. 26b includes a left/right side plan view of the exhaust pipe tether 2600. FIG. 26c includes a top plan view of the exhaust pipe tether 2600 and FIG. 26d includes a bottom plan view of the exhaust pipe tether 2600.

As indicated, the exhaust pipe tether 2600 can include a generally elongated U-shaped body 2602 similar to the body 2502 described in conjunction with FIG. 25a through 25d. Moreover, the exhaust pipe tether 2600 can include a generally cubic first end piece 2620 and a generally cubic second end piece 2622 shaped to resemble dice, i.e., similar to the end piece 208 described in conjunction with FIG. 2a through FIG. 21.

Referring to FIG. 27, another exhaust tip assembly is illustrated and is designated 2700. The exhaust tip assembly 2700 can include an exhaust tip 2702 similar to the exhaust tip 302 illustrated in FIG. 3a through FIG. 3d and described herein. Further, the exhaust tip assembly 2700 can include an exhaust pipe tether, e.g., the exhaust pipe tether 2500 illustrated in FIG. 25a through FIG. 25d, the exhaust pipe tether 2600 illustrated in FIG. 26a through FIG. 26d, or any of the other embodiments of an exhaust pipe tether described herein, that can be installed in the same manner described above in conjunction with FIG. 3a through FIG. 3d. The exhaust pipe tether 2500 can also be used to secure a leash as described herein.

FIG. 28a through FIG. 28d depict another embodiment of an exhaust pipe tether that is generally designated 2800. FIG. 28a includes a front/rear plan view of the exhaust pipe tether 2800. FIG. 28b includes a left/right side plan view of the exhaust pipe tether 2800. FIG. 28c includes a top plan view of the exhaust pipe tether 2800 and FIG. 28d includes a bottom plan view of the exhaust pipe tether 2800.

FIG. 28a and FIG. 28b indicate that the exhaust pipe tether 2800 can include a generally open, or split, ring-shaped body 2802. The ring-shaped body 2802 can include a first end 2812 and a second end 2814. The ends 2812, 2814 of the body 2802 can be formed with male threads. A first end piece 2820 can be machined, or otherwise formed, to include a bore having internal threads and the first end piece 2820 can be threadably engaged with the first end 2812 of the body 2802. A second end piece 2822 can also be machined, or otherwise formed, with a bore having internal threads. The second end piece 2822 can be threadably engaged with the second end 2814 of the body 2802.

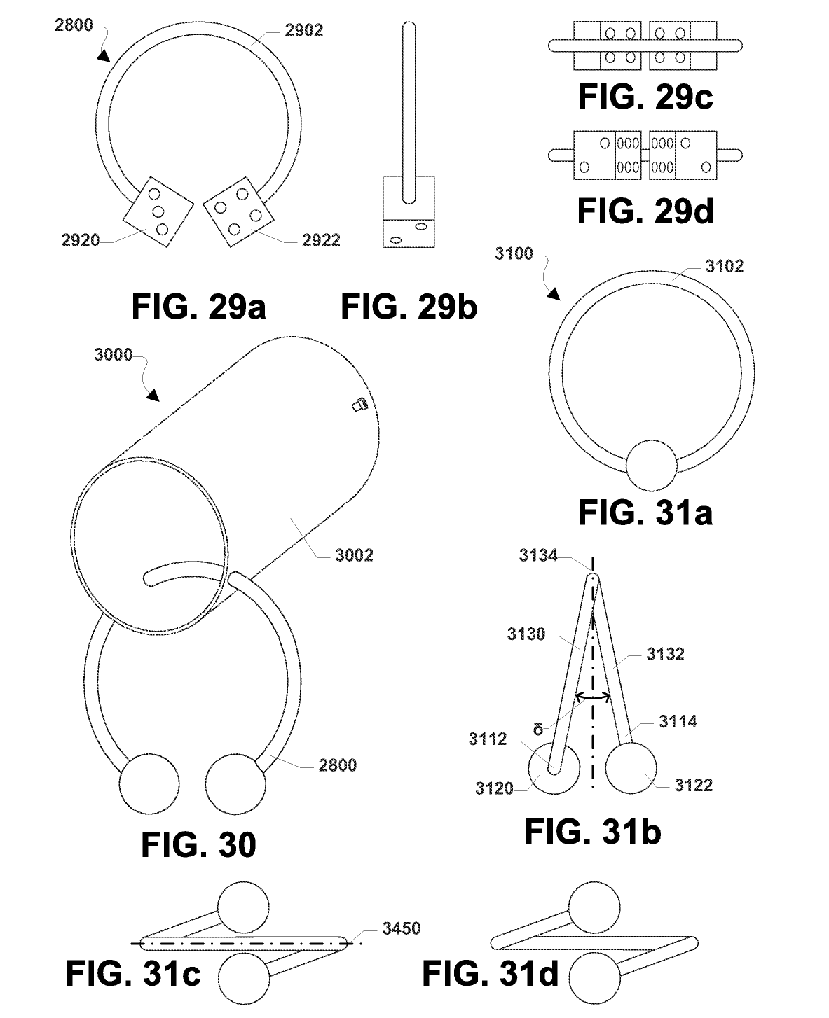

FIG. 29a through FIG. 29d illustrate another embodiment of an exhaust pipe tether 2900. FIG. 29a includes a front/rear plan view of the exhaust pipe tether 2900. FIG. 29b includes a left/right side plan view of the exhaust pipe tether 2900. FIG. 29c includes a top plan view of the exhaust pipe tether 2900 and FIG. 29d includes a bottom plan view of the exhaust pipe tether 2900.

As indicated, the exhaust pipe tether 2900 can include a generally open, or split, ring-shaped body 2902 similar to the body 2802 described in conjunction with FIG. 28a through 28d. Moreover, the exhaust pipe tether 2900 can include a generally cubic first end piece 2920 and a generally cubic second end piece 2922 shaped to resemble dice, i.e., similar to the end piece 208 described in conjunction with FIG. 2a through FIG. 2f.

Referring now to FIG. 30, another exhaust tip assembly is illustrated and is designated 3000. The exhaust tip assembly 3000 can include an exhaust tip 3002 similar to the exhaust tip 302 illustrated in FIG. 3a through FIG. 3d and described herein. Further, the exhaust tip assembly 3000 can include an exhaust pipe tether, e.g., the exhaust pipe tether 2800 illustrated in FIG. 28a through FIG. 28d, the exhaust pipe tether 2900 illustrated in FIG. 29a through FIG. 29d, or any of the other embodiments of an exhaust pipe tether described herein, that can be installed in the same manner described above in conjunction with FIG. 3a through FIG. 3d. The exhaust pipe tether 2800 can also be used to secure a leash as described herein.

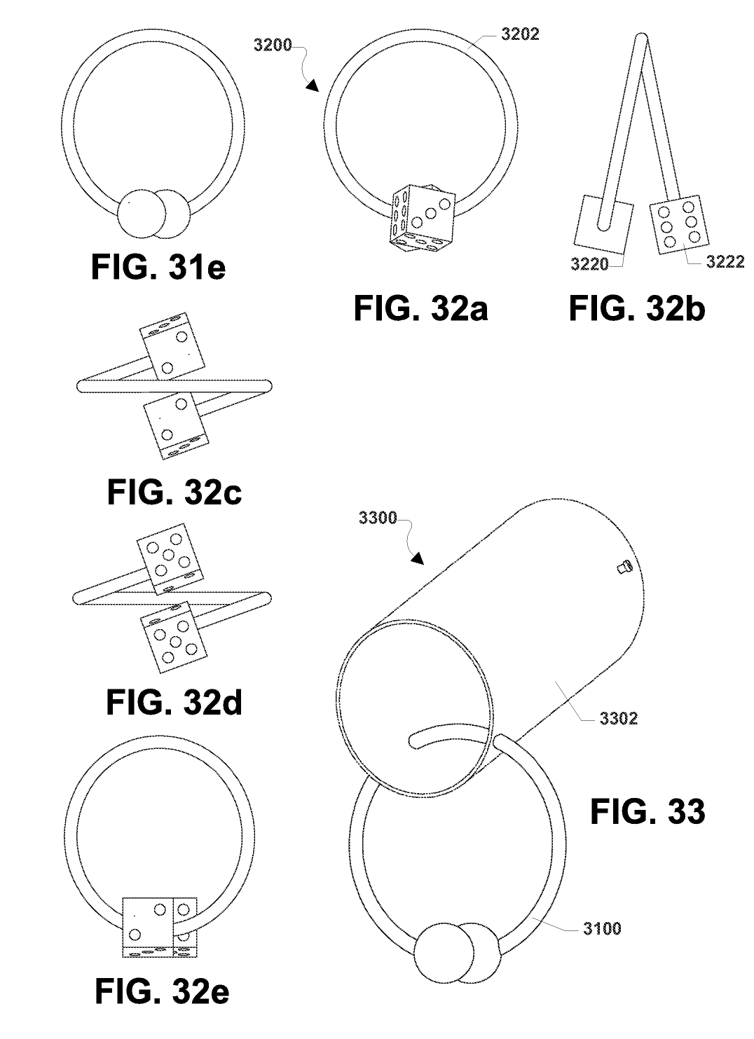

FIG. 31a through FIG. 31d depict still another embodiment of an exhaust pipe tether that is generally designated 3100. FIG. 31a includes a front/rear plan view of the exhaust pipe tether 3100. FIG. 31b includes a left/right side plan view of the exhaust pipe tether 3100. FIG. 31c includes a top plan view of the exhaust pipe tether 3100 and FIG. 31d includes a bottom plan view of the exhaust pipe tether 3100. FIG. 31c includes another plan view of the exhaust pipe tether 3100 as viewed from the left or right side at a slight angle with respect to either side.

FIG. 31a and FIG. 31b indicate that the exhaust pipe tether 3100 can include a generally open, or split, ring-shaped body 3102. The ring-shaped body 3102 can include a first end 3112 and a second end 3114. The ends 3112, 3114 of the body 3102 can be formed with male threads. A first end piece 3120 can be machined, or otherwise formed, to include a bore having internal threads and the first end piece 3120 can be threadably engaged with the first end 3112 of the body 3102. A second end piece 3122 can also be machined, or otherwise formed, with a bore having internal threads. The second end piece 3122 can be threadably engaged with the second end 3114 of the body 3102

As indicated in FIG. 31c, the exhaust pipe tether 3100 can be bent so that as viewed from either the left side or the right side, a first half 3130 of the exhaust pipe tether 3100 can form an angle, δ, with respect to a second half 3132 of the that is symmetrical about a center axis 3134 of the exhaust pipe tether 3100. In a particular embodiment δ, can be ≧15.0, such as ≧17.5°, ≧20.0°, or ≧22.5°. Further, δ can be ≦45.0°, such as ≦40.0, ≦35.0°, ≦30.0°, or ≦25.0°. In another aspect, β can be within a range between and including any of the maximum or minimum values of δ described herein.

For example, δ can be ≧15.0° and ≦45.0°, such as ≧15.00 and ≦40.0°, ≧15.0° and ≦35.0°, 15.0° and ≦30.0°, or ≧15.0° and ≦25.0°. Moreover, δ can be ≧17.5° and ≦45.0°, such as ≧17.5° and ≦40.0°, ≧17.5° and ≦35.0°, ≧17.5° and ≦30.0°, or ≧17.5° and ≦25.0°. Further, δ can be ≧20.0° and ≦45.0, such as ≧20.0° and ≦40.0°, ≧20.0° and ≦35.0°, ≧20.0° and ≦30.0°, or ≧20.0° and ≦25.0°. In yet another aspect, δ can be ≧22.5° and ≦45.0, such as ≧22.5° and ≦40.0°, ≧22.5° and ≦35.0°, ≧22.5° and ≦30.0°, or ≧22.5° and ≦25.0°.

FIG. 32a through FIG. 32d illustrate another embodiment of an exhaust pipe tether 3200. FIG. 32a includes a front/rear plan view of the exhaust pipe tether 3200. FIG. 32b includes a left/right side plan view of the exhaust pipe tether 3200. FIG. 32c includes a top plan view of the exhaust pipe tether 3200 and FIG. 32d includes a bottom plan view of the exhaust pipe tether 3200. FIG. 32e includes another plan view of the exhaust pipe tether 3100 as viewed from the left or right side at a slight angle with respect to either side.

As indicated, the exhaust pipe tether 3200 can include a generally open, or split, ring-shaped body 3202 similar to the body 3102 described in conjunction with FIG. 31a through 31d. Moreover, the exhaust pipe tether 3200 can include a generally cubic first end piece 3220 and a generally cubic second end piece 3222 shaped to resemble dice, i.e., similar to the end piece 208 described in conjunction with FIG. 2a through FIG. 2f.

Referring to FIG. 33, still another exhaust tip assembly is illustrated and is designated 3300. The exhaust tip assembly 3300 can include an exhaust tip 3302 similar to the exhaust tip 332 illustrated in FIG. 3a through FIG. 3d and described herein. Further, the exhaust tip assembly 3300 can include an exhaust pipe tether, e.g., the exhaust pipe tether 3100 illustrated in FIG. 3a through FIG. 31e, the exhaust pipe tether 3200 illustrated in FIG. 32a through FIG. 32c, or any of the other embodiments of an exhaust pipe tether described herein, that can be installed in the same manner described above in conjunction with FIG. 3a through FIG. 3d. The exhaust pipe tether 3100 can also be used to secure a leash as described herein.

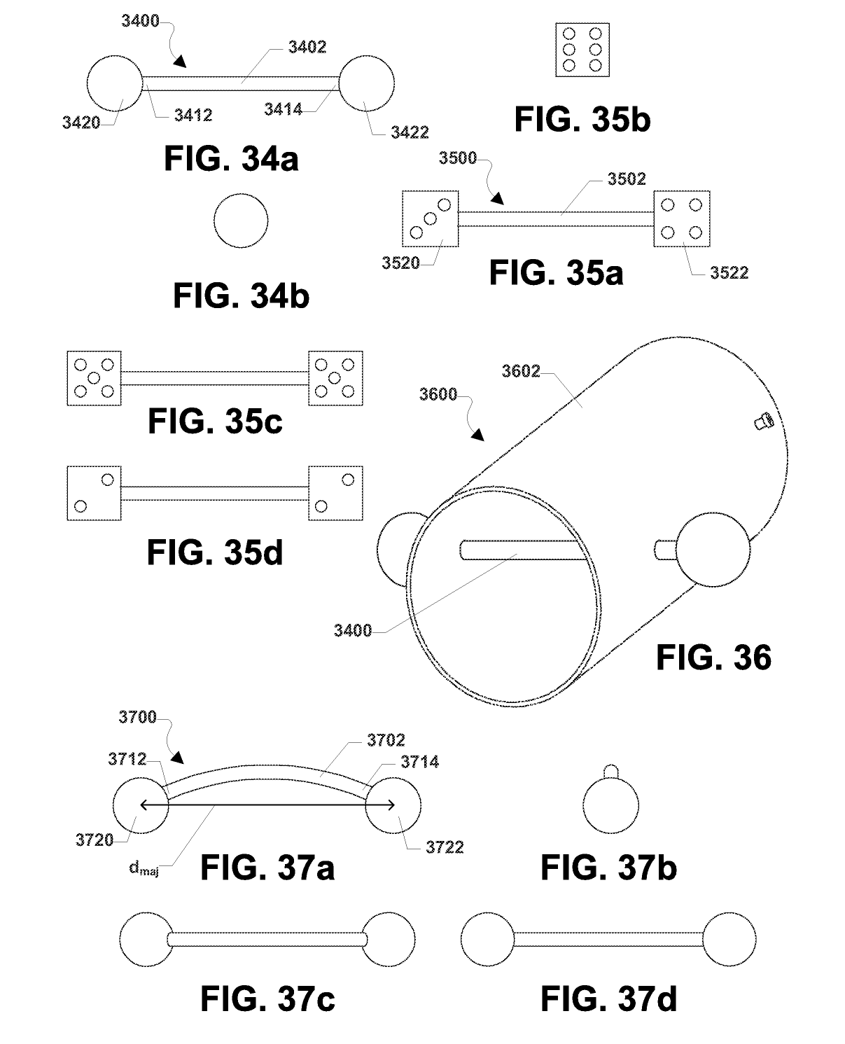

FIG. 34a and FIG. 34b include another embodiment of an exhaust pipe tether that is generally designated 3400. FIG. 34a includes a front/rear/top/bottom plan view of the exhaust pipe tether 3400. FIG. 34b includes a left/right side plan view of the exhaust pipe tether 3400.

FIG. 34a indicate that the exhaust pipe tether 3400 can include a generally straight, or linear, body 3402. The body 3402 can include a first end 3412 and a second end 3414. The ends 3412, 3414 of the body 3402 can be formed with male threads. A first end piece 3420 can be machined, or otherwise formed, to include a bore having internal threads and the first end piece 3420 can be threadably engaged with the first end 3412 of the body 3402. A second end piece 3422 can also be machined, or otherwise formed, with a bore having internal threads. The second end piece 3422 can be threadably engaged with the second end 3414 of the body 3402.

FIG. 35a through FIG. 35d depict another embodiment of an exhaust pipe tether 3500. FIG. 35a includes a front/rear plan view of the exhaust pipe tether 3500. FIG. 35b includes a left/right side plan view of the exhaust pipe tether 3500. FIG. 35c includes a top plan view of the exhaust pipe tether 3500 and FIG. 35d includes a bottom plan view of the exhaust pipe tether 3500.

As indicated, the exhaust pipe tether 3500 can include a generally straight, or linear, body 3502 similar to the body 3402 described in conjunction with FIG. 34a and FIG. 34b. Moreover, the exhaust pipe tether 3500 can include a generally cubic first end piece 3520 and a generally cubic second end piece 3522 shaped to resemble dice, i.e., similar to the end piece 208 described in conjunction with FIG. 2a through FIG. 2f.

Referring to FIG. 36, still another exhaust tip assembly is illustrated and is designated 3600. The exhaust tip assembly 3600 can include an exhaust tip 3602 similar to the exhaust tip 302 illustrated in FIG. 3a through FIG. 3d and described herein. Further, the exhaust tip assembly 3600 can include an exhaust pipe tether, e.g., the exhaust pipe tether 3400 illustrated in FIG. 34a and FIG. 34b, the exhaust pipe tether 3500 illustrated in FIG. 35a through FIG. 35d, or any of the other embodiments of an exhaust pipe tether described herein, that can be installed in the same manner described above in conjunction with FIG. 3a through FIG. 3d. The exhaust pipe tether 3400 can also be used to secure a leash as described herein.

FIG. 37a and FIG. 37b include another embodiment of an exhaust pipe tether that is generally designated 3700. FIG. 37a includes a front/rear plan view of the exhaust pipe tether 3700. FIG. 37b includes a left/right side plan view of the exhaust pipe tether 3700. FIG. 37c includes a top plan view of the exhaust pipe tether 3700 and FIG. 37d includes a bottom plan view of the exhaust pipe tether 3700.

FIG. 37a indicates that the exhaust pipe tether 3700 can include a curved body 3702. As illustrated, the body 3702 can be curved, but does not form a ring, or a split ring, as described in conjunction with other embodiments herein. The body 3702 can include a first end 3712 and a second end 3714. The ends 3712, 3714 of the body 3702 can be formed with male threads. A first end piece 3720 can be machined, or otherwise formed, to include a bore having internal threads and the first end piece 3720 can be threadably engaged with the first end 3712 of the body 3702. A second end piece 3722 can also be machined, or otherwise formed, with a bore having internal threads. The second end piece 3722 can be threadably engaged with the second end 3714 of the body 3702.

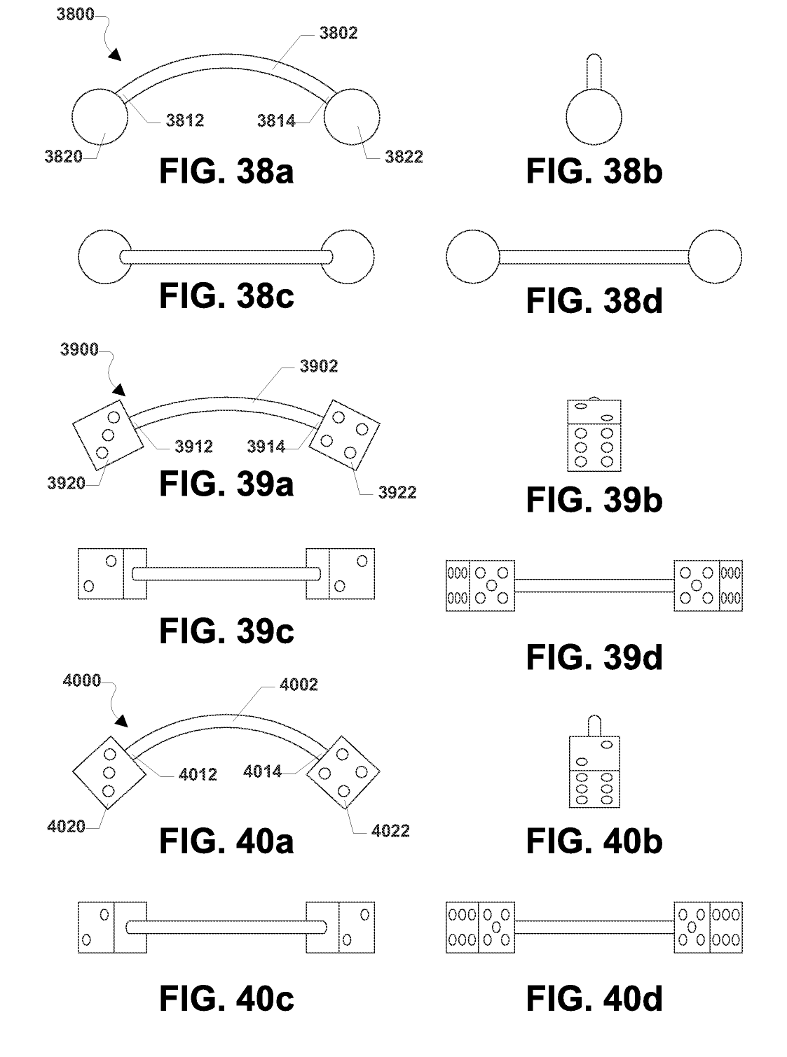

FIG. 38a and FIG. 38b include another embodiment of an exhaust pipe tether that is generally designated 3800. FIG. 38a includes a front/rear plan view of the exhaust pipe tether 3800. FIG. 38b includes a left/right side plan view of the exhaust pipe tether 3800. FIG. 38c includes a top plan view of the exhaust pipe tether 3800 and FIG. 38d includes a bottom plan view of the exhaust pipe tether 3800.

FIG. 38a indicates that the exhaust pipe tether 3800 can include a curved body 3802, similar to the curved body 3702 of the previous exhaust pipe tether 3700 but with a smaller radius of curvature. The body 3802 can include a first end 3812 and a second end 3814. The ends 3812, 3814 of the body 3802 can be formed with male threads. A first end piece 3820 can be machined, or otherwise formed, to include a bore having internal threads and the first end piece 3820 can be threadably engaged with the first end 3812 of the body 3802. A second end piece 3822 can also be machined, or otherwise formed, with a bore having internal threads. The second end piece 3822 can be threadably engaged with the second end 3814 of the body 3802.

In each of the embodiments shown in FIG. 37a through FIG. 37d and FIG. 38a through FIG. 38d, the body 3702, 3802 can have a major dimension, dₘₐⱼ, measured along a straight line from a center of the first end 3712, 3812 to a center of the second end 3714, 3814 of the body 3702, 3802. Further, the body 3702, 3802 can have a radius of curvature, r_{b}, and a ratio, R, of dₘₐⱼ/r_{b} can be ≧0.25, such as ≧0.5, ≧0.75, ≧1.0, ≧1.025, ≧1.05, or ≧1.01. Further, R can be ≦2.0, such as ≦1.75, ≦1.5, or ≦1.25. In a particular aspect. R can be within a range between and including any of the maximum and minimum values of R described herein.

For example, R can be ≧0.25 and ≦2.0, such as ≧0.25 and ≦1.75, ≧0.25 and ≦1.5, or ≧0.25 and ≦1.25. R can be ≧0.5 and ≦2.0, such as ≧0.5 and ≦1.75, ≧0.5 and ≦1.5, or ≧0.5 and ≦1.25. Moreover, R can be ≧0.75 and ≦2.0, such as ≧0.75 and ≦1.75, ≧0.75 and ≦1.5, or ≧0.75 and ≦1.25. R can also be ≧1.0 and ≦2.0, such as ≧1.0 and ≦1.75, ≧1.0 and ≦1.5, or ≧1.0 and ≦1.25. In another aspect, R can be ≧1.025 and ≦2.0, such as ≧1.025 and ≦1.75, ≧1.025 and ≦1.5, or ≧1.025 and ≦1.25. Further, R can be ≧1.05 and ≦2.0, such as ≧1.05 and ≦1.75, ≧1.05 and ≦1.5, or ≧1.05 and ≦1.25. R can also be ≧1.01 and ≦2.0, such as ≧1.01 and ≦1.75, ≧1.01 and ≦1.5, or ≧1.01 and ≦1.25.

FIG. 39a through FIG. 39d depict another embodiment of an exhaust pipe tether 3900. FIG. 39a includes a front/rear plan view of the exhaust pipe tether 3900. FIG. 39b includes a left/right side plan view of the exhaust pipe tether 3900. FIG. 39c includes a top plan view of the exhaust pipe tether 3900 and FIG. 39d includes a bottom plan view of the exhaust pipe tether 3900.

As indicated, the exhaust pipe tether 3900 can include a curved body 3902 similar to the body 3702 illustrated in FIG. 37a. Moreover, the exhaust pipe tether 3900 can include a generally cubic first end piece 3920 and a generally cubic second end piece 3922 shaped to resemble dice. i.e., similar to the end piece 208 described in conjunction with FIG. 2a through FIG. 2f.

FIG. 40a through FIG. 40d depict another embodiment of an exhaust pipe tether 4000. FIG. 40a includes a front/rear plan view of the exhaust pipe tether 4000. FIG. 40b includes a left/right side plan view of the exhaust pipe tether 4000. FIG. 40c includes a top plan view of the exhaust pipe tether 4000 and FIG. 40d includes a bottom plan view of the exhaust pipe tether 4000.

As indicated, the exhaust pipe tether 4000 can include a curved body 4002 similar to the body 3802 illustrated in FIG. 38a. Moreover, the exhaust pipe tether 4000 can include a generally cubic first end piece 4020 and a generally cubic second end piece 4022 shaped to resemble dice, i.e., similar to the end piece 208 described in conjunction with FIG. 2a through FIG. 2f.

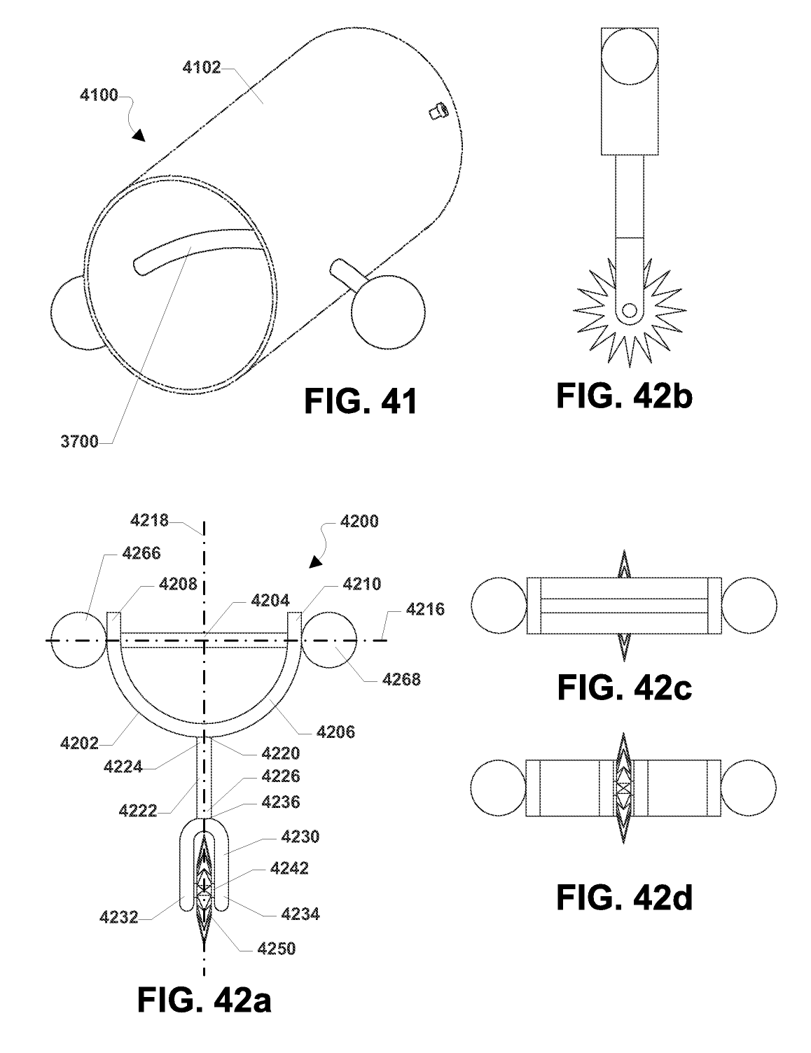

Referring to FIG. 41, still another exhaust tip assembly is illustrated and is designated 4100. The exhaust tip assembly 4100 can include an exhaust tip 4102 similar to the exhaust tip 302 illustrated in FIG. 3a through FIG. 3d and described herein. Further, the exhaust tip assembly 4100 can include an exhaust pipe tether, e.g. the exhaust pipe tether 3700 illustrated in FIG. 37a and FIG. 37b, the exhaust pipe tether 3800 illustrated in FIG. 38a through FIG. 38d, the exhaust pipe tether 3900 illustrated in FIG. 39a through FIG. 39d, the exhaust pipe tether 4000 illustrated in FIG. 40a through FIG. 40d, or any of the other embodiments of an exhaust pipe tether described herein, that can be installed in the same manner described above in conjunction with FIG. 3a through FIG. 3d. The exhaust pipe tether 3700 can also be used to secure a leash as described herein.

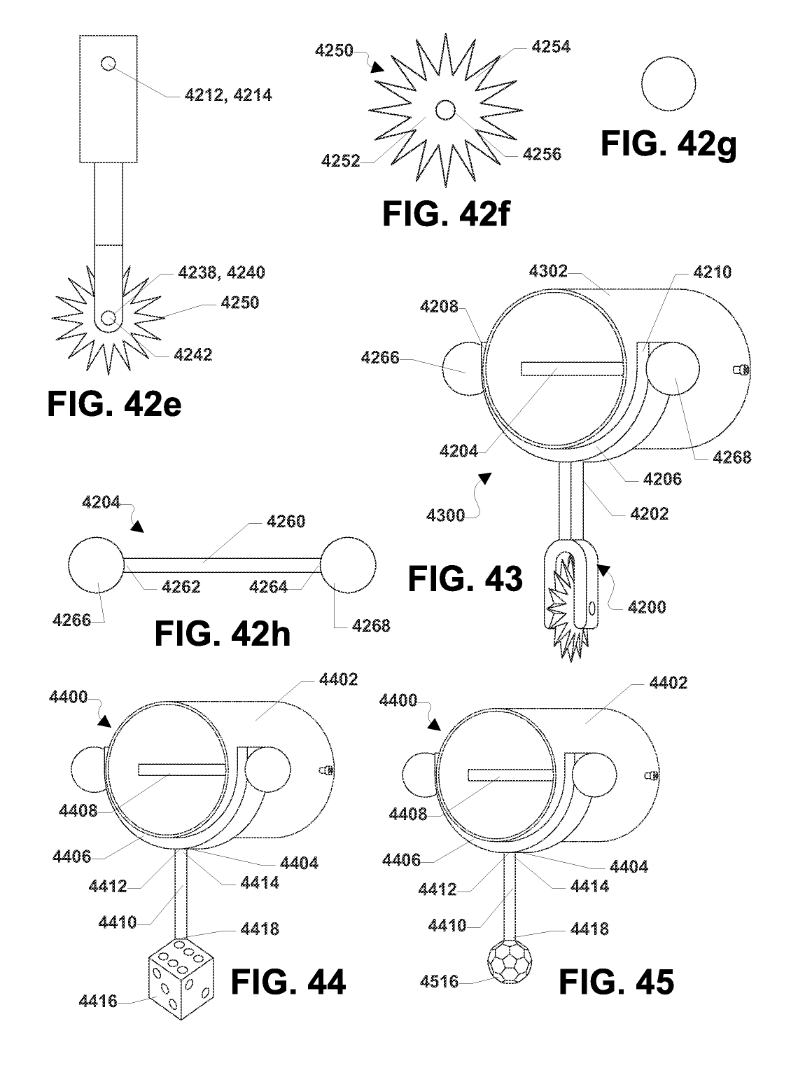

Referring now to FIG. 42a through 42h, another embodiment of an exhaust pipe tether is illustrated and is generally designated 4200. FIG. 42a includes a front/rear plan view of the exhaust pipe tether 4200. FIG. 42b includes a left/right side plan view of the exhaust pipe tether 4200. FIG. 42c includes a top plan view of the exhaust pipe tether 4200. FIG. 42d includes a bottom plan view of the exhaust pipe tether 4200. FIG. 42e is a left/right side plan view of a body for the exhaust pipe tether 4200. FIG. 42f is a front/rear plan view of a spur for the exhaust pipe tether 4200. FIG. 42g is a left/right side plan view of an attachment rod for the exhaust pipe tether 4200. FIG. 42h is a front/rear plan view of the attachment rod for the exhaust pipe tether 4200.

As illustrated, the exhaust pipe tether 4200 can include a body 4202 and an attachment rod 42040. The body 4202 can include a generally semi-cylindrical upper portion 4206 having a first end 4208 and a second end 4210. As indicated in FIG. 42e, each end 4208, 4210 of the body 4202 can include a bore 4212, 4214 extending generally perpendicularly through the end 4208, 4210 along an axis 4216 perpendicular to a central, long axis 4218 of the exhaust pipe tether 4200. The body 4202 can also include a midpoint 4220 that lies along the central, long axis 4218. A lower arm 4222 can extend from the midpoint 4224 of the upper portion 4206 of the body 4202 in a downward direction away from the upper portion 4206 of the body 4202 along the central, long axis 4218. The lower arm 4222 can include a proximal end 4224 and a distal end 4226. The proximal end 4224 of the lower arm 4222 can be integrally formed with, or otherwise connected to, the upper portion 4206 of the body 4202.

A bracket 4230 can be attached to, or otherwise integrally formed with, the distal end 4226 of the lower arm 4222. The bracket 4230 can be generally U-shaped and can include a first end 4232, a second 4234, and a midpoint 4236 that can lie along the central, long axis 4218. The midpoint 4236 of the bracket 4230 can be affixed to, or formed with, the distal end 4226 of the lower arm 4222. As indicated, each end 4232, 4234 of the bracket 4230 can be formed with a bore 4238, 4240 generally perpendicular to each end 4232, 4234 and lying along an axis perpendicular to the central, long axis 4218.

In another aspect, the lower arm 4222 can be a threaded rod that can have a threaded proximal end installed in a threaded bore formed in the upper portion 4206 of the body 4202 at the midpoint 4220 of the upper portion 4206 of the body 4202. The threaded rod can also have a threaded distal end that can be installed in a threaded bore formed in the bracket 4230 at the midpoint 4236 of the bracket 4230.

An axle 4242 can extend through the ends 4232, 4234 of the bracket 4230. In a particular aspect, the axle 4242 can be press fitted into the bores 4238, 4240 formed in the ends 4232, 4234 of the bracket 4230. In another aspect, one or both of the bores 4238, 4240 can be machined, or otherwise formed with, female threads and the axle 4242 can be machined, or otherwise formed with, male threads and the axle 4242 can be threadably engaged with one or both of the bores 4238, 4240.

As further illustrated, a spur 4250 can be installed within the bracket 4230 on the axle 4242. The spur 4250 can rotate on the axle 4242. Further, the spur 4250 can include a central body 4252 and a plurality of tines 4254 can extend radially outward from the central body 4252 of the spur 4250. The spur 4250 can include a bore 4256 formed perpendicularly through a middle of the central body 4252. The bore 4256 formed in the spur 4250 can have a diameter that is slightly larger than a diameter of the axle 4242. As such, the spur 4250 can rotate on the axle 4242.

As depicted in FIG. 42h, the attachment rod 4204 can include a generally straight, or linear, body 4260. The body 4260 can include a first end 4262 and a second end 4264. The ends 4262, 4264 of the body 3402 can be formed with external, or male, threads. A first end piece 4266 can be machined, or otherwise formed, to include a bore having internal, or female, threads and the first end piece 4266 can be threadably engaged with the first end 4262 of the body 4204. A second end piece 4268 can also be machined, or otherwise formed, with a bore having internal threads. The second end piece 4268 can be threadably engaged with the second end 4264 of the body 4260. The end pieces 4266, 4268 can be spherical, as shown, or the end pieces 4266, 4268 can be any of the end pieces described herein.

FIG. 43 includes another exhaust tip assembly that is designated 4300. The exhaust tip assembly 4300 can include an exhaust tip 4302 similar to the exhaust tip 302 illustrated in FIG. 3a through FIG. 3d and described herein. Further, the exhaust tip assembly 4300 can include an exhaust pipe tether, e.g., the exhaust pipe tether 4200 illustrated in FIG. 42a and FIG. 42h. The upper portion 4206 of the body 4202 can be fitted around the exhaust tip 4302 and the attachment rod 4204 can be installed through the ends 4208, 4210 of the upper portion 4206 of the body 4202 and through the exhaust tip 4302 and the end pieces 4266, 4268 can be threadably engaged with the ends 4262, 4264 of the body 4260 of the attachment rod 4204. Thereafter, the exhaust pipe tether 4200 can hang generally downward from the exhaust tip 4302 and the exhaust pipe tether 4200 can be used to secure a leash as described herein.

In another embodiment, as indicated in FIG. 44 and FIG. 45, an exhaust pipe tether 4400 can include a body 4404 having an upper portion 4406 and an attachment rod 4408 similar to the upper portion 4206 and the attachment rod 4204 described in conjunction with FIG. 42a through FIG. 42h. However, in lieu of a lower arm 4222, a rod 4410 can be threaded, or otherwise affixed, into a bore formed along a midpoint 4412 of the upper portion 4406 of the body 4404. Specifically, a proximal end 4414 of the threaded rod 4410 can be threadably engaged with the body 4404, as shown, and an end piece 4416, 4516 can be threadably engaged with a distal end 4418 of the rod 4410. The end piece 4416, 4516 can be any of the end pieces described herein.

Referring now to FIG. 46a through FIG. 188d, various end pieces are illustrated. FIG. 46a is a front/rear plan view, FIG. 46b is a left/right side plan view, FIG. 46c is a first end plan view, and FIG. 46d is a second end view of the end piece 4600. The end piece 4600 can be generally circular in a cross-section taken perpendicular to a longitudinal axis. The end piece 4600 can include a flat end 4602 that can be formed with a bore 4604 and a pointed end 4606 that can be formed with four flat, angled surfaces 4608.

FIG. 47a is a front/rear plan view of an end piece 4700. FIG. 47b is a left/right side plan view. FIG. 47c is a first end view and FIG. 47d is a second end view. The end piece 4700 can be generally square in a cross-section taken perpendicular to a longitudinal axis. The end piece 4700 can include a flat end 4702 that can be formed with a bore 4704 and a pointed end 4706 that can be formed with four flat, angled surfaces 4708.

FIG. 48a is a front/rear/left side/right side plan view of an end piece 4800. FIG. 48b is a first end view and FIG. 48c is a second end view of the end piece 4800. The end piece 4800 can be generally square in a cross-section taken perpendicular to a longitudinal axis. The end piece 4800 can include a flat end 4802 that can be formed with a bore 4804 and a pointed end 4806 that can be formed with four flat, angled surfaces 4808

FIG. 49a is a front/rear plan view of yet another end piece 4900. FIG. 49b is a left/right side plan view of the end piece 4900. FIG. 49c is a first end view and FIG. 49d is a second end view. The end piece 4900 can be generally hexagonal in a cross-section taken perpendicular to a longitudinal axis. The end piece 4900 can include a flat end 4902 that can be formed with a bore 4904 and a pointed end 4906 that can be formed with six flat, angled surfaces 4908.

FIG. 50a is a front/rear plan view of still another end piece 5000. FIG. 50b is a left/right side plan view of the end piece 5000. FIG. 50c is a first end view and FIG. 50d is a second end view. The end piece 5000 can be generally hexagonal in a cross-section taken perpendicular to a longitudinal axis. The end piece 5000 can include a first flat end 5002 that can be formed with a bore 5004 and a second flat end 5006.

FIG. 51a is a front/rear/left/right side plan view of an end piece 5100. FIG. 51b is a first end view and FIG. 51c is a second end view. The end piece 5100 can be generally circular in a cross-section taken perpendicular to a longitudinal axis. The end piece 5100 can include generally cylindrical central portion 5102, a relatively short conical portion 5104 extending from the central portion 5102, and a relatively long conical portion 5106 extending from the central portion 5102 opposite the relatively short conical portion 5104. The relatively short conical portion can be formed with a bore 5108.

FIG. 52a is a front/rear/left/right side plan view of an end piece 5200. FIG. 52b is a first end view and FIG. 52c is a second end view. The end piece 5200 can be generally circular in a cross-section taken perpendicular to a longitudinal axis. The end piece 5200 can be generally conical and can include small flat end 5202 and a large flat end 5204 that can be formed with a bore 5204.

FIG. 53a is a front/rear/left/right side plan view of an end piece 5300. FIG. 53b is a first end view and FIG. 53c is a second end view. The end piece 5300 can be generally circular in a cross-section taken perpendicular to a longitudinal axis. The end piece 5300 can include a generally conical portion 5302 that can terminate in a relatively small flat end 5304 and a generally cylindrical portion 5306 that can terminate in a relatively large flat end 5308 that can be formed with a bore 5310.

FIG. 54a is a front/rear/left/right side plan view of an end piece 5400. FIG. 54b is a first end view and FIG. 54c is a second end view. The end piece 5400 can be generally circular in a cross-section taken perpendicular to a longitudinal axis. The end piece 5400 can include a first generally conical portion 5402 that can terminate in a relatively small flat end 5404 and a second generally conical portion 5406 that can terminate in a relatively large flat end 5408 that can be formed with a bore 5410.

FIG. 55a is a front/rear/left/right side plan view of an end piece 5500. FIG. 55b is a first end view and FIG. 55c is a second end view. The end piece 5500 can be generally circular in a cross-section taken perpendicular to a longitudinal axis. The end piece 5500 can include a generally cylindrical central portion 5502. A first generally conical portion 5504 can extend from the central portion 5502 and can terminate in a flat end 5506. A second generally conical portion 5508 can extend from the central portion 5502 opposite the first conical portion 5504 and can terminate in a flat end 5510 that can be formed with a bore 5512.

FIG. 56a is a front/rear/left/right side plan view of an end piece 5600. FIG. 56b is a first end view and FIG. 56c is a second end view. The end piece 5600 can be generally circular in a cross-section taken perpendicular to a longitudinal axis. The end piece 5600 can include a generally cylindrical central portion 5602. A first, relatively long, generally conical portion 5604 can extend from the central portion 5602 and can terminate in a relatively small flat end 5606. A second, relatively short, generally conical portion 5608 can extend from the central portion 5602 opposite the first conical portion 5604 and can terminate in a relatively large flat end 5610 that can be formed with a bore 5612.

FIG. 57a is a front/rear/left/right side plan view of an end piece 5700. FIG. 57b is a first end view and FIG. 57c is a second end view. The end piece 5700 can be generally circular in a cross-section taken perpendicular to a longitudinal axis. The end piece 5700 can include a generally conical portion 5702 that can terminate in a relatively small flat end 5704 and a generally cylindrical portion 5706 that can terminate in a relatively large flat end 5708 that can be formed with a bore 5710.

FIG. 58a is a front/rear/left/right side plan view of an end piece 5800. FIG. 58b is a first end view and FIG. 58c is a second end view. The end piece 5800 can be generally circular in a cross-section taken perpendicular to a longitudinal axis. The end piece 5800 can include a generally cylindrical central portion 5802. A first, relatively long, generally conical portion 5804 can extend from the central portion 5802 and can terminate in a relatively small flat end 5806. A second, relatively short, generally conical portion 5808 can extend from the central portion 5802 opposite the first conical portion 5804 and can terminate in a relatively large flat end 5810 that can be formed with a bore 5812.

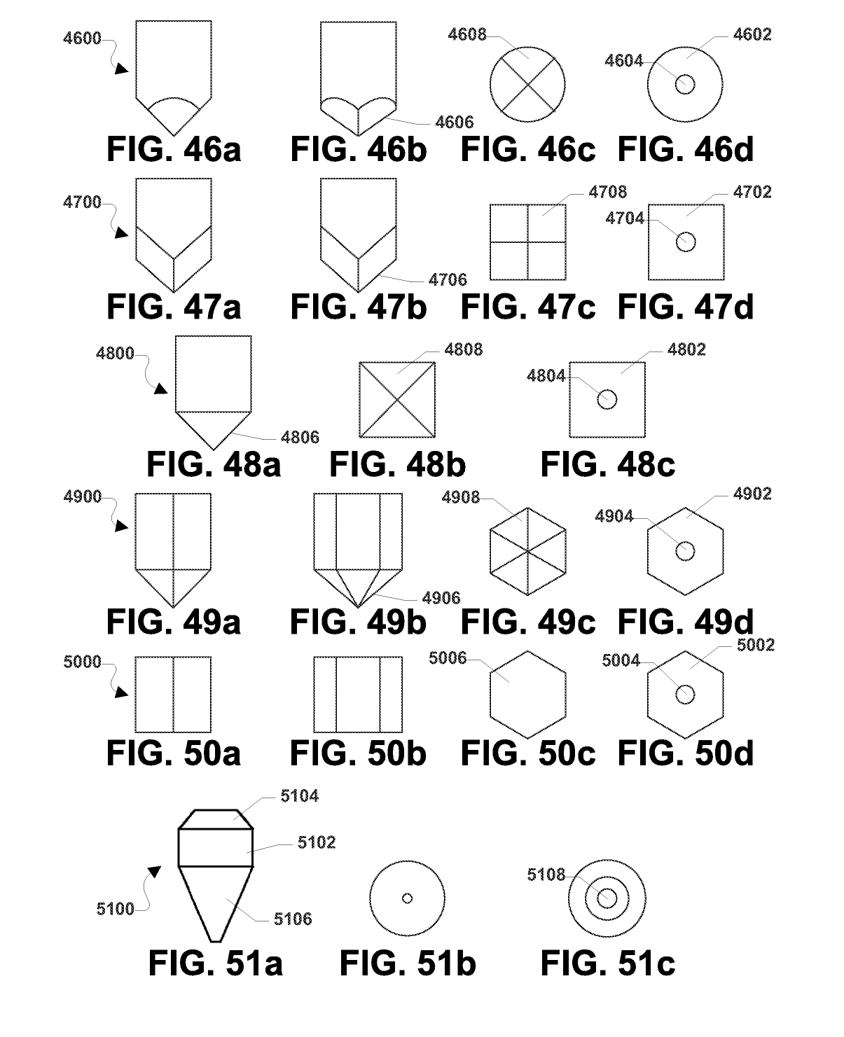

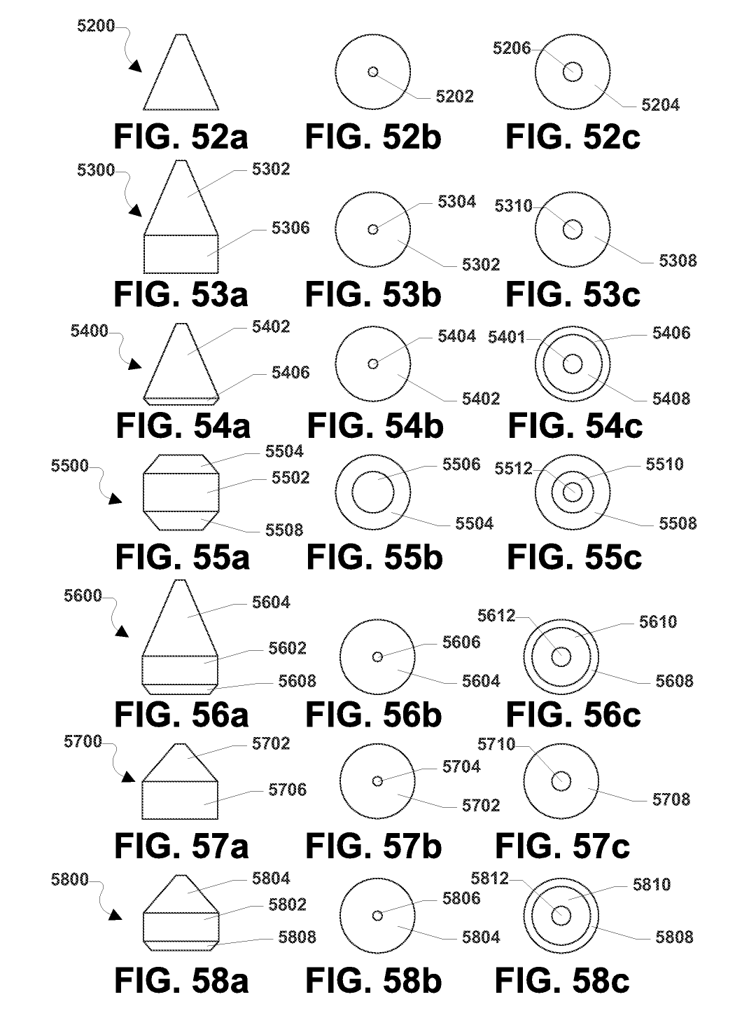

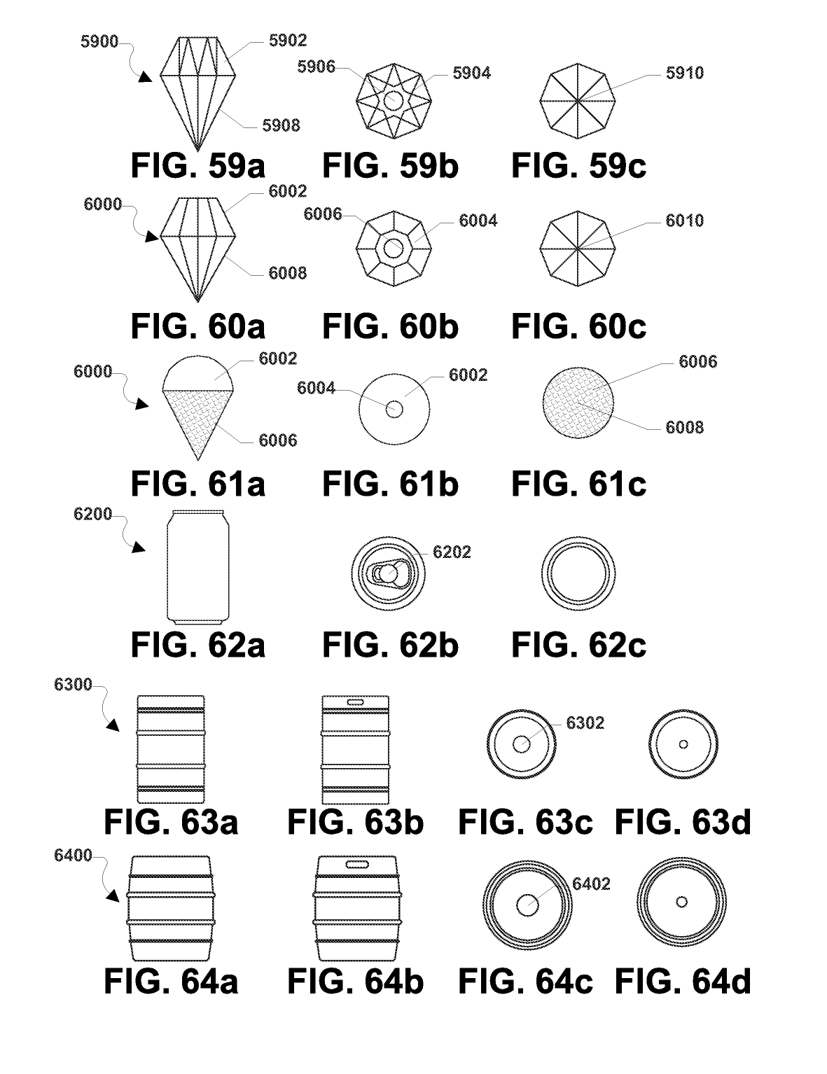

FIG. 59a is a front/rear/left/right side plan view of an end piece 5900 that is generally shaped like a jewel. FIG. 59b is a first end view and FIG. 59c is a second end view. The end piece 5900 can include a relative short, first multi-faceted portion 5902 that can terminate in a flat end 5904 that can be formed with a bore 5906. The end piece can include a relatively long, second multi-faceted portion 5908 that can terminate in a point 5910.

FIG. 60a is a front/rear/left/right side plan view of another end piece 6000 that is generally shaped like a jewel. FIG. 60b is a first end plan view and FIG. 60c is a second end view. The end piece 6000 can include a relative short, first multi-faceted portion 6002 that can terminate in a flat end 6004 that can be formed with a bore 6006. The end piece can include a relatively long, second multi-faceted portion 6008 terminating in a point 6010

FIG. 61a is a front/rear/left/right side plan view of yet another end piece 6100 that is generally shaped like an ice cream cone. FIG. 61b is a first end view and FIG. 61c is a second end view. The end piece 6100 can include an upper rounded portion 6102 formed with a central bore 6104 and a conical portion 6108 that can terminate in a point 6110. Further, the conical portion 6108 can be textured to simulate a waffle cone.

FIG. 62a is a front/rear/left/right side plan view of yet another end piece 6200 that is generally shaped like a can, e.g., a soda can or a beer can. FIG. 62b is a first end view and FIG. 62c is a second end view. The can-shaped end piece 6200 can include a bore 6202 therein.

FIG. 63a is a front/rear plan view of an end piece 6300 that is shaped generally like a beer keg. FIG. 63b is a left/right side plan view FIG. 63c is a first end view and FIG. 63d is a second end view. The keg-shaped end piece 6300 can include a bore 6302 therein.

FIG. 64a is a front/rear plan view of another end piece 6400 that is generally shaped like a beer keg FIG. 64b is a left/right side plan view. FIG. 64c is a first end view and FIG. 64d is a second end view. The keg-shaped end piece 6400 can include a bore 6402 formed therein.

FIG. 65a is a front/rear plan view of yet another end piece 6500 that is generally shaped like a heart. FIG. 65b is a left/right side plan view FIG. 65c is a first end view and FIG. 65d is a second end view. The heart-shaped end piece 6500 can include a bore 6502 therein.

FIG. 66a is a front/rear/left/right side plan view of yet another end piece 6600 that is generally shaped like a bottle, e.g., a soda bottle or a beer bottle. FIG. 66b is a first end view and FIG. 66c is a second end view. The bottle-shaped end piece 6600 can include a bore 6602 therein.

FIG. 67a is a front/rear/left/right side plan view of yet another end piece 6700 that is generally shaped like a bowling pin. FIG. 67b is a first end view and FIG. 67c is a second end view. The bowling pin-shaped end piece 6700 can include a bore 6702 formed in an end thereof.

FIG. 68a is a front/rear/left/right side plan view of yet another end piece 6800 that is generally shaped like a shotgun shell. FIG. 68b is a first end view and FIG. 68c is a second end view. The shotgun shell-shaped end piece 6800 can include a bore 6804 in an end thereof.

FIG. 69a is a front/rear/left/right side plan view of yet another end piece 6900 that is generally shaped like a bullet.

FIG. 69b is a first end view and FIG. 69c is a second end view. The bullet-shaped end piece 6900 can include a bore 6902 formed in an end.

FIG. 70a is a front/rear/left/right side plan view of an end piece 7000 that is shaped like chalk for a pool cue. FIG. 70b is a top plan view and FIG. 70c is a bottom plan view. The chalk-shaped end piece 7000 can include a bore 7002 formed in an end.

FIG. 71a is a top/bottom/front/rear plan view of an end piece 7100 that is shaped like a stack of barbell weights. FIG. 71b is a left side plan view and FIG. 71c is a right side plan view of the end piece 7100. The end piece 7100 can include a bore 7102 in an end thereof.

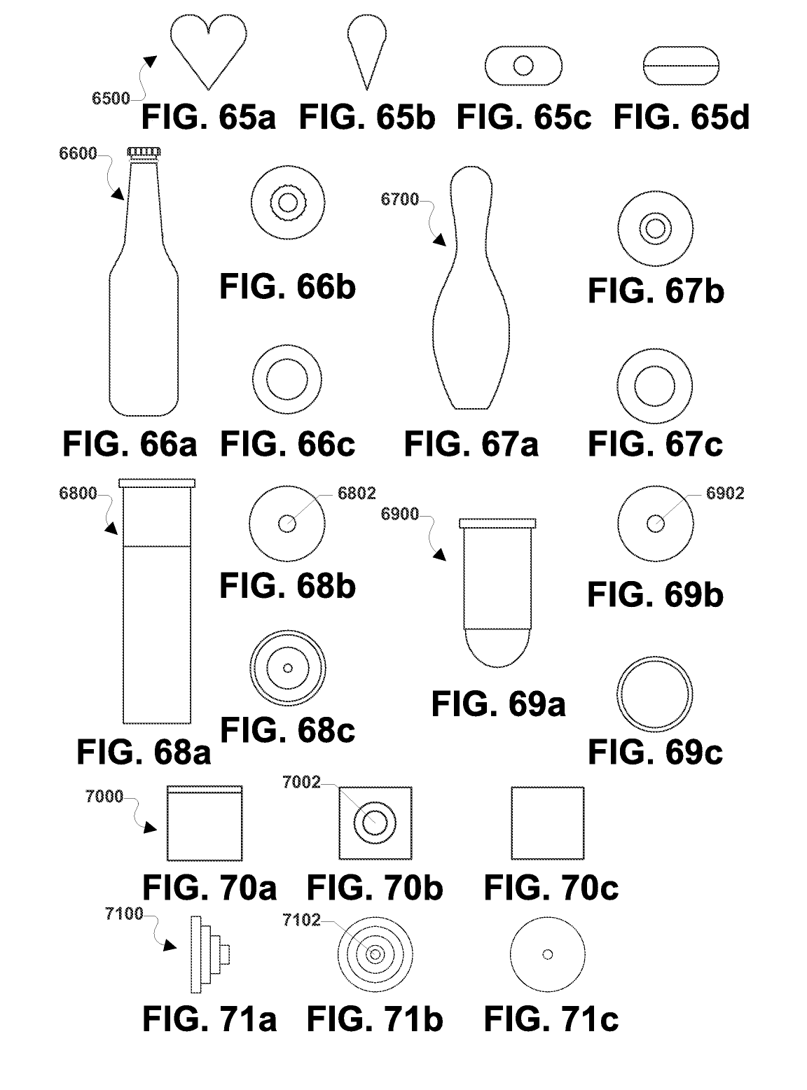

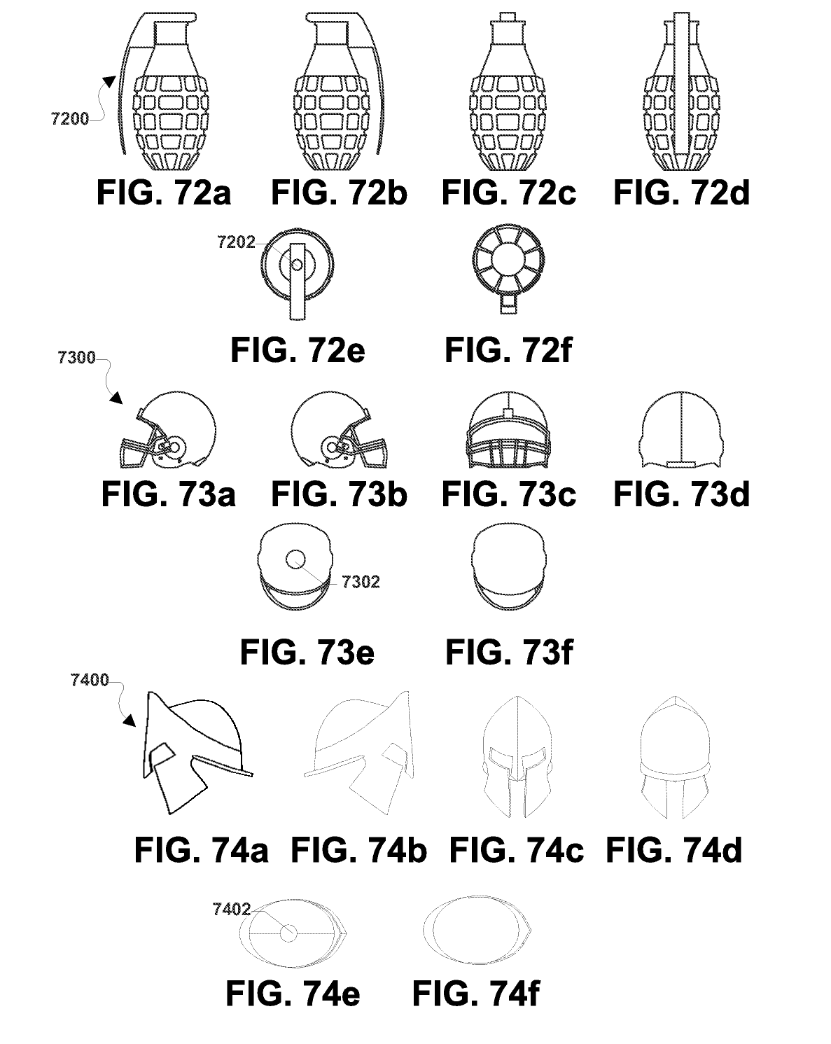

FIG. 72a is a left side plan view of an end piece 7200 that is shaped like a hand grenade. FIG. 72h is a right side plan view FIG. 72c is a front plan view FIG. 72d is a rear plan view. FIG. 72e is a top plan view and FIG. 72f is a bottom plan view of the end piece 7200. The grenade-shaped end piece 7200 can include a bore 7202.

FIG. 73a is a left side plan view of an end piece 7300 that is shaped like a football helmet. FIG. 73b is a right side plan view. FIG. 73c is a front plan view. FIG. 73d is a rear plan view. FIG. 73e is a top plan view and FIG. 73f is a bottom plan view of the end piece 7300. The helmet-shaped end piece 7300 can include a bore 7302.

FIG. 74a is a left side plan view of an end piece 7400 that is shaped like a Spartan helmet. FIG. 74b is a right side plan.

FIG. 74c is a front plan view. FIG. 74d is a rear plan view. FIG. 74e is a top plan view and FIG. 74f is a bottom plan view of the end piece 7400. The helmet-shaped end piece 7400 can include a bore 7402 therein.

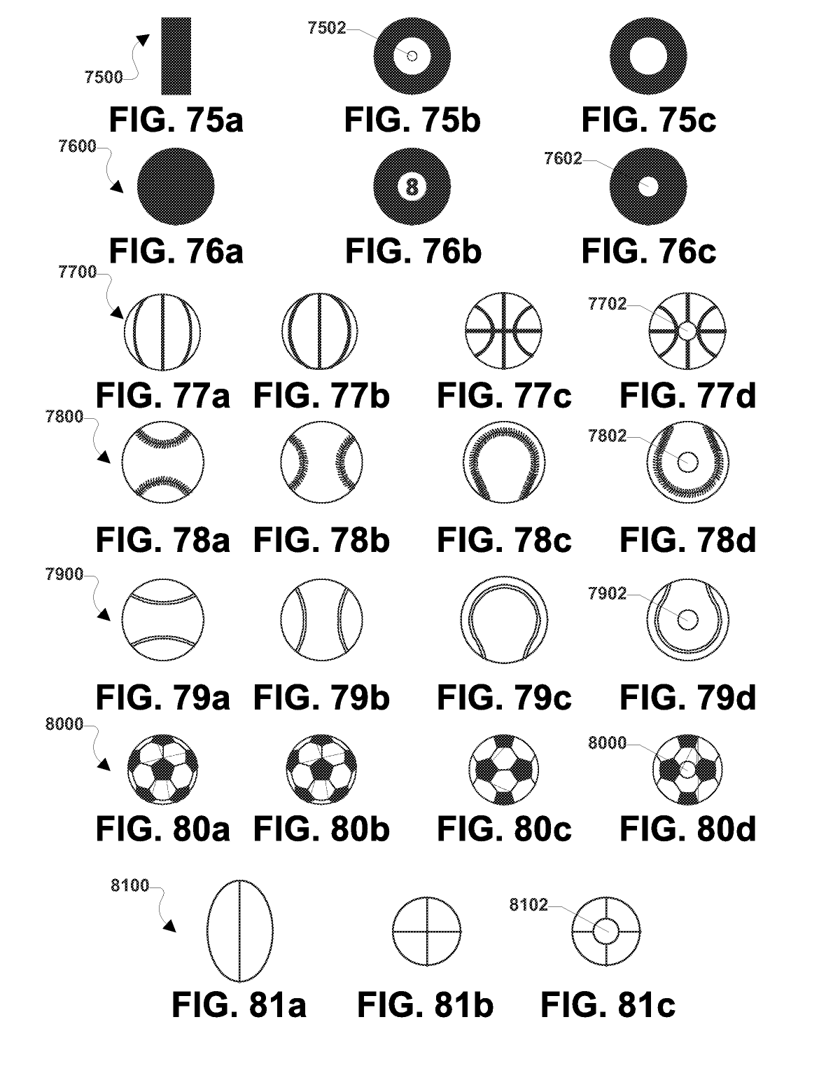

FIG. 75a is a top/bottom/front/rear plan view of an end piece 7500 that is shaped like a tire/wheel assembly. FIG. 75b is a left side plan view and FIG. 75c is a right side plan view of the end piece 7500. The end piece 7500 can include a bore 7502 formed therein.

FIG. 76a is a left side/right side/bottom/rear plan view of an end piece 7600 that is shaped like a billiard ball, e.g., an eight ball FIG. 76b is a front plan view and FIG. 76c is a top plan view of the end piece 7600. The end piece 7600 can include a bore 7602 formed therein.

FIG. 77a is a front/rear plan view of an end piece 7700 that is shaped like a basketball. FIG. 77b is a left/right side plan view of the end piece 7700. FIG. 77c is a bottom plan view and FIG. 77d is a top plan view of the end piece 7700. As depicted, the basketball-shaped end piece 7700 can include a bore 7702 formed therein.

FIG. 78a is a front/rear plan view of an end piece 7800 that is shaped like a baseball or a softball. FIG. 78b is a left/right side plan view FIG. 78c is a bottom plan view and FIG. 78d is a top plan view of the end piece 7800. As depicted, the baseball-shaped end piece 7800 can include a bore 7802 formed therein.

FIG. 79a is a front/rear plan view of an end piece 7900 that is shaped like a tennis ball. FIG. 79b is a left/right side plan view of the end piece 7900. FIG. 79c is a bottom plan view and FIG. 79d is a top plan view of the end piece 7900. As depicted, the tennis ball-shaped end piece 7900 can include a bore 7902 therein.

FIG. 80a is a front/rear plan view of an end piece 8000 that is shaped like a soccer ball. FIG. 80b is a left/right side plan view. FIG. 80c is a bottom plan view and FIG. 80d is a top plan view of the end piece 8000. As depicted, the soccer ball-shaped end piece 8000 can include a bore 8002 formed therein.

FIG. 18a is a front/rear/left/right side plan view of an end piece 8100 that is shaped like a rugby ball. FIG. 81b is a bottom plan view and FIG. 81c is a top plan view. The end piece 8100 can include a bore 8102 therein.

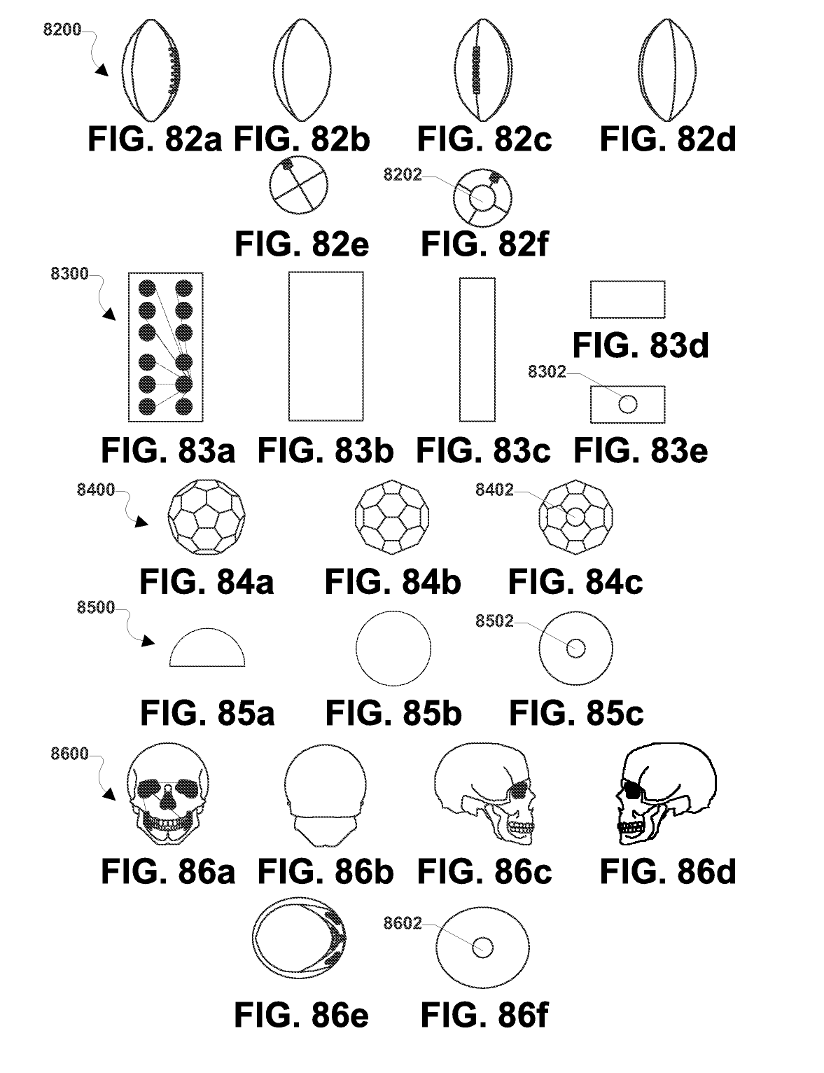

FIG. 82a is a front plan view of an end piece 8200 that is shaped like a football. FIG. 82b is a rear plan view. FIG. 82c is a right side plan view. FIG. 82d is a left side plan view. FIG. 82e is a bottom plan view and FIG. 82f is a top plan view. As depicted, the football-shaped end piece 8200 can include a bore 8202 formed therein.

FIG. 83a is a front plan view of an end piece 8300 that is shaped like a domino. FIG. 83b is a rear plan view. FIG. 83c is a left/right side plan view of the end piece 8300. FIG. 83d is a bottom plan view and FIG. 83e is a top plan view. The domino-shaped end piece 8300 can include a bore 8302 formed therein.

FIG. 84a is a front/rear/left/right side plan view of an end piece 8400 that is shaped like a disco ball FIG. 84b is a bottom plan view and FIG. 84c is a top plan view of the end piece 8400. As depicted, the disco ball-shaped end piece 8400 can include a bore 8402 formed therein.

FIG. 85a is a front/rear/left side/right side plan view of an end piece 8500 that is shaped like a hemisphere. FIG. 85b is a bottom plan view and FIG. 85c is a top plan view of the end piece 8500. As depicted, the hemispherical end piece 8500 can include a bore 8502 formed therein.

FIG. 86a is a front plan view of an end piece 8600 that is shaped like a human skull. FIG. 86b is a rear plan view. FIG. 86c is a left side plan view. FIG. 86d is a right side plan view. FIG. 86e is a bottom plan view and FIG. 86f is a top plan view of the end piece 8600. The skull-shaped end piece 8600 can include a bore 8602 therein.

FIG. 87a is a front plan view of an end piece 8700 that is shaped like a racing helmet. FIG. 87b is a rear plan view.

FIG. 87c is a left side plan. FIG. 87d is a right side plan view. FIG. 87e is a top plan view and FIG. 87f is a bottom plan view. The helmet-shaped end piece 8700 can include a bore 8702 formed therein.

FIG. 88a is a front plan view of an end piece 8800 that is shaped like auto emblem. FIG. 88b is a rear plan view. FIG. 88c is a left/right side plan view. FIG. 88d is a bottom plan view and FIG. 88e is a top plan view. As depicted, the emblem-shaped end piece 8800 can include a bore 8802 therein.

FIG. 89a is a front/rear plan view of an end piece 8900 that is shaped like oval emblem. FIG. 89b is a left/right side plan view. FIG. 89c is a top plan view of the end piece 8900 and FIG. 89d is a bottom plan view of the end piece 8900. As depicted, the emblem-shaped end piece 8900 can include a bore 8902 formed therein.

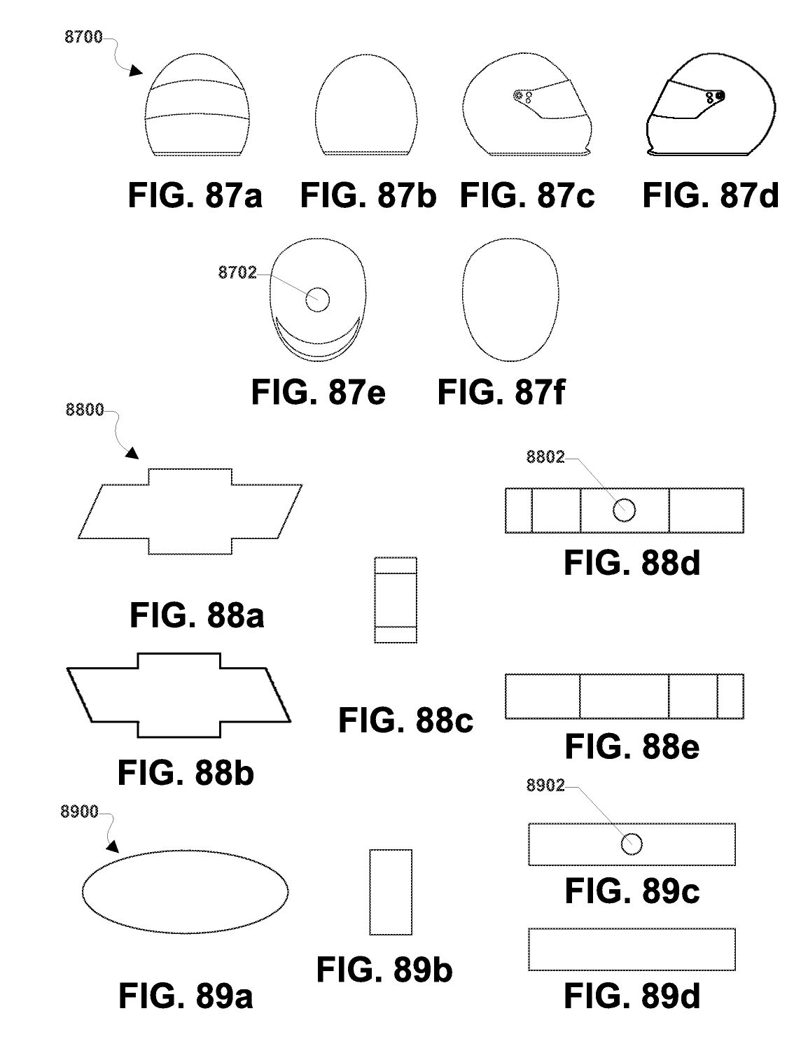

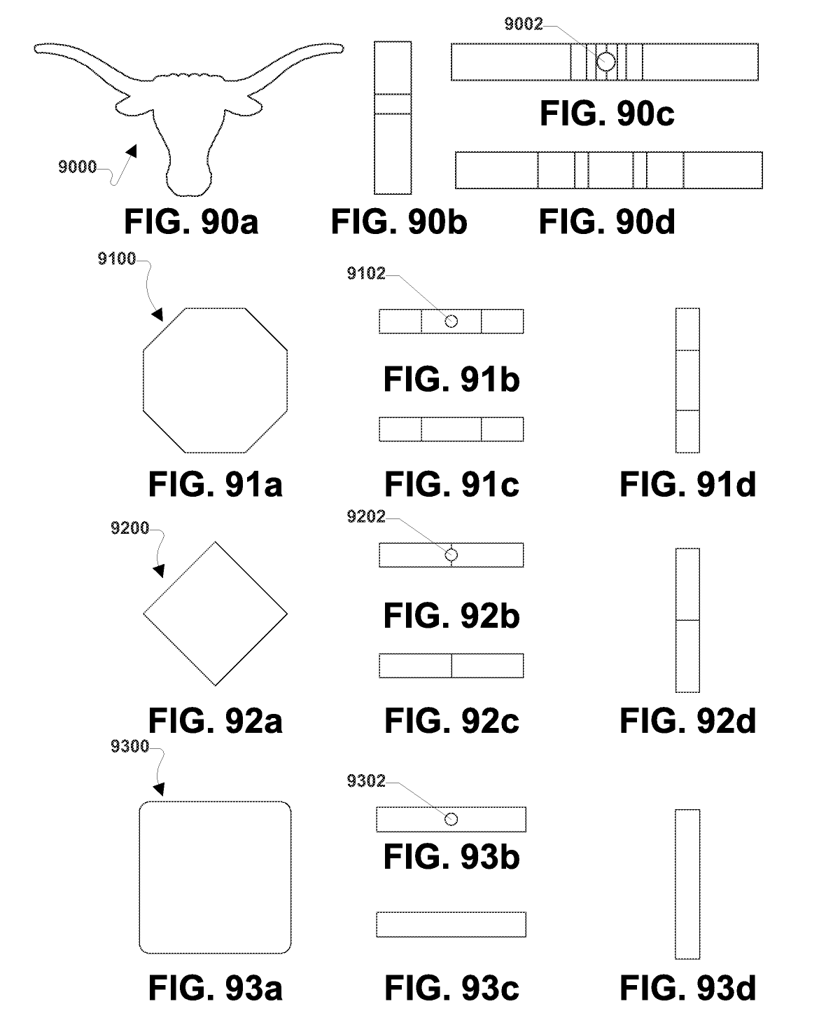

FIG. 90a is a front/rear plan view of an end piece 9000 that is shaped like a steer head. FIG. 90b is a left/right side plan view. FIG. 90c is a top plan view of the end piece 9000 and FIG. 90d is a bottom plan view of the end piece 9000. As depicted, the steer head-shaped end piece 9000 can include a bore 9002 formed therein.

FIG. 91a is a front/rear plan view of a first road sign-shaped end piece 9100. FIG. 91b is a top plan view. FIG. 91c is a bottom plan view and FIG. 91d is a left/right side plan view of the end piece 9100. As depicted, the road sign-shaped end piece 9100 can include a bore 9102 that can be machined, or otherwise formed, therein.

FIG. 92a is a front/rear plan view of a second road sign-shaped end piece 9200. FIG. 92b is a top plan view. FIG. 92c is a bottom plan view and FIG. 92d is a left/right side plan view of the end piece 9200. As depicted, the road sign-shaped end piece 9200 can include a bore 9202 that can be machined, or otherwise formed, therein.

FIG. 93a is a front/rear plan view of a third road sign-shaped end piece 9300. FIG. 93b is a top plan view. FIG. 93c is a bottom plan view and FIG. 93d is a left/right side plan view of the end piece 9300. As depicted, the road sign-shaped end piece 9300 can include a bore 9302 that can be machined, or otherwise formed, therein.

FIG. 94a is a front/rear plan view of a fourth road sign-shaped end piece 9400. FIG. 94b is a top plan view. FIG. 94c is a bottom plan view and FIG. 94d is a left/right side plan view of the end piece 9400. As depicted, the road sign-shaped end piece 9400 can include a bore 9402 that can be machined, or otherwise formed, therein.

FIG. 95a is a front/rear plan view of a fifth road sign-shaped end piece 9500. FIG. 95b is a top plan view. FIG. 95c is a bottom plan view and FIG. 95d is a left/right side plan view of the end piece 9500. As depicted, the road sign-shaped end piece 9500 can include a bore 9502 that can be machined, or otherwise formed, therein.

FIG. 96a is a front/rear plan view of a sixth road sign-shaped end piece 9600. FIG. 96b is a top plan view. FIG. 96c is a bottom plan view and FIG. 96d is a left/right side plan view of the end piece 9600. As depicted, the road sign-shaped end piece 9600 can include a bore 9602 that can be machined, or otherwise formed, therein.

FIG. 97a is a front/rear plan view of a seventh road sign-shaped end piece 9700. FIG. 97b is a top plan view. FIG. 97c is a bottom plan view and FIG. 97d is a left/right side plan view. As depicted, the road sign-shaped end piece 9700 can include a bore 9702 therein.

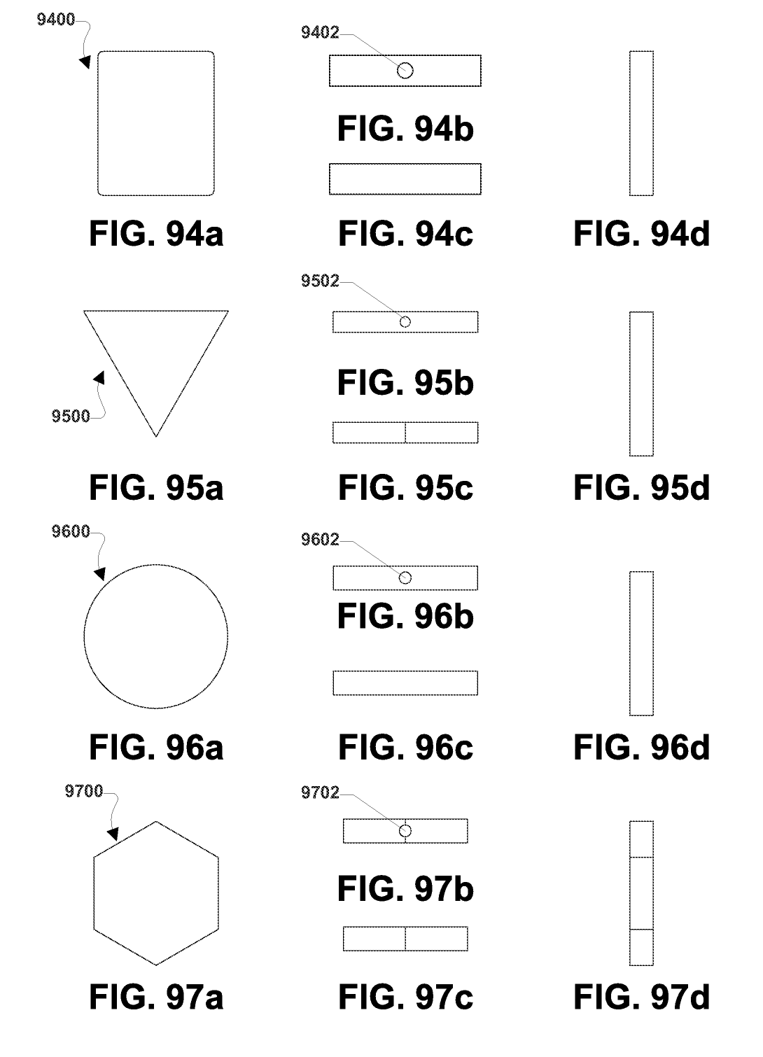

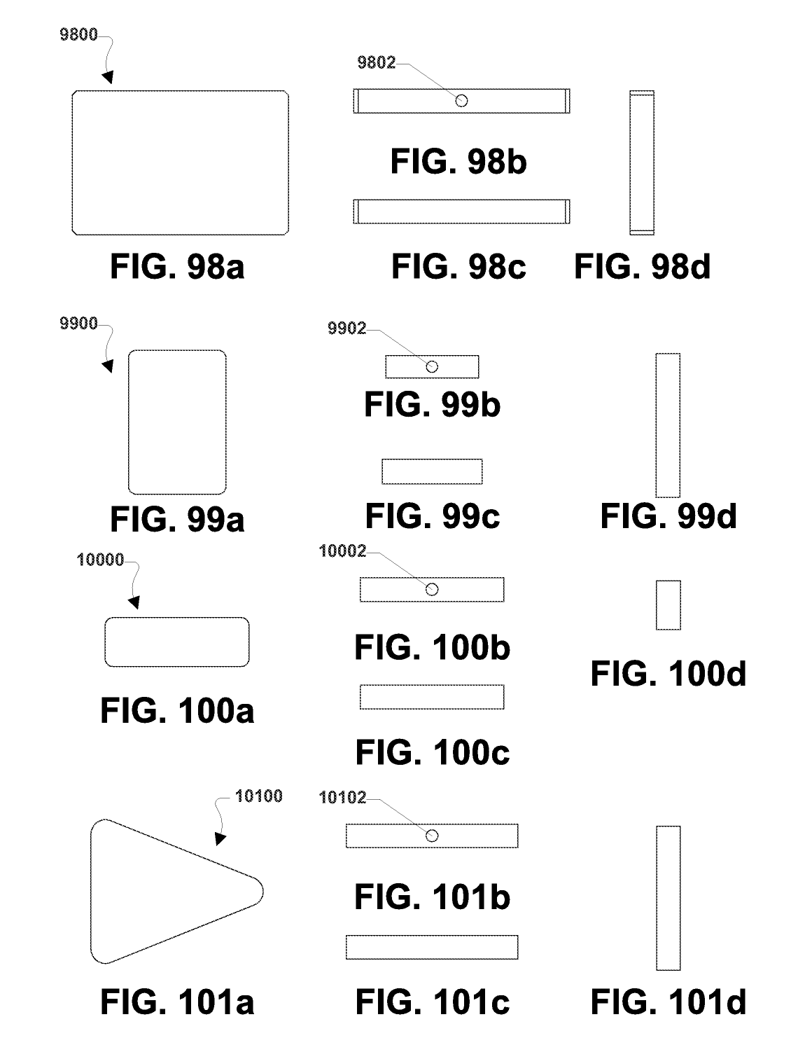

FIG. 98a is a front/rear plan view of an eighth road sign-shaped end piece 9800. FIG. 98b is a top plan view. FIG. 98c is a bottom plan view and FIG. 98d is a left/right side plan view. As depicted, the road sign-shaped end piece 9800 can include a bore 9802 therein.

FIG. 99a is a front/rear plan view of a ninth road sign-shaped end piece 9900. FIG. 99b is a top plan view. FIG. 99c is a bottom plan view and FIG. 99d is a left/right side plan view. As depicted, the road sign-shaped end piece 9900 can include a bore 9902 therein.

FIG. 100a is a front/rear plan view of a tenth road sign-shaped end piece 10000. FIG. 100b is a top plan view. FIG. 100c is a bottom plan view and FIG. 100d is a let/right side plan view. As depicted, the road sign-shaped end piece 10000 can include a bore 10002 therein.

FIG. 101a is a front/rear plan view of an eleventh road sign-shaped end piece 10100. FIG. 101b is a top plan view. FIG. 101c is a bottom plan view and FIG. 101d is a left/right side plan view. As depicted, the road sign-shaped end piece 10100 can include a bore 10102 therein.

FIG. 102a is a front/rear plan view of a twelfth road sign-shaped end piece 10200. FIG. 102b is a top plan view. FIG. 102c is a bottom plan view and FIG. 102d is a left/right side plan view. As depicted, the road sign-shaped end piece 10200 can include a bore 10202 therein.

FIG. 103a is a front/rear plan view of a thirteenth road sign-shaped end piece 10300. FIG. 103b is a top plan view. FIG. 103c is a bottom plan view and FIG. 103d is a left/right side plan view. As depicted, the road sign-shaped end piece 10300 can include a bore 10302 therein.

FIG. 104a is a front/rear plan view of a fourteenth road sign-shaped end piece 10400. FIG. 104b is a top plan view.

FIG. 104c is a bottom plan view and FIG. 104d is a left/right side plan view. As depicted, the road sign-shaped end piece 10400 can include a bore 10402 therein.

FIG. 105a is a front/rear plan view of a fifteenth road sign-shaped end piece 10500. FIG. 105b is a top plan view. FIG. 105c is a bottom plan view and FIG. 105d is a left/right side plan view. As depicted, the road sign-shaped end piece 10500 can include a bore 10502 therein.

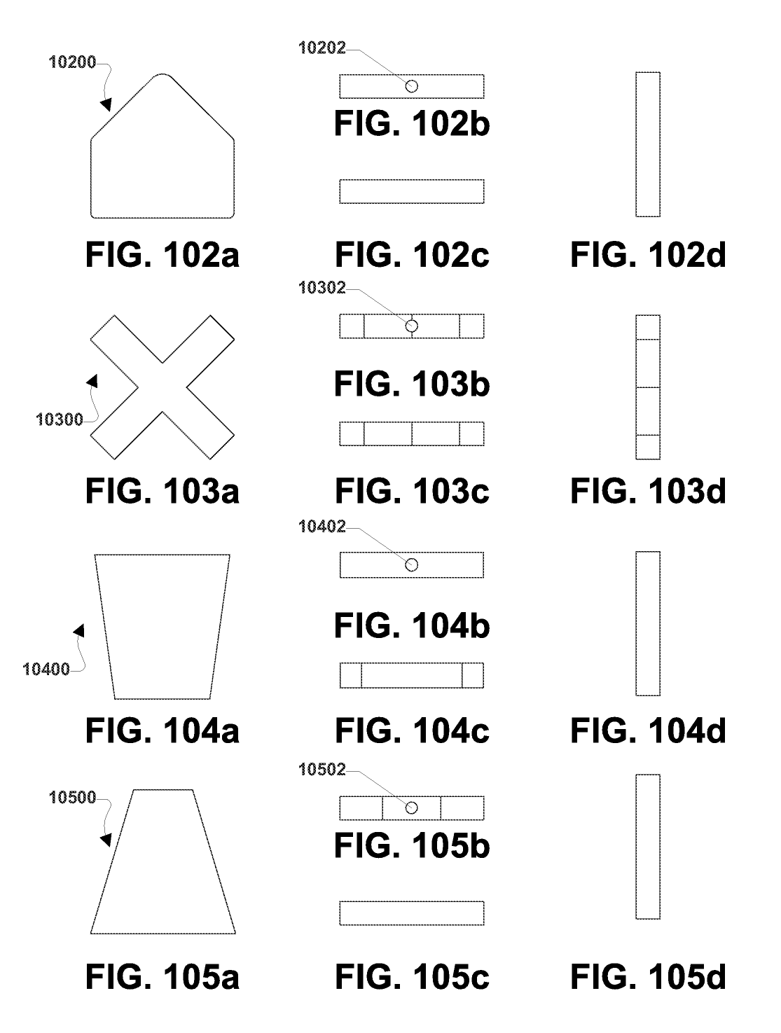

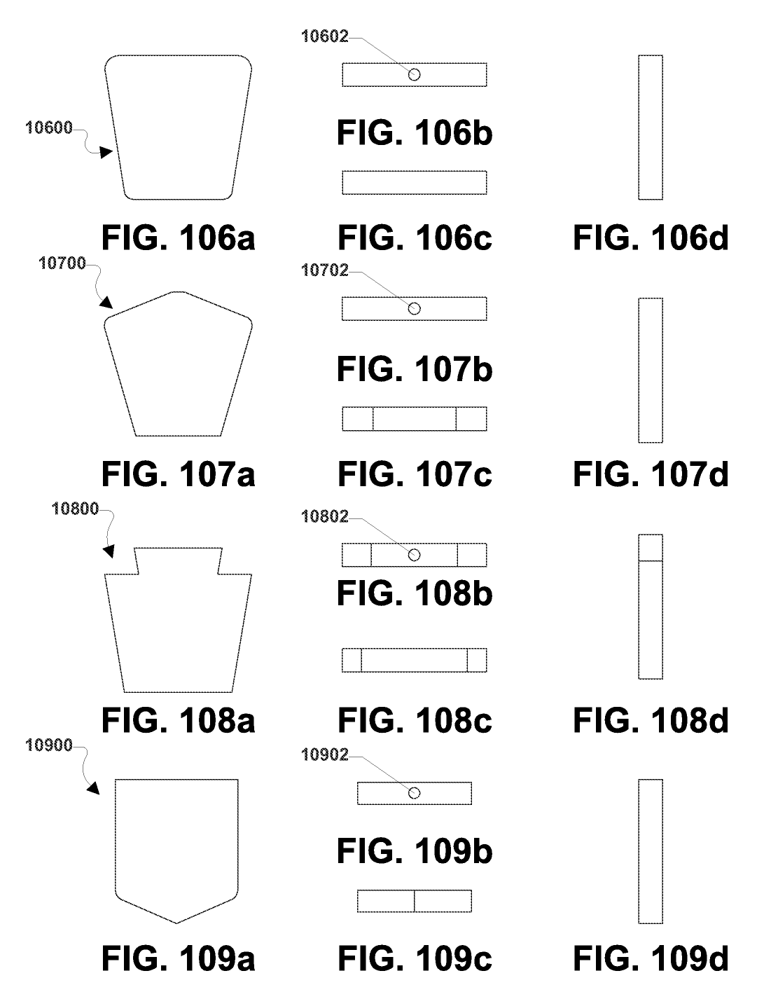

FIG. 106a is a front/rear plan view of a sixteenth road sign-shaped end piece 10600. FIG. 106b is a top plan view. FIG. 106c is a bottom plan view and FIG. 106d is a left/right side plan view. The end piece 10600 can include a bore 10602 therein.

FIG. 107a is a front/rear plan view of a seventeenth road sign-shaped end piece 10700. FIG. 107b is a top plan view.

FIG. 107c is a bottom plan view and FIG. 107d is a left/right side plan view. The road sign-shaped end piece 10700 can include a bore 10702 therein.

FIG. 108a is a front/rear plan view of an eighteenth road sign-shaped end piece 10800. FIG. 108b is a top plan view.

FIG. 108c is a bottom plan view and FIG. 108d is a left/right side plan view. The road sign-shaped end piece 10800 can include a bore 10802 therein.

FIG. 109a is a front/rear plan view of a nineteenth road sign-shaped end piece 10900. FIG. 109b is a top plan view.

FIG. 109c is a bottom plan view and FIG. 109d is a left/right side plan view. As depicted, the road sign-shaped end piece 10900 can include a bore 10902 therein.

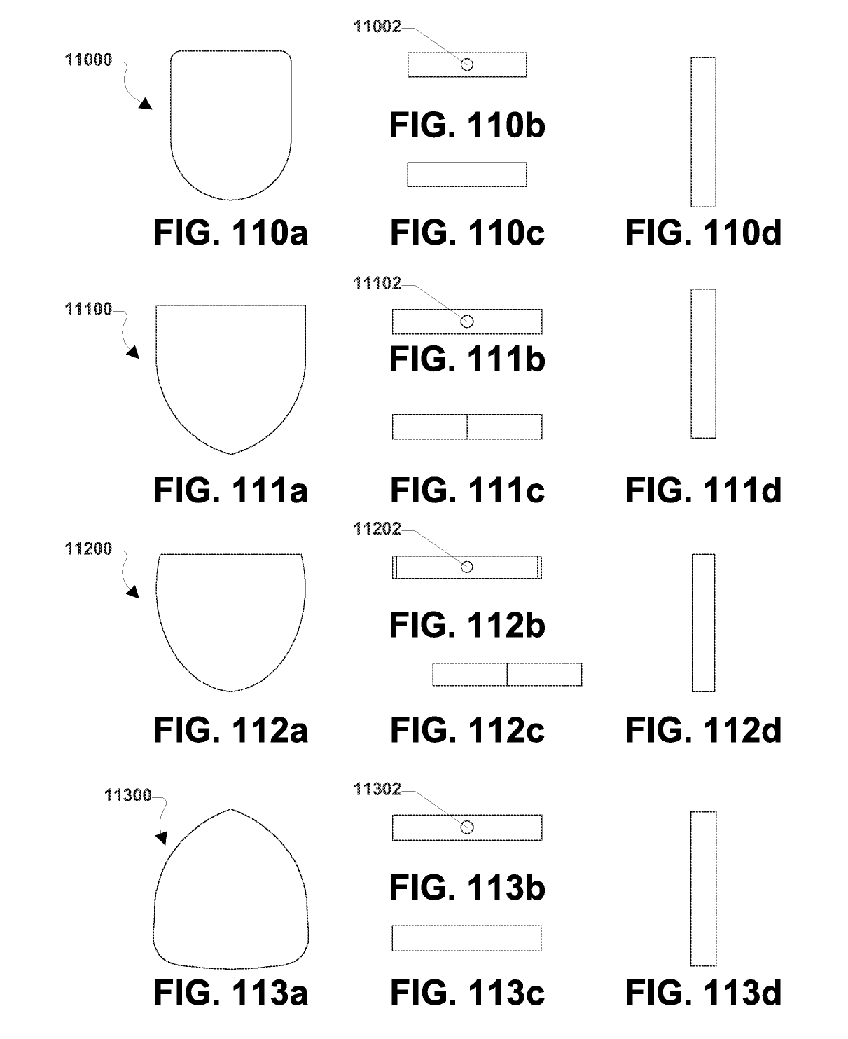

FIG. 110a is a front/rear plan view of a twentieth road sign-shaped end piece 11000. FIG. 110b is a top plan view.

FIG. 110c is a bottom plan view and FIG. 110d is a left/right side plan view. The mad sign-shaped end piece 11000 can include a bore 11002 formed therein.

FIG. 111a is a front/rear plan view of a twenty-first road sign-shaped end piece 11100. FIG. 111b is a top plan view. FIG. 111c is a bottom plan view and FIG. 111d is a left/right side plan view. The road sign-shaped end piece 11100 can include a bore 11102 therein.

FIG. 112a is a front/rear plan view of a twenty-second road sign-shaped end piece 11200. FIG. 112b is a top plan view.

FIG. 112c is a bottom plan view and FIG. 112d is a left/right side plan view. The mad sign-shaped end piece 11200 can include a bore 11202 formed therein.

FIG. 113a is a front/rear plan view of a twenty-third road sign-shaped end piece 11310. FIG. 113b is a top plan view FIG. 113c s a bottom plan view and FIG. 113d is a left/right side plan view. The road sign-shaped end piece 11310 can include a bore 11312.

FIG. 114a is a front/rear plan view of a twenty-fourth road sign-shaped end piece 11410. FIG. 114b is a top plan view. FIG. 114c is a bottom plan view and FIG. 114d is a left/right side plan view. The road sign-shaped end piece 11410 can include a bore 11412 therein.

FIG. 115a is a front/rear plan view of a twenty-fifth road sign-shaped end piece 11510. FIG. 115b is a top plan view.

FIG. 115c is a bottom plan view and FIG. 115d is a left/right side plan view. As depicted, the road sign-shaped end piece 11510 can include a bore 11512.

FIG. 116a is a front/rear plan view of a twenty-sixth road sign-shaped end piece 11610. FIG. 116b is a top plan view.

FIG. 116c is a bottom plan view and FIG. 116d is a left/right side plan view. As illustrated, the mad sign-shaped end piece 11610 can include a bore 11612.

FIG. 117a is a front/rear plan view of a twenty-seventh road sign-shaped end piece 11700. FIG. 117b is a top plan view. FIG. 117c is a bottom plan view and FIG. 117d is a left/right side plan view. As depicted, the road sign-shaped end piece 11700 can include a bore 11702.

FIG. 118a is a front/rear plan view of a twenty-eighth road sign-shaped end piece 11800. FIG. 18b is a top plan view.

FIG. 118c is a bottom plan view and FIG. 118d is a left/right side plan view. As depicted, the road sign-shaped end piece 11800 can include a bore 11802.

FIG. 19a is a front/rear plan view of a twenty-ninth road sign-shaped end piece 11900. FIG. 19b is a top plan view.

FIG. 119c is a bottom plan view and FIG. 19d is a left/right side plan view. As depicted, the road sign-shaped end piece 11900 can include a bore 11902.

FIG. 120a is a front/rear plan view of a thirtieth road sign-shaped end piece 12000. FIG. 120b is a top plan view FIG. 120c is a bottom plan view and FIG. 120d is a left/right side plan view. As depicted, the road sign-shaped end piece 12000 can include a bore 12002.

FIG. 121a is a front/rear plan view of a thirty-first road sign-shaped end piece 12100. FIG. 121b is a top plan view.

FIG. 121c is a bottom plan view and FIG. 121d is a left/right side plan view. As shown, the road sign-shaped end piece 12100 can include a bore 12103.

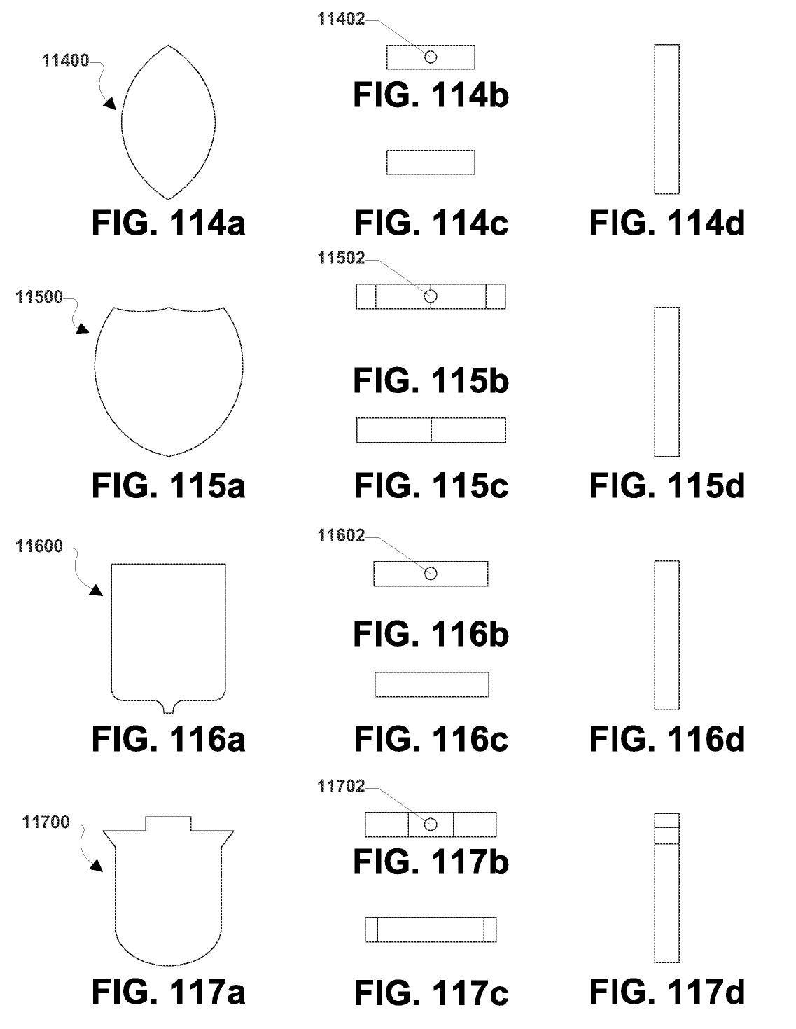

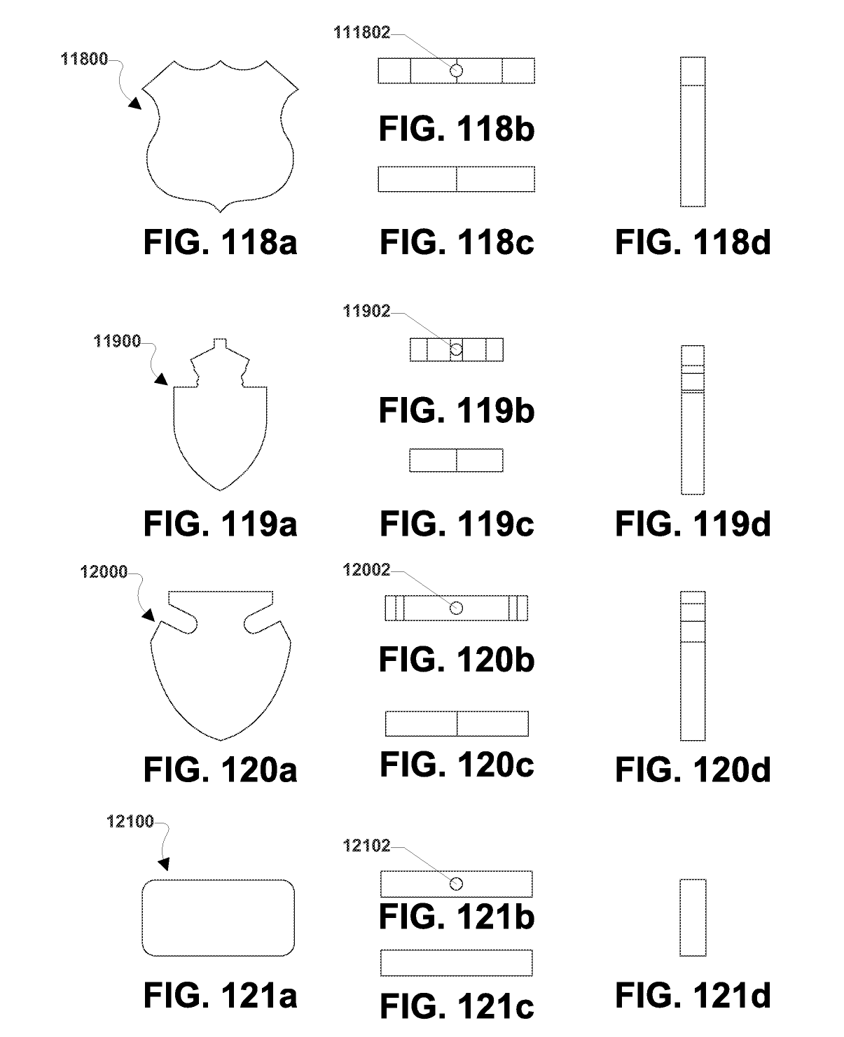

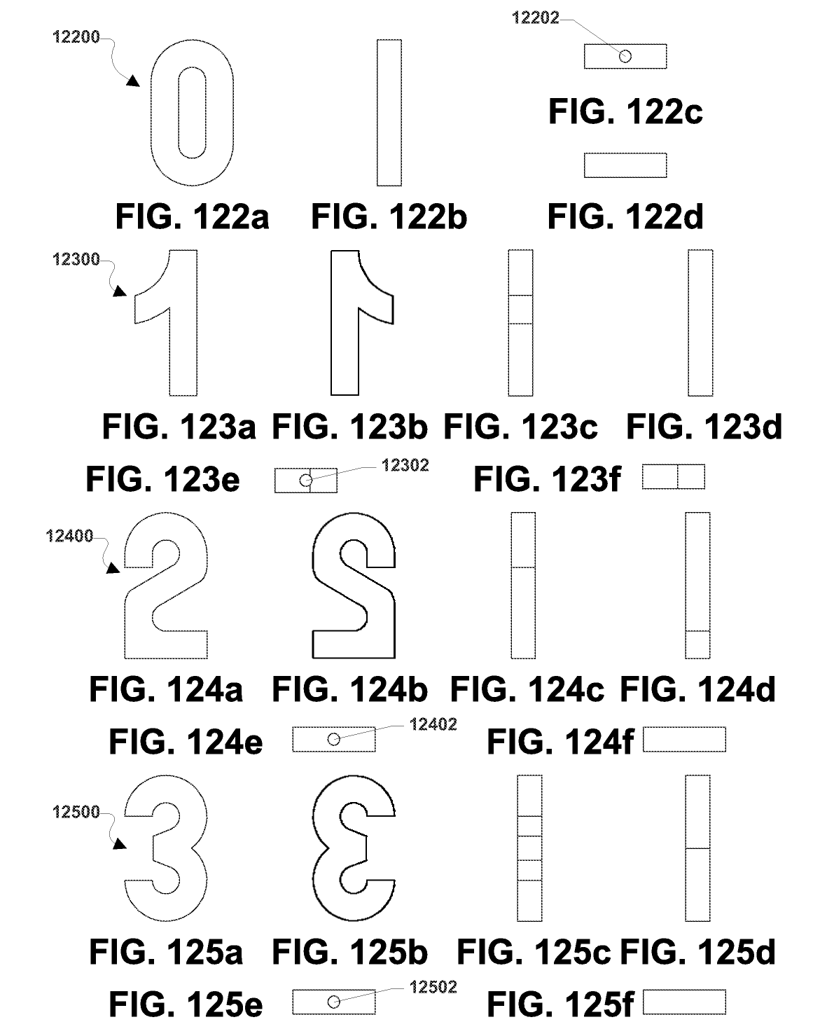

FIG. 122a is a front/rear plan view of an end piece 12200 shaped like the number zero FIG. 122b is a left/right side plan view. FIG. 122c is a top plan view and FIG. 122d is a bottom plan view. As depicted, the number-shaped end piece 12200 can include a bore 12202.

FIG. 123a is a front plan view of an end piece 12300 shaped like the number one. FIG. 123b is a rear plan view. FIG. 123c is a left side plan view. FIG. 123d is a right side plan view, FIG. 123e is a top plan view, and FIG. 123f is a bottom plan view of the end piece 12300. The number-shaped end piece 12300 can include a bore 12302.

FIG. 124a is a front plan view of an end piece 12400 shaped like the number two. FIG. 124b is a rear plan view, FIG. 124c is a left side plan view, FIG. 124d is a right side plan view, FIG. 124e is a top plan view, and FIG. 124f is a bottom plan view of the end piece 12400. The number-shaped end piece 12400 can include a bore 12402.

FIG. 125a is a front plan view of an end piece 12500 shaped like the number three. FIG. 125h is a rear plan view, FIG. 125c is a left side plan view, FIG. 125d is a right side plan view, FIG. 125e is a top plan view, and FIG. 125f is a bottom plan view of the end piece 12500. The number-shaped end piece 12500 can include a bore 12502.

FIG. 126a is a front plan view of an end piece 12600 shaped like the number four. FIG. 126b is a rear plan view, FIG. 126c is a left side plan view. FIG. 126d is a right side plan view, FIG. 126e is a top plan view, and FIG. 126f is a bottom plan view of the end piece 12600. The number-shaped end piece 12600 can include a bore 12602 therein.

FIG. 127a is a front plan view of an end piece 12700 shaped like the number five. FIG. 127b is a rear plan view. FIG. 127c is a left side plan view, FIG. 127d is a right side plan view, FIG. 127e is a top plan view, and FIG. 127f s a bottom plan view of the end piece 12700. The end piece 12700 can include a bore 12702 therein.

FIG. 128a is a front plan view of an end piece 12800 shaped like the number six. FIG. 128b is a rear plan view, FIG. 128c is a left side plan view, FIG. 128d is a right side plan view. FIG. 128e is a top plan view, and FIG. 128f is a bottom plan view of the end piece 12800. The number-shaped end piece 12800 can include a bore 12802.

FIG. 129a is a front plan view of an end piece 12900 shaped like the number seven. FIG. 129b is a rear plan view, FIG. 129c is a left side plan view, FIG. 129d is a right side plan view, FIG. 129e is a top plan view, and FIG. 129f is a bottom plan view of the end piece 12900. The end piece 12900 can include a bore 12902 therein.

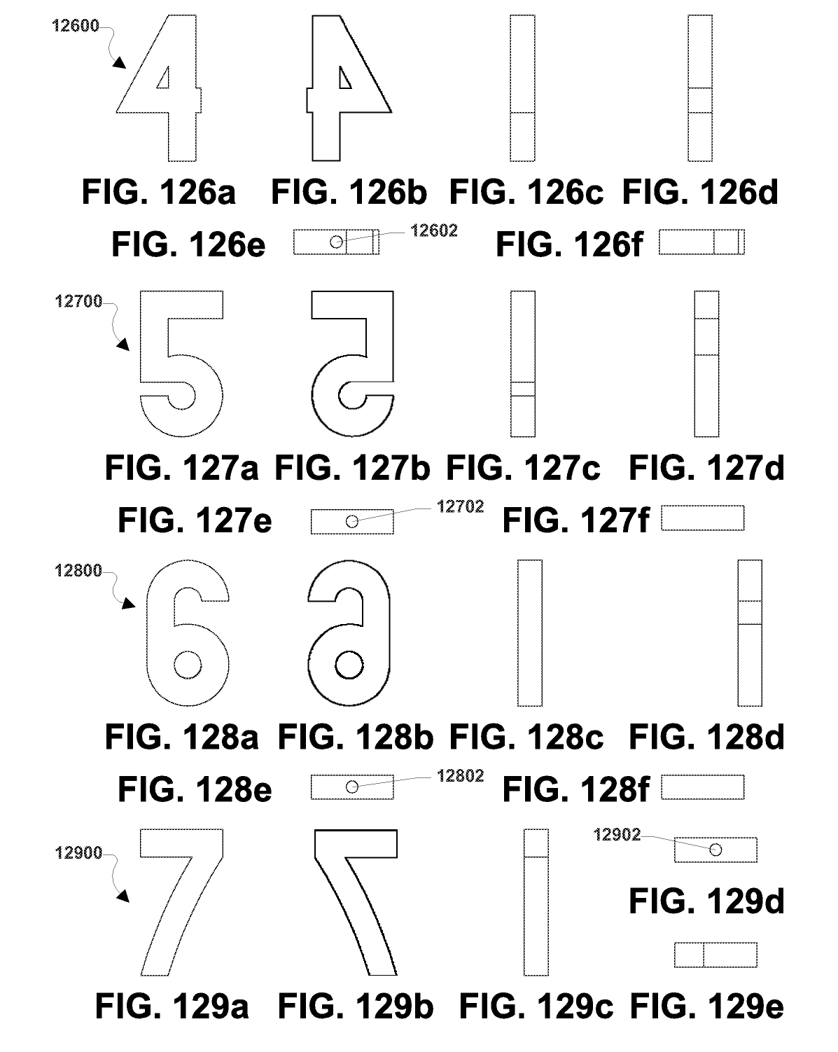

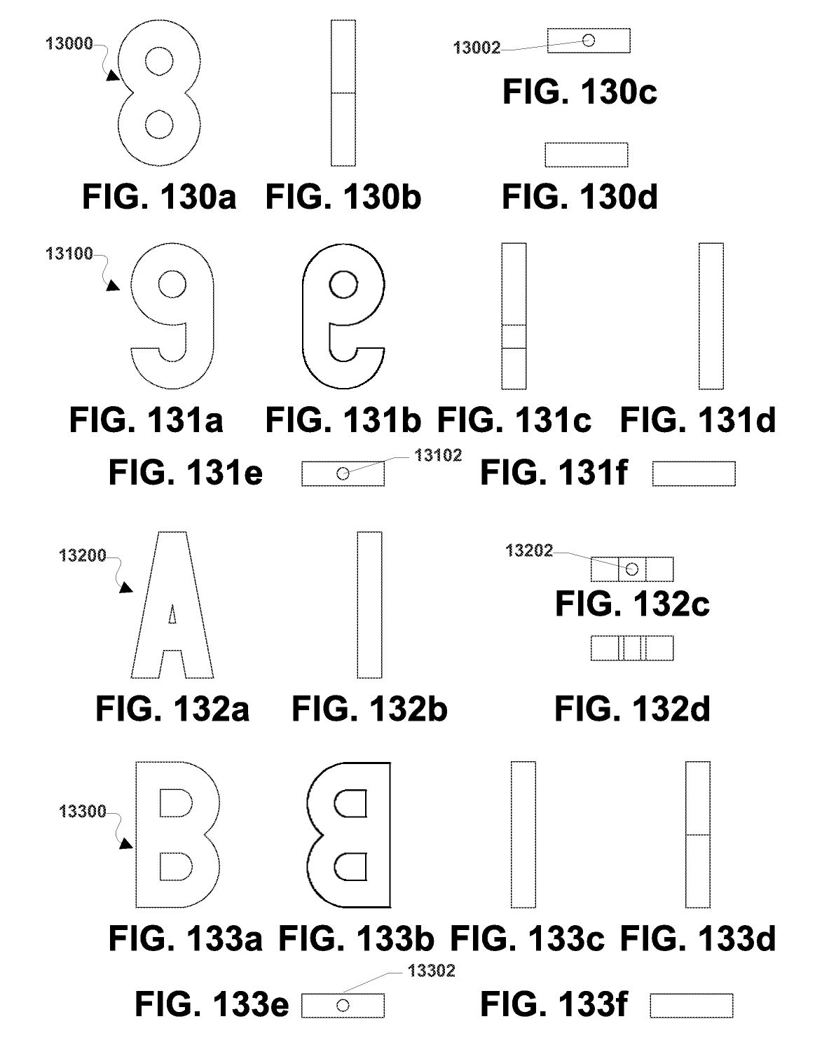

FIG. 130a is a front/rear plan view of an end piece 13000 shaped like the number eight. FIG. 130b is a left/right side plan view, FIG. 130c is a top plan view, and FIG. 130d is a bottom plan view of the end piece 13000. The end piece 13000 can include a bore 13002

FIG. 131a is a front plan view of an end piece 13100 shaped like the number nine. FIG. 131b is a rear plan view, FIG. 131c is a left side plan view, FIG. 131d is a right side plan view, FIG. 131e is a top plan view, and FIG. 131f is a bottom plan view of the end piece 13100. The number-shaped end piece 13100 can include a bore 13102.

FIG. 132a is a front/rear plan view of an end piece 13200 shaped like the letter A. FIG. 132b is a left/right side plan view. FIG. 132c is a top plan view, and FIG. 132d is a bottom plan view of the end piece 13200. The letter-shaped end piece 13200 can include a bore 13202.

FIG. 133a is a front plan view of an end piece 13300 shaped like the letter B. FIG. 133b is a rear plan view, FIG. 133c is a left side plan view, FIG. 133d is a right side plan view. FIG. 133e is a top plan view, and FIG. 133f is a bottom plan view of the end piece 13300. The letter-shaped end piece 13300 can include a bore 13302.

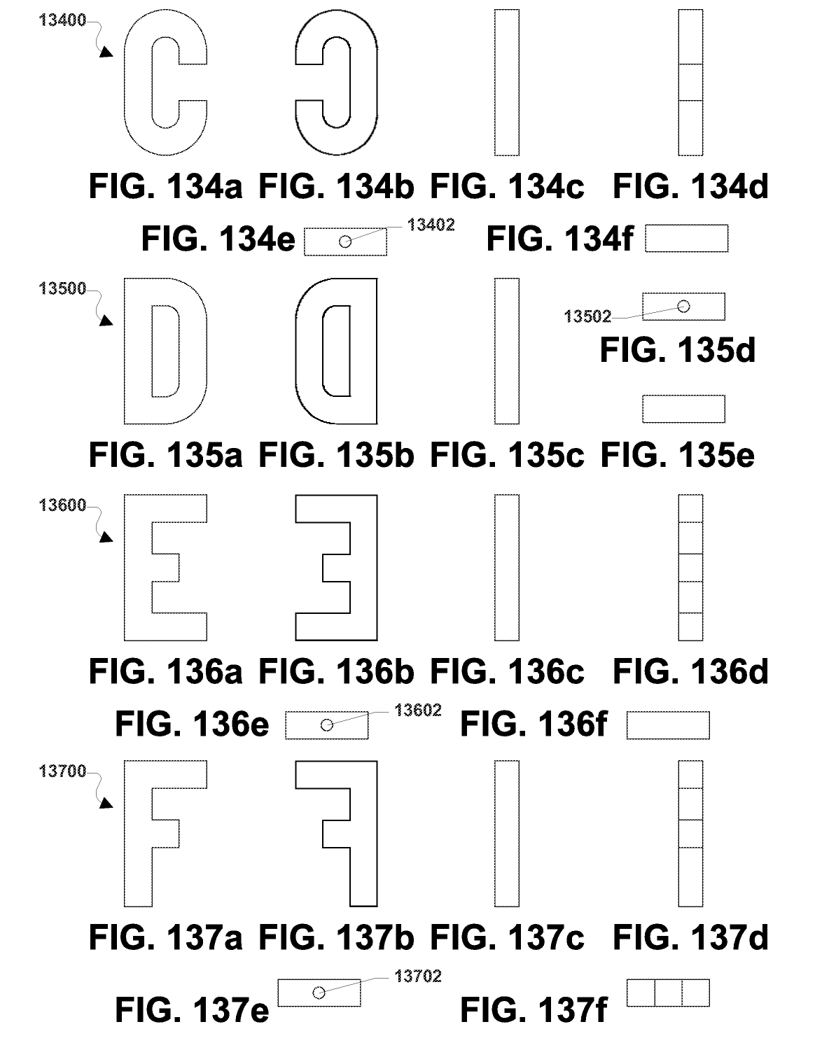

FIG. 134a is a front plan view of an end piece 13400 shaped like the letter C. FIG. 134b is a rear plan view, FIG. 134c is a left side plan view, FIG. 134d is a right side plan view, FIG. 134c is a top plan view, and FIG. 134f is a bottom plan view of the end piece 13400. The letter-shaped end piece 13400 can include a bore 13402.

FIG. 135a is a front plan view of an end piece 13500 shaped like the letter D. FIG. 135b is a rear plan view, FIG. 135c is a left side plan view. FIG. 135d is a right side plan view, FIG. 135e is a top plan view, and FIG. 135f is a bottom plan view of the end piece 13500. The letter-shaped end piece 13500 can include a bore 13502.

FIG. 136a is a front plan view of an end piece 13600 shaped like the letter E. FIG. 136b is a rear plan view, FIG. 136c is a left side plan view, and FIG. 136d is a right side plan view. FIG. 136e is a top plan view, and FIG. 136f is a bottom plan view of the end piece 13600. The letter-shaped end piece 13600 can include a bore 13602.

FIG. 137a is a front plan view of an end piece 13700 shaped like the letter F. FIG. 137b is a rear plan view, FIG. 137c is a left side plan view, FIG. 137d is a right side plan view. FIG. 137e is a top plan view, and FIG. 137f is a bottom plan view of the end piece 13700. The end piece 13700 can include a bore 13702 formed therein.

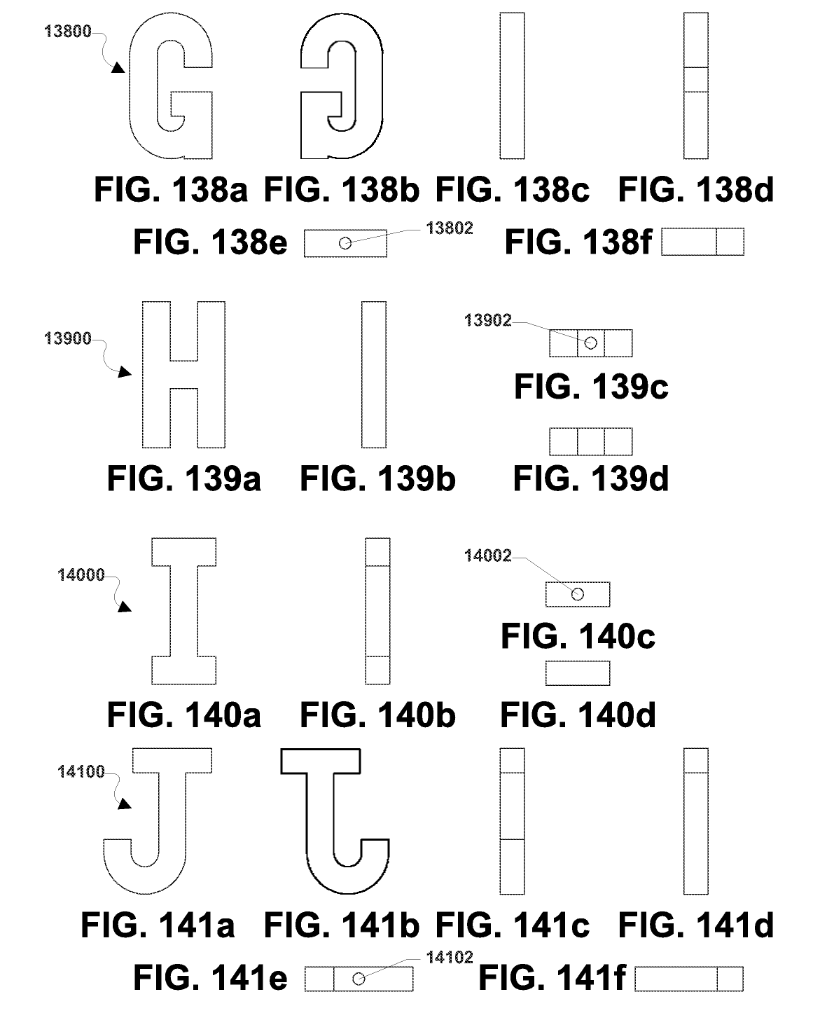

FIG. 138a is a front plan view of an end piece 13800 shaped like the letter G. FIG. 138b is a rear plan view, FIG. 138c is a left side plan view. FIG. 138d is a right side plan view, FIG. 138e is a top plan view, and FIG. 138f is a bottom plan view of the end piece 13800. The letter-shaped end piece 13800 can include a bore 13802.

FIG. 139a is a front/rear plan view of an end piece 13900 shaped like the letter H. FIG. 139b is a left/right side plan view. FIG. 13c is a top plan view, and FIG. 139d is a bottom plan view of the end piece 13900. The letter-shaped end piece 13900 can include a bore 13902.

FIG. 140a is a front/rear plan view of an end piece 14000 shaped like the letter I. FIG. 140b is a left/right side plan view, FIG. 140c is a top plan view, and FIG. 140d is a bottom plan view of the end piece 14000. The letter-shaped end piece 14000 can include a bore 14002.

FIG. 141a is a front plan view of an end piece 14100 shaped like the letter J. FIG. 141b is a rear plan view, FIG. 141c is a left side plan view, FIG. 141d is a right side plan view, FIG. 141e is a top plan view, and FIG. 141f is a bottom plan view of the end piece 14100. The letter-shaped end piece 14100 can include a bore 14102.

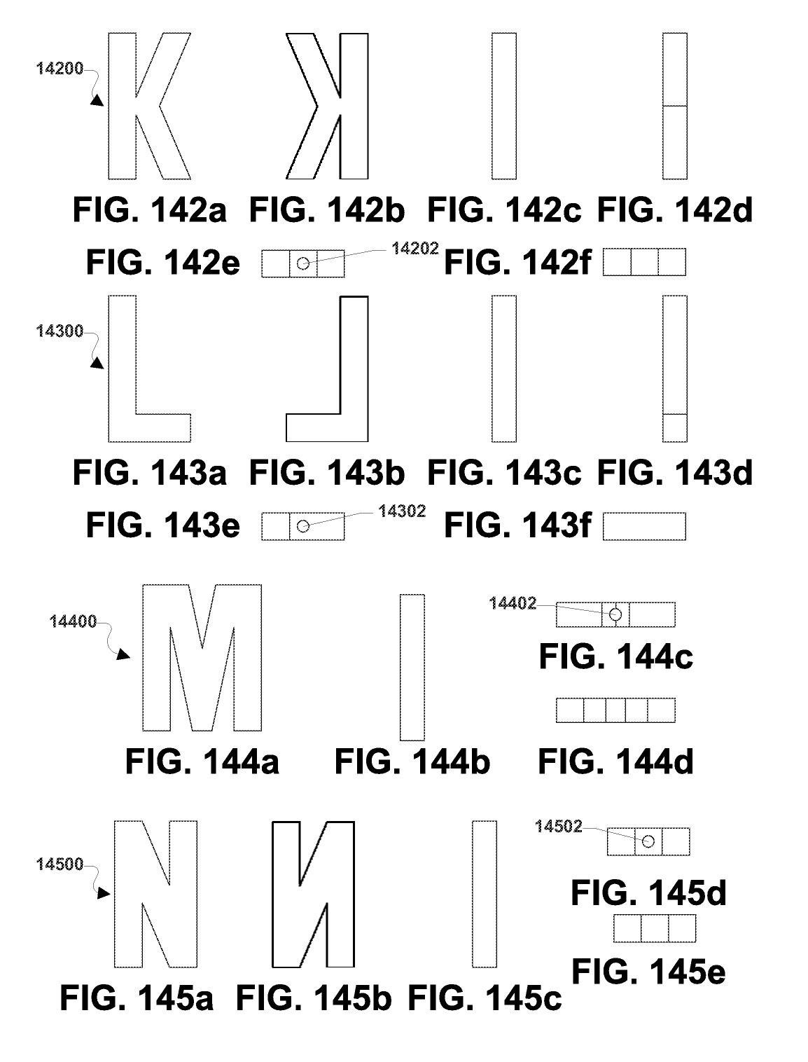

FIG. 142a is a front plan view of an end piece 14200 shaped like the letter K. FIG. 142h is a rear plan view, FIG. 142c is a left side plan view. FIG. 142d is a right side plan view, FIG. 142e is a top plan view, and FIG. 142f is a bottom plan view of the end piece 14200. The letter-shaped end piece 14200 can include a bore 14202 therein.

FIG. 143a is a front plan view of an end piece 14300 shaped like the letter L. FIG. 143b is a rear plan view, FIG. 143c is a left side plan view, FIG. 143d is a right side plan view. FIG. 143c is a top plan view, and FIG. 143f is a bottom plan view of the end piece 14300. The end piece 14300 can include a bore 14302 formed therein.

FIG. 144a is a front/rear plan view of an end piece 14400 shaped like the letter M. FIG. 144b is a left/right side plan view, FIG. 144c is a top plan view, and FIG. 144d is a bottom plan view of the end piece 14400. The letter-shaped end piece 14400 can include a bore 14402.

FIG. 145a is a front plan view of an end piece 14500 shaped like the letter N. FIG. 145b is a rear plan view, FIG. 145c is a left side plan view. FIG. 145d is a right side plan view, FIG. 145e is a top plan view, and FIG. 145f is a bottom plan view of the end piece 14500. The end piece 14500 can include a bore 14502 formed therein.

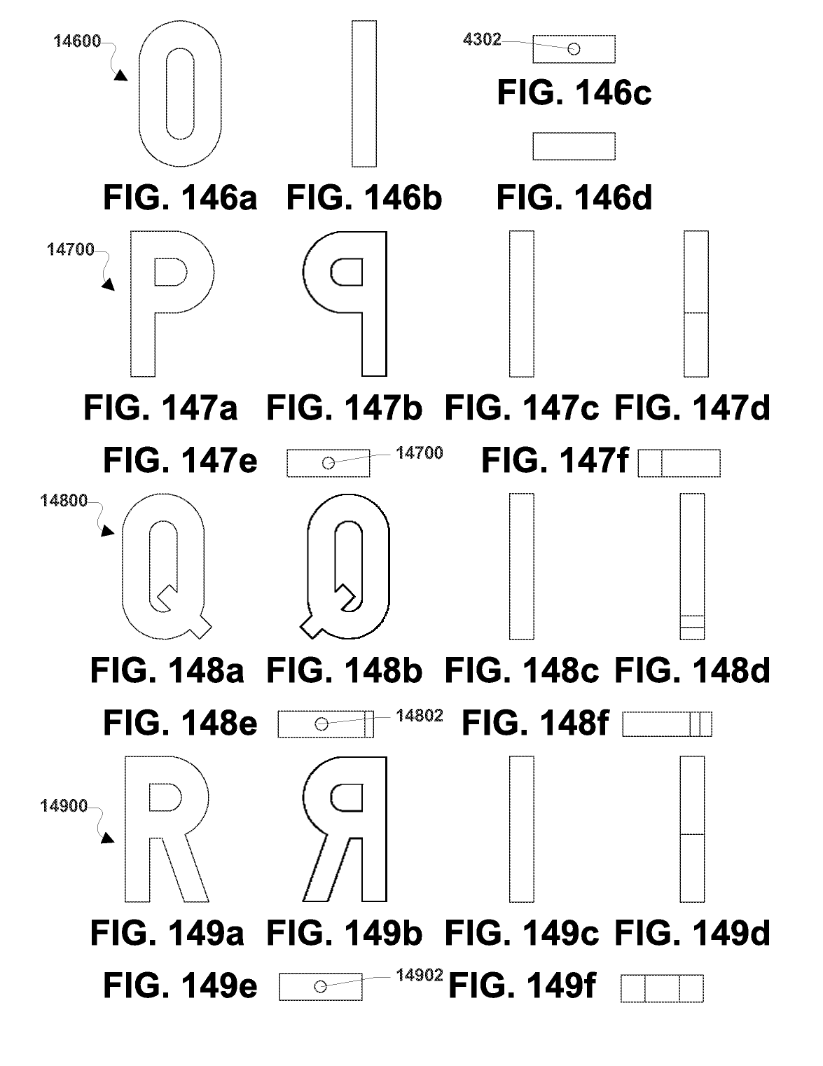

FIG. 146a is a front/rear plan view of an end piece 14600 shaped like the letter O. FIG. 146b is a left/right side plan view. FIG. 146c is a top plan view, and FIG. 146d is a bottom plan view of the end piece 14600. The letter-shaped end piece 14600 can include a bore 14602.

FIG. 147a is a front plan view of an end piece 14700 shaped like the letter P. FIG. 147b is a rear plan view, FIG. 147c is a left side plan view, FIG. 147d is a right side plan view. FIG. 147e is a top plan view, and FIG. 147f is a bottom plan view of the end piece 14700. The end piece 14700 can include a bore 14702 formed therein.

FIG. 148a is a front plan view of an end piece 14800 shaped like the letter Q. FIG. 148b is a rear plan view, FIG. 148c is a left side plan view, FIG. 148d is a right side plan view, FIG. 148e is a top plan view, and FIG. 148f is a bottom plan view of the end piece 14800. The end piece 14800 can include a bore 14802 formed therein.

FIG. 149a is a front plan view of an end piece 14900 shaped like the letter R. FIG. 149b is a rear plan view, FIG. 149c is a left side plan view. FIG. 149d is a right side plan view, FIG. 149e is a top plan view, and FIG. 149f is a bottom plan view of the end piece 14900. The letter-shaped end piece 14900 can include a bore 14902.

FIG. 150a is a front plan view of an end piece 15000 shaped like the letter S. FIG. 150b is a rear plan view, FIG. 150c is a left side plan view, FIG. 150d is a right side plan view, FIG. 150e is a top plan view, and FIG. 150f is a bottom plan view of the end piece 15000. The end piece 15000 can include a bore 15002 formed therein.

FIG. 151a is a front/rear plan view of an end piece 15100 shaped like the letter T. FIG. 151b is a left/right side plan view, FIG. 151c is a top plan view, and FIG. 151d is a bottom plan view of the end piece 15100. The letter-shaped end piece 15100 can include a bore 15102.

FIG. 152a is a front/rear plan view of an end piece 15200 shaped like the letter U. FIG. 152b is a left/right side plan view. FIG. 152c is a top plan view, and FIG. 152d is a bottom plan view of the end piece 15200. The letter-shaped end piece 15200 can include a bore 15202.

FIG. 153a is a front/rear plan view of an end piece 15300 shaped like the letter V. FIG. 153b is a left/right side plan view. FIG. 153c is a top plan view, and FIG. 153d is a bottom plan view of the end piece 15300. The letter-shaped end piece 15300 can include a bore 15302.

FIG. 154a is a front/rear plan view of an end piece 15400 shaped like the letter W. FIG. 154b is a left/right side plan view, FIG. 154c is a top plan view, and FIG. 154d is a bottom plan view of the end piece 15400. The letter-shaped end piece 15400 can include a bore 15402.

FIG. 155a is a front/rear plan view of an end piece 15500 shaped like the letter X. FIG. 155b is a left/right side plan view, FIG. 155c is a top plan view, and FIG. 155d is a bottom plan view of the end piece 15500. The letter-shaped end piece 15500 can include a bore 15502.

FIG. 156a is a front/rear plan view of an end piece 15600 shaped like the letter Y. FIG. 156b is a left/right side plan view. FIG. 156c is a top plan view, and FIG. 156d is a bottom plan view of the end piece 15600. The letter-shaped end piece 15600 can include a bore 15602.

FIG. 157a is a front plan view of an end piece 15700 shaped like the letter Z. FIG. 157b is a rear plan view, FIG. 157c is a left side plan view, FIG. 157d is a right side plan view. FIG. 157e is a top plan view, and FIG. 157f is a bottom plan view of the end piece 15700. The end piece 15700 can include a bore 15702 formed therein.

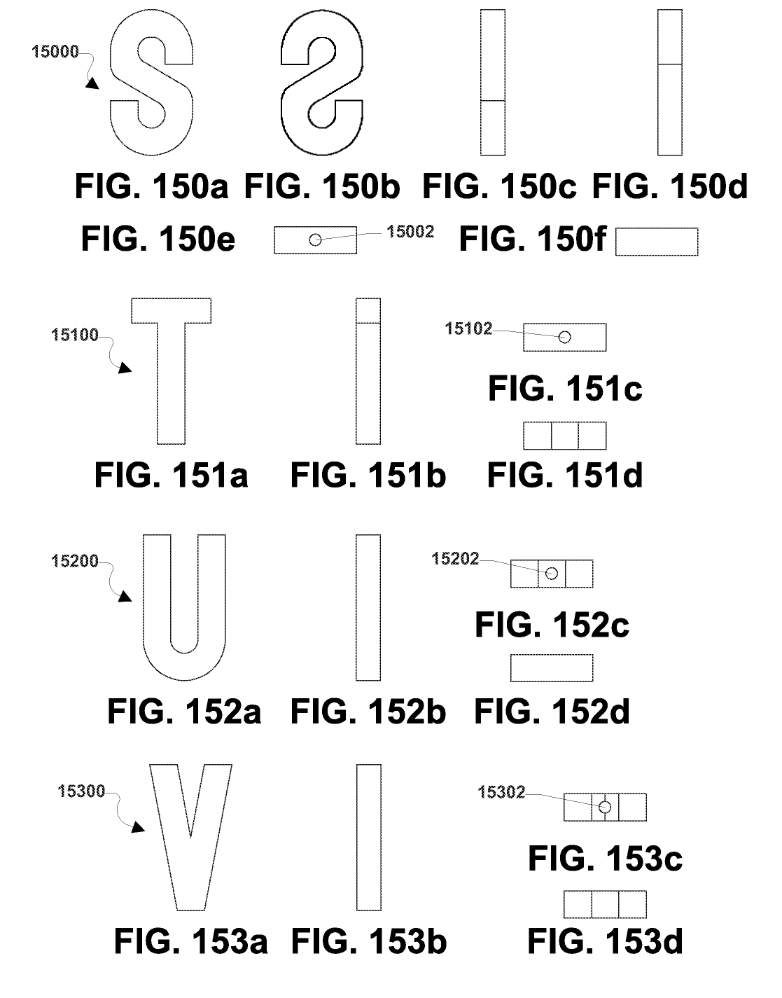

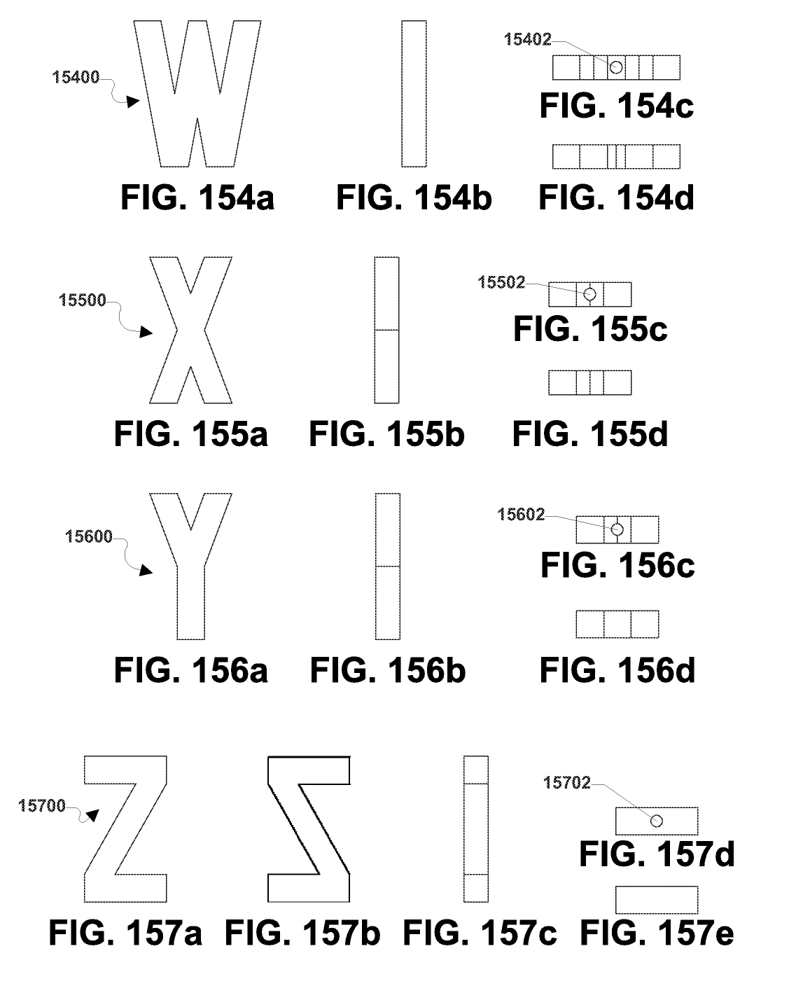

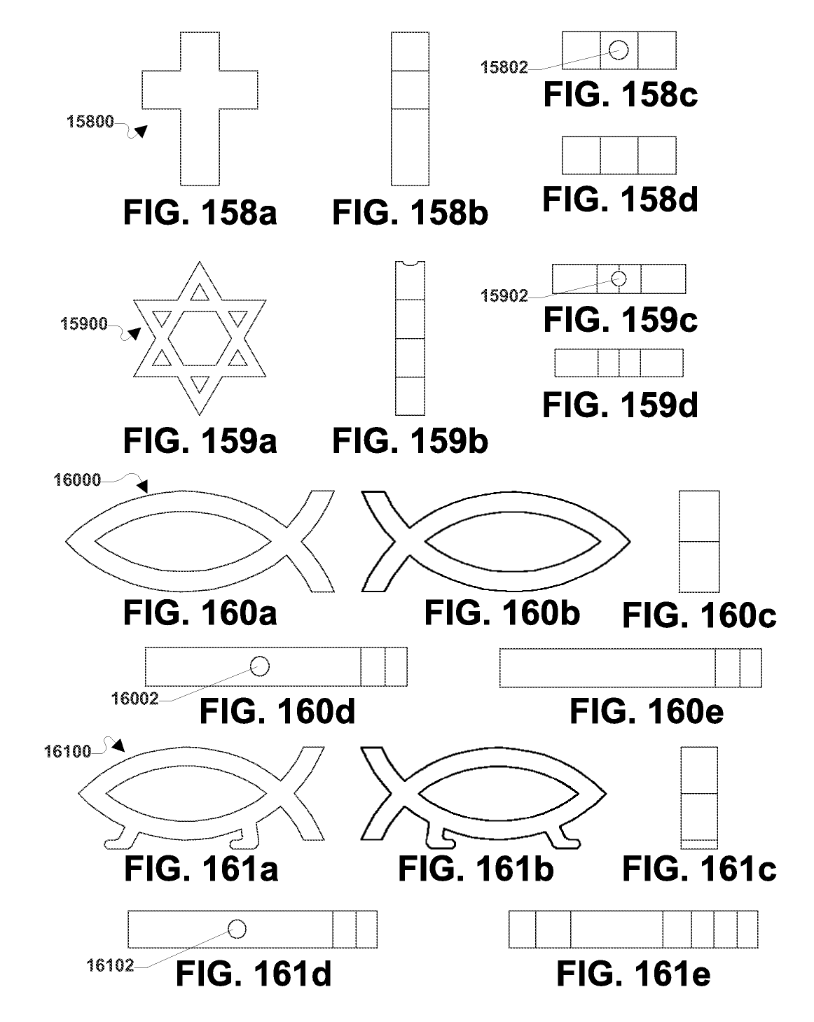

FIG. 158a is a front/rear plan view of an end piece 15800 shaped like a cross. FIG. 158b is a left/right side plan view.

FIG. 158c is a top plan view, and FIG. 158d is a bottom plan view of the end piece 15800. The cross-shaped end piece 15800 can include a bore 15802

FIG. 159a is a front/rear plan view of an end piece 15900 shaped like a star of David. FIG. 159b is a left/right side plan view. FIG. 159c is a top plan view, and FIG. 159d is a bottom plan view of the end piece 15900. As illustrated, the end piece 15900 can include a bore 15902.

FIG. 160a is a front plan view of an end piece 16000 shaped like an Ichthys. FIG. 160b is a rear plan view, FIG. 160c is a left/right side plan view, FIG. 160d is a top plan view, and FIG. 160e is a bottom plan view of the end piece 16000. As depicted, the Ichthys-shaped end piece 16000 can include a bore 16002.

FIG. 161a is a front plan view of an end piece 16100 shaped like a modified Ichthys. FIG. 161b is a rear plan view, FIG. 161c is a left/right side plan view. FIG. 161d is a top plan view, and FIG. 161e is a bottom plan view of the end piece 16100. As depicted, the modified Ichthys-shaped end piece 16100 can include a bore 16102.

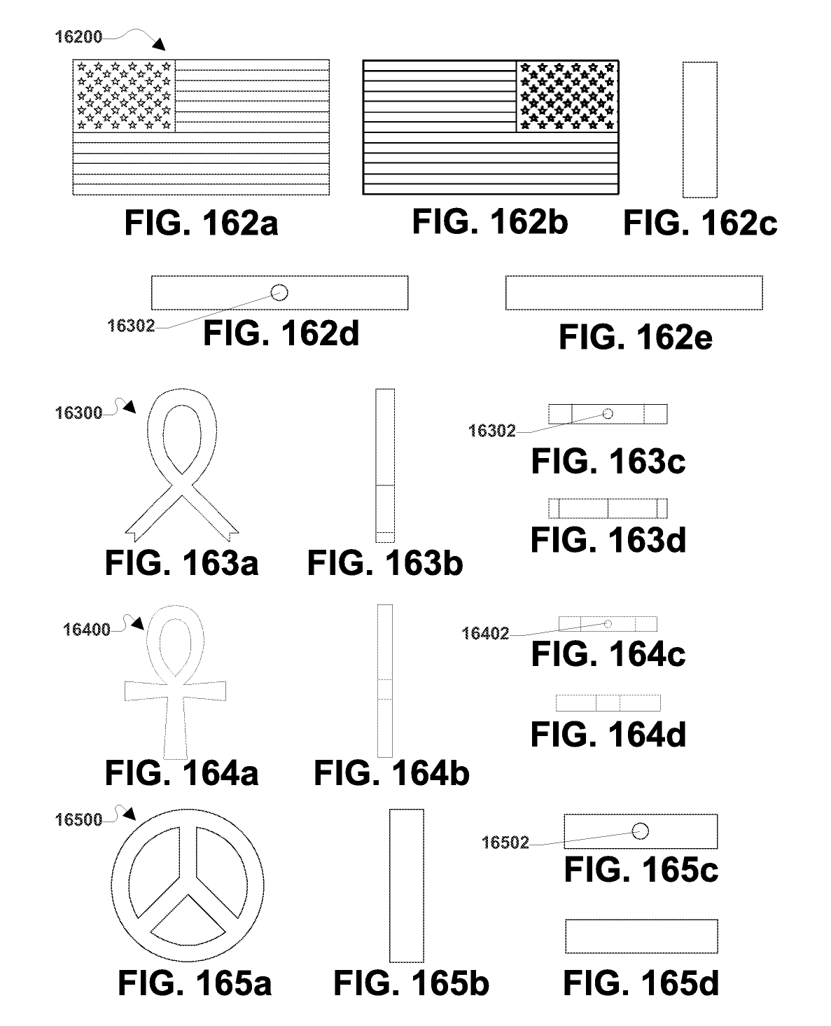

FIG. 162a is a front plan view of an end piece 16200 shaped like a flag, e.g., a U.S. flag. FIG. 162b is a rear plan view, FIG. 162c is a left/right side plan view, FIG. 162d is a top plan view, and FIG. 162e is a bottom plan view of the end piece 16200. As depicted, the flag-shaped end piece 16200 can include a bore 16202.

FIG. 163a is a front/rear plan view of an end piece 16300 shaped like a ribbon. FIG. 163b is a left/right side plan view.

FIG. 163c is a top plan view, and FIG. 163d is a bottom plan view of the end piece 16300. The ribbon-shaped end piece 16300 can include a bore 16302.

FIG. 164a is a front/rear plan view of an end piece 16400 shaped like an Ankh. FIG. 164b is a left/right side plan view, FIG. 164c is a top plan view, and FIG. 164d is a bottom plan view of the end piece 16400. The Ankh-shaped end piece 16400 can include a bore 16402.

FIG. 165a is a front/rear plan view of an end piece 16500 shaped like a peace symbol. FIG. 165b is a left/right side plan view, FIG. 165c is a top plan view, and FIG. 165d is a bottom plan view of the end piece 16500. As illustrated, the end piece 16500 can include a bore 16502.

FIG. 166a is a front plan view of an end piece 16600 shaped like a first hamsa. FIG. 16b is a rear plan view, FIG. 166c is a left side plan view, FIG. 165d is a right side plan view, FIG. 165e is a top plan view, and FIG. 166f is a bottom plan view of the end piece 16600. The hamsa-shaped end piece 16600 can include a bore 16602.

FIG. 167a is a front/rear plan view of an end piece 16700 shaped like a second hamsa. FIG. 167b is a left/right side plan view, FIG. 167c is a top plan view, and FIG. 167d is a bottom plan view of the end piece 16700. The hamsa-shaped end piece 16700 can include a bore 16702.

FIG. 168a is a front/rear plan view of an end piece 16800 shaped like a trinity. FIG. 168b is a left/right side plan view, FIG. 168c is a top plan view, and FIG. 168d is a bottom plan view of the end piece 16800. As depicted, the trinity-shaped end piece 16800 can include a bore 16802 formed therein.

FIG. 169a is a front/rear plan view of an end piece 16900 shaped like a star. FIG. 169b is a left/right side plan view, FIG. 169c is a top plan view, and FIG. 169d is a bottom plan view of the end piece 16900. As depicted, the star-shaped end piece 16900 can include a bore 16902 formed therein.

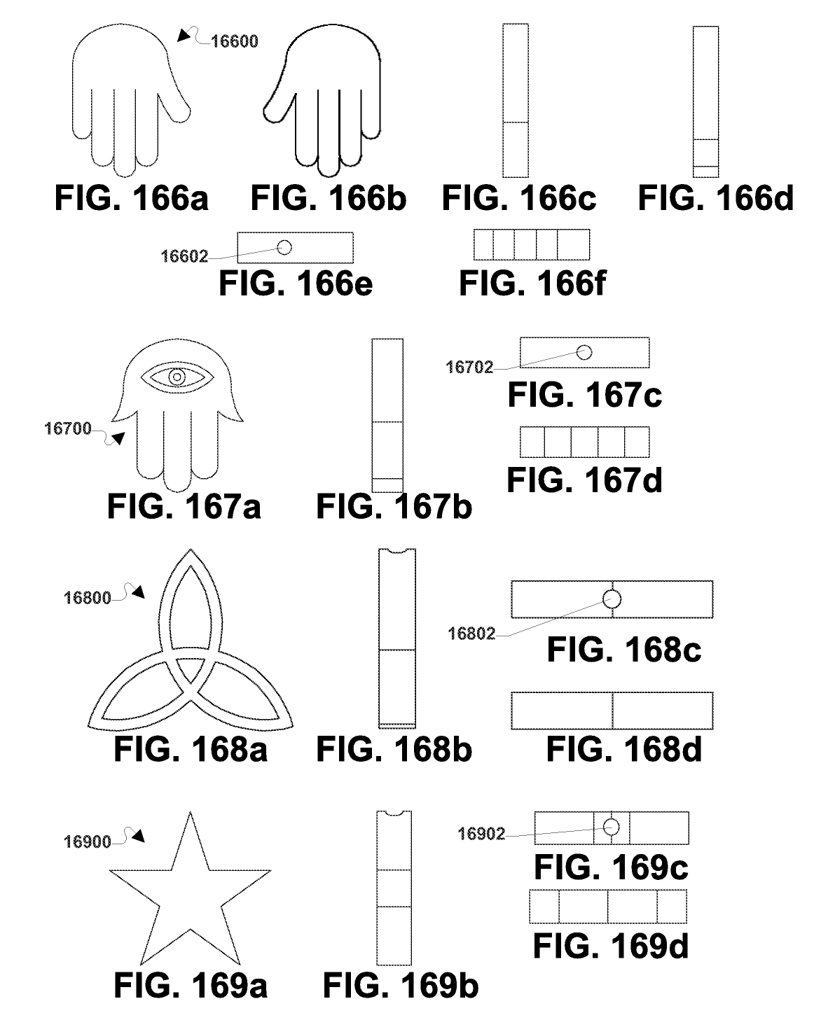

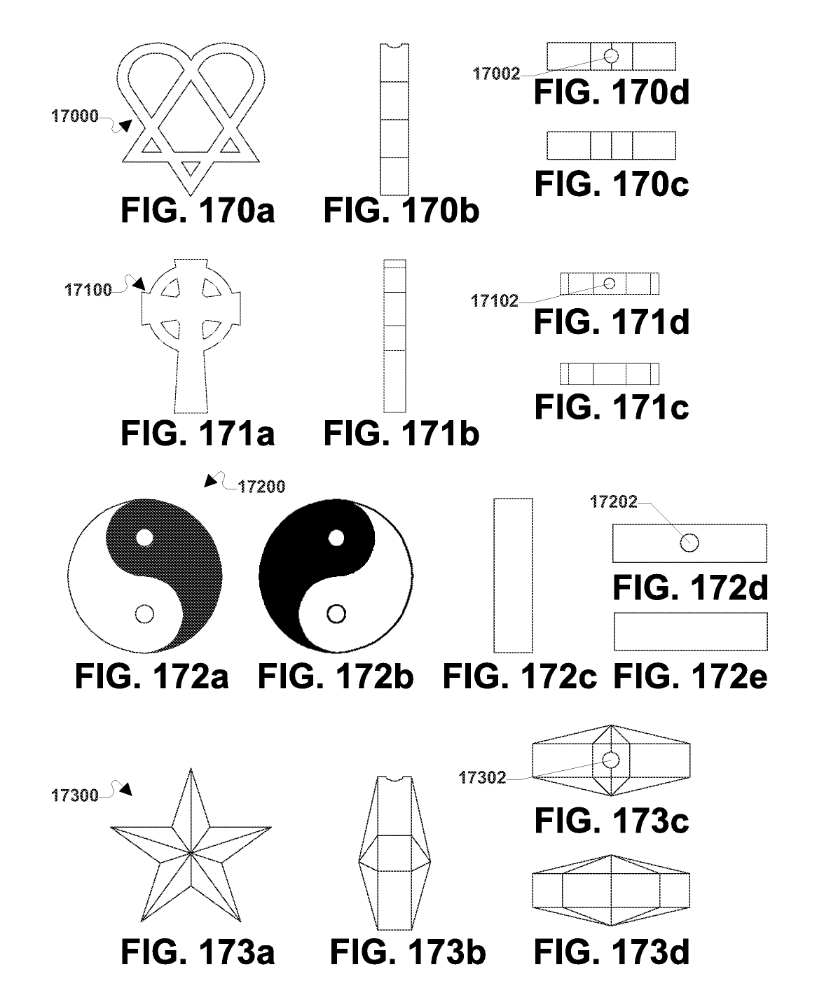

FIG. 170a is a front/rear plan view of an end piece 17000 shaped like a heartagram. FIG. 170b is a left/right side plan view. FIG. 170c is a top plan view, and FIG. 170d is a bottom plan view of the end piece 17000. As depicted, the heartagram-shaped end piece 16900 can include a bore 17002.

FIG. 171a is a front/rear plan view of an end piece 17100 shaped like a Celtic cross. FIG. 171b is a left/right side plan view, FIG. 171c is a top plan view, and FIG. 171d is a bottom plan view of the end piece 17100. As illustrated, the cross-shaped end piece 17100 can include a bore 17102 formed therein.

FIG. 172a is a front plan view of an end piece 17200 shaped like a Yin-Yang symbol. FIG. 172b is a rear plan view. FIG. 172c is a left/right side plan view. FIG. 172d is a top plan view, and FIG. 172e is a bottom plan view of the end piece 17200. The end piece 17200 can include a bore 17202.

FIG. 173a is a front/rear plan view of another end piece 17300 shaped like a star. FIG. 173b is a left/right side plan view. FIG. 173c is a top plan view, and FIG. 173d is a bottom plan view of the end piece 17300. As illustrated, the star-shaped end piece 17300 can include a bore 17302 formed therein.

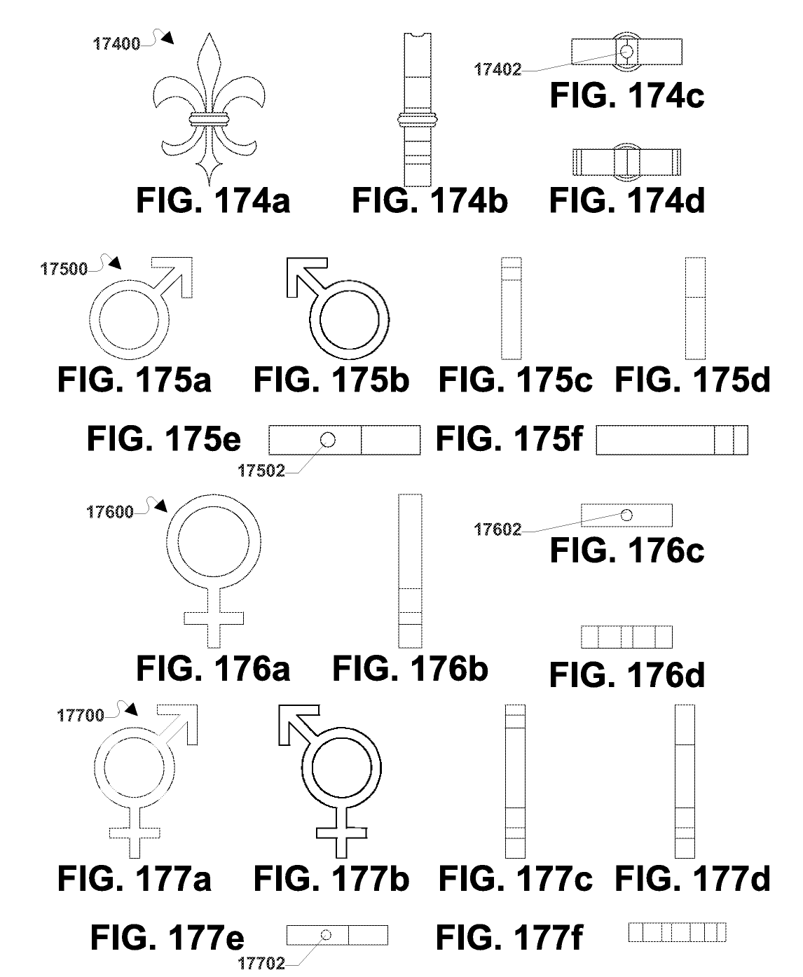

FIG. 174a is a front/rear plan view of another end piece 17400 shaped like a fleur-de-lis FIG. 174b is a left/right side plan view, FIG. 174c is a top plan view, and FIG. 174d is a bottom plan view of the end piece 17400. As illustrated, the fleur-de-lis-shaped end piece 17400 can include a bore 17402 therein.

FIG. 175a is a front plan view of another end piece 17500 shaped like a male gender symbol. FIG. 175b is a rear plan view, FIG. 175c is a left side plan view, FIG. 175d is a right side plan view, FIG. 175e is a top plan view, and FIG. 175f is a bottom plan view of the end piece 17500. The end piece 17500 can include a bore 17502 therein.

FIG. 176a is a front/rear plan view of another end piece 17600 shaped like a female gender symbol. FIG. 176b is a left/right side plan view, FIG. 176c is a top plan view, and FIG. 176d is a bottom plan view of the end piece 17600. As illustrated, the end piece 17600 can include a bore 17602 therein.

FIG. 177a is a front plan view of another end piece 17700 shaped like a transgender symbol. FIG. 177b is a rear plan view. FIG. 177c is a left side plan view, FIG. 177d is a right side plan view. FIG. 177e is a top plan view, and FIG. 177f is a bottom plan view of the end piece 17700. The end piece 17700 can include a bore 17702 therein.

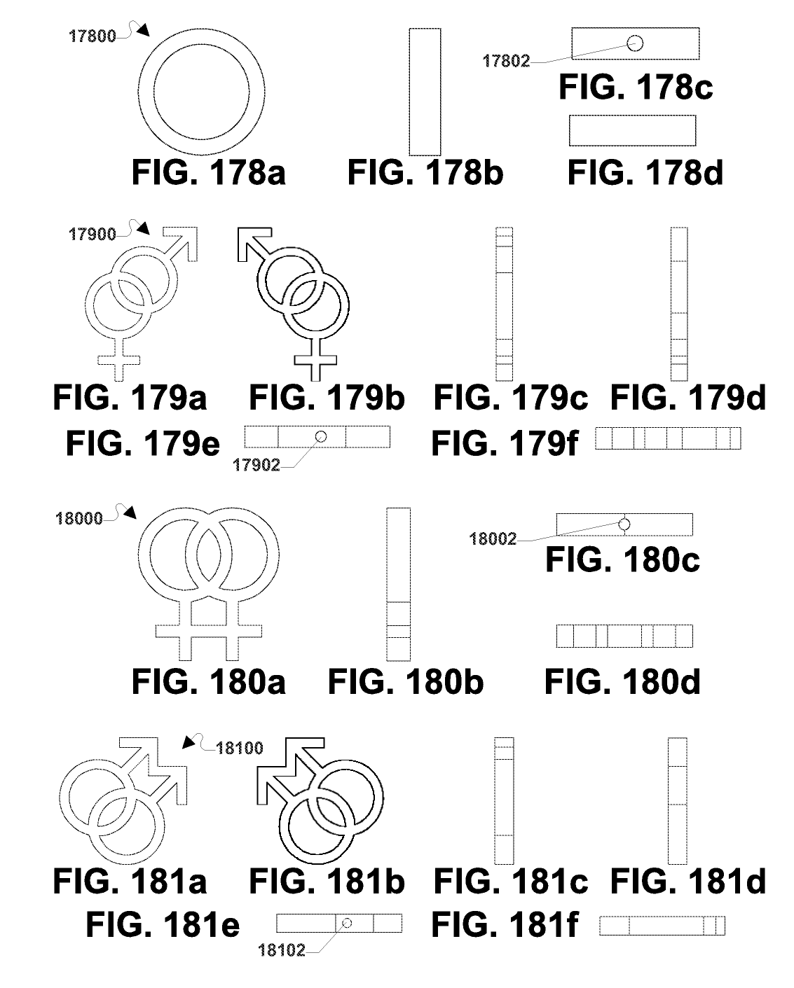

FIG. 178a is a front/rear plan view of another end piece 17800 shaped like a neutral gender symbol. FIG. 178b is a left/right side plan view, FIG. 178c is a top plan view, and FIG. 178d is a bottom plan view of the end piece 17800. As illustrated, the end piece 17800 can include a bore 17802 therein.

FIG. 179a is a front plan view of another end piece 17900 shaped like a heterosexual male/female symbol. FIG. 179b is a rear plan view, FIG. 179c is a left side plan view. FIG. 179d is a right side plan view, FIG. 179e is a top plan view, and FIG. 179f is a bottom plan view. The end piece 17900 can include a bore 17902 therein.

FIG. 180a is a front/rear plan view of another end piece 18000 shaped like a homosexual female symbol. FIG. 180b a left/right side plan view, FIG. 180c is a top plan view, and FIG. 180d is a bottom plan view of the end piece 18000. As depicted, the end piece 18000 can include a bore 18002 therein.

FIG. 181a is a front plan view of another end piece 18100 shaped like a homosexual male symbol. FIG. 181b is a rear plan view, FIG. 181c is a left side plan view, FIG. 181d is a right side plan view, FIG. 181e is a top plan view, and FIG. 181f is a bottom plan view. The end piece 18100 can include a bore 18102 therein.

FIG. 182a is a front/rear plan view of another end piece 18200 shaped like another cross. FIG. 182b a left/right side plan view, FIG. 182c is a top plan view, and FIG. 182d is a bottom plan view of the end piece 18200. As depicted, the cross-shaped end piece 18200 can include a bore 18202 therein.

FIG. 183a is a front/rear plan view of another end piece 18300 shaped like yet another cross. FIG. 183b a left/right side plan view, FIG. 183c is a top plan view, and FIG. 183d is a bottom plan view of the end piece 18300. As depicted, the cross-shaped end piece 18300 can include a bore 18302 therein.

FIG. 184a is a front/rear plan view of another end piece 18400 shaped like another cross. FIG. 184b a left/right side plan view, FIG. 184c is a top plan view, and FIG. 184d is a bottom plan view of the end piece 18400. As depicted, the cross-shaped end piece 18400 can include a bore 18402 therein.

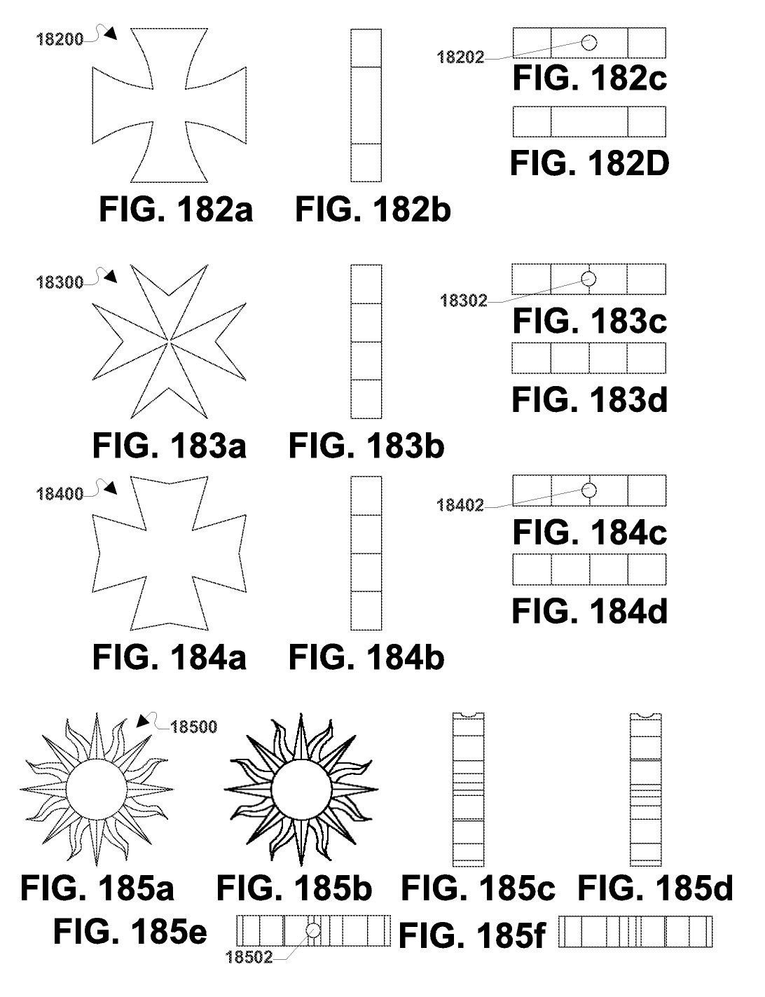

FIG. 185a is a front plan view of another end piece 18500 shaped like a sun. FIG. 185b is a rear plan view, FIG. 185c is a left side plan view, FIG. 185d is a right side plan view. FIG. 185e is a top plan view, and FIG. 185^{f} is a bottom plan view of the end piece 18500. The end piece 18500 can include a bore 18502 therein.

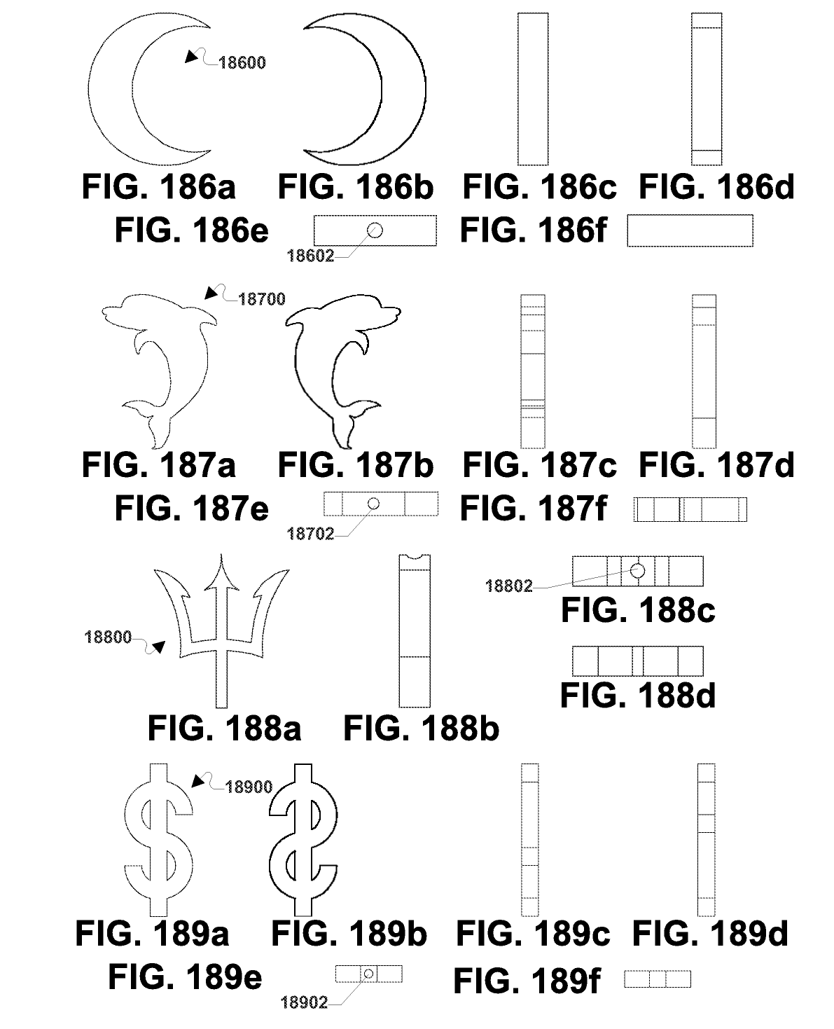

FIG. 186a is a front plan view of another end piece 18600 shaped like a moon. FIG. 186b is a rear plan view, FIG. 186c is a left side plan view, FIG. 186d is a right side plan view. FIG. 186e is a top plan view, and FIG. 186f is a bottom plan view of the end piece 18600. The end piece 18600 can include a bore 18602 therein.

FIG. 187a is a front plan view of another end piece 18700 shaped like a dolphin. FIG. 187b is a rear plan view, FIG. 187c is a left side plan view, FIG. 187d is a right side plan view, FIG. 187e is a top plan view, and FIG. 187f is a bottom plan view of the end piece 18700. The end piece 18700 can include a bore 18702 therein.

FIG. 188a is a front/rear plan view of another end piece 18800 shaped like a trident. FIG. 188b is a left/right side plan view. FIG. 188c is a top plan view, and FIG. 188d is a bottom plan view of the end piece 18800. As depicted, the trident-shaped end piece 18800 can include a bore 18802 therein.

FIG. 189a is a front plan view of another end piece 18900 shaped like a dollar sign. FIG. 189b is a rear plan view, FIG. 189c is a left side plan view. FIG. 189d is a right side plan view of the end piece 18900, FIG. 189e is a top plan view, and FIG. 189f is a bottom plan view. The end piece 18900 can include a bore 18902 formed therein.

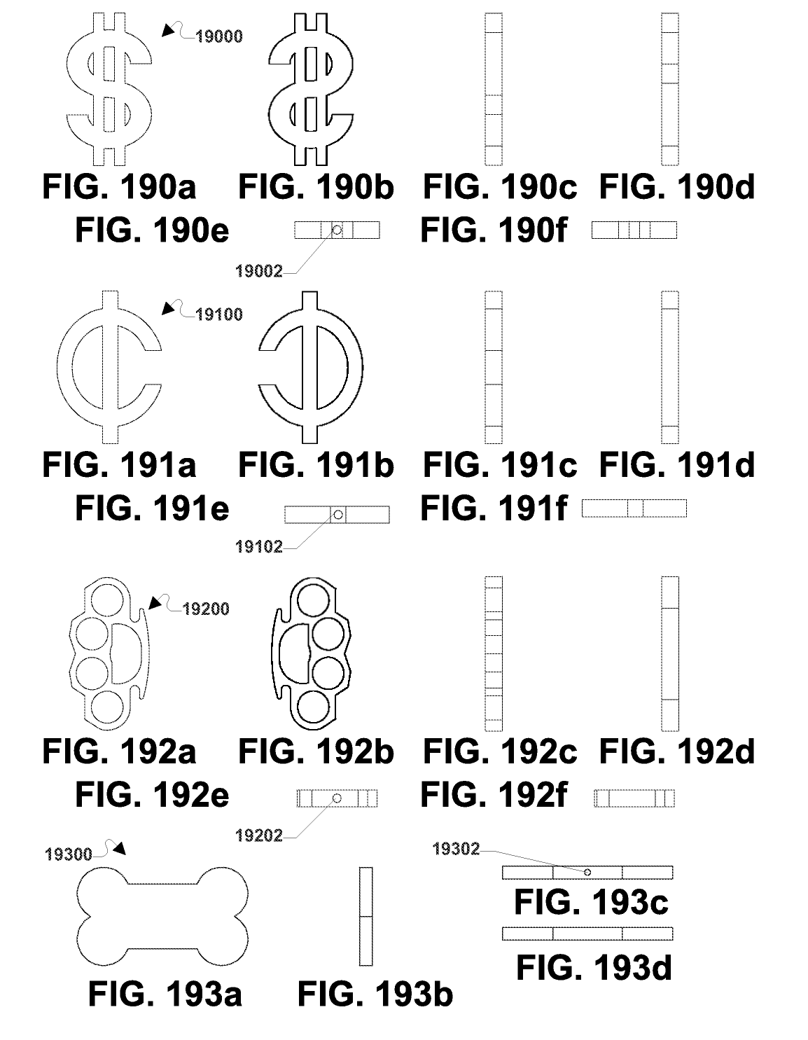

FIG. 190a is a front plan view of another end piece 19000 shaped like another dollar sign. FIG. 190b is a rear plan view, FIG. 190c is a left side plan view, FIG. 190d is a right side plan view of the end piece 19000, FIG. 190e is a top plan view, and FIG. 190f is a bottom plan view. The end piece 19000 can include a bore 19002 formed therein.

FIG. 191a is a front plan view of another end piece 19100 shaped like a cents sign. FIG. 191b is a rear plan view, FIG. 191c is a left side plan view, FIG. 191d is a right side plan view of the end piece 19100, FIG. 191e is a top plan view, and FIG. 191f is a bottom plan view. The end piece 19100 can include a bore 19102 formed therein.

FIG. 192a is a front plan view of another end piece 19200 shaped like brass knuckles FIG. 192b is a rear plan view, FIG. 192c is a left side plan view, FIG. 192d is a right side plan view of the end piece 19200, FIG. 192e is a top plan view, and FIG. 192f is a bottom plan view. The end piece 19200 can include a bore 19202 formed therein.

FIG. 193a is a front/rear plan view of another end piece 19300 shaped like a dog bone. FIG. 193b is a left/right side plan view, FIG. 193c is a top plan view, and FIG. 193d is a bottom plan view of the end piece 19300. The end piece 19300 can include a bore 19302 formed therein.

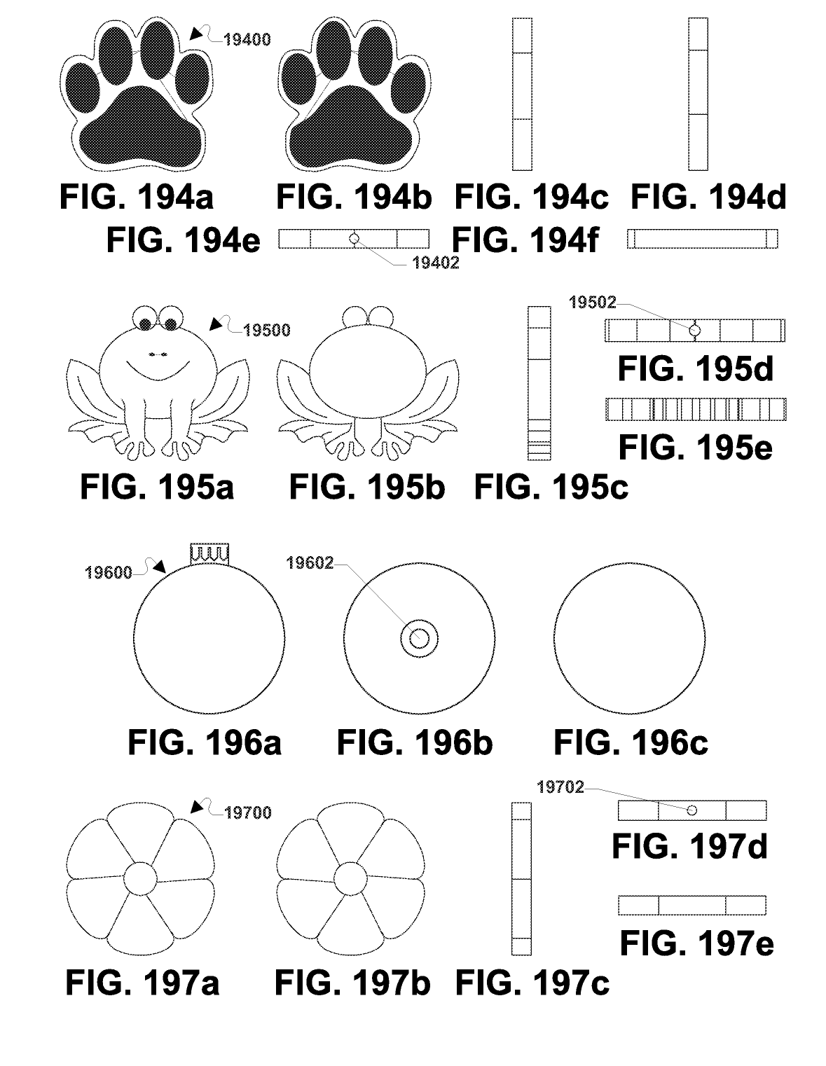

FIG. 194a is a front plan view of another end piece 19400 shaped like an animal paw. FIG. 194b is a rear plan view, FIG. 194c is a left side plan view. FIG. 194d is a right side plan view of the end piece 19400, FIG. 194e is a top plan view, and FIG. 194f is a bottom plan view. The end piece 19400 can include a bore 19402 formed therein.

FIG. 195a is a front plan view of another end piece 19500 shaped like a frog. FIG. 195b is a rear plan view. FIG. 195c is a left side plan view. FIG. 195d is a left/right side plan view of the end piece 19500, FIG. 195d is a top plan view, and FIG. 195e is a bottom plan view. The end piece 19500 can include a bore 19502 formed therein.

FIG. 196a is a front/rear/left/right side plan view of another end piece 19600 shaped like a Christmas tree ornament. FIG. 196b is a top plan view and FIG. 196c is a bottom plan view. The end piece 19600 can include a bore 19602 formed therein.

FIG. 197a is a front plan view of another end piece 19700 shaped like a flower. FIG. 197b is a rear plan view, FIG. 197c is a left side plan view. FIG. 197d is a left/right side plan view of the end piece 19700, FIG. 197d is a top plan view, and FIG. 197e is a bottom plan view. The end piece 19700 can include a bore 19702 formed therein.

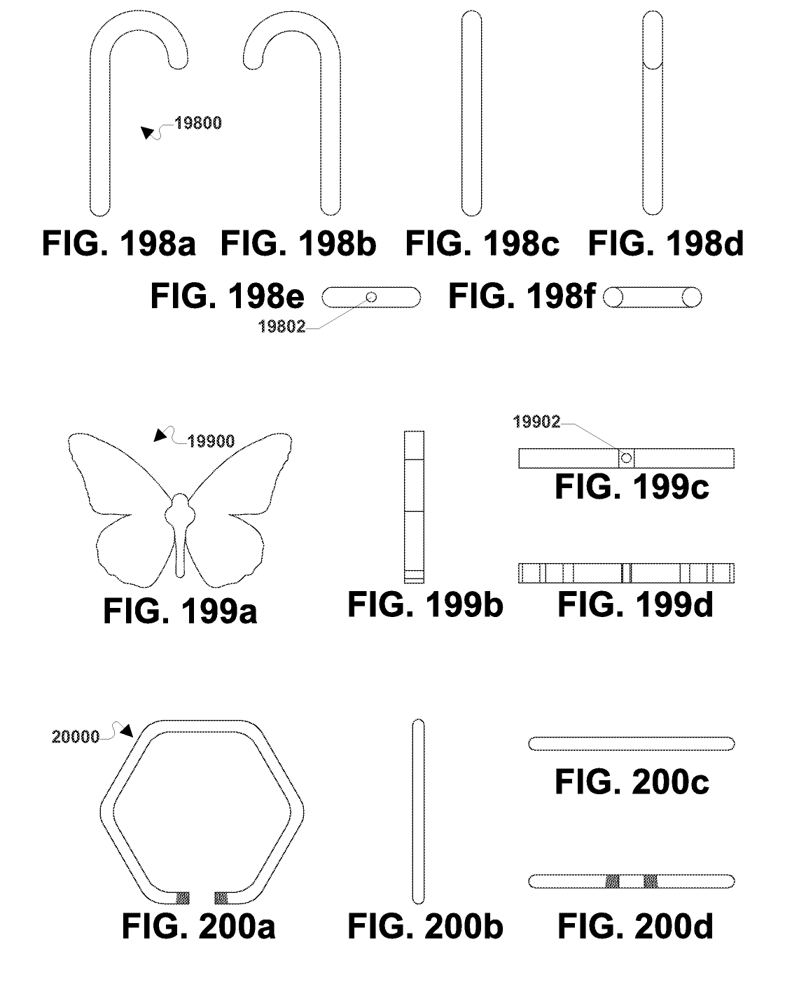

FIG. 198a is a front plan view of another end piece 19800 shaped like a candy cane. FIG. 198b is a rear plan view, FIG. 198c is a left side plan view, FIG. 198d is a right side plan view of the end piece 19800, FIG. 198e is a top plan view, and FIG. 198f is a bottom plan view. The end piece 19800 can include a bore 19802 formed therein.

FIG. 199a is a front/rear plan view of another end piece 19900 shaped like a butterfly. FIG. 199b is a left/right side plan view, FIG. 199c is a top plan view, and FIG. 199d is a bottom plan view of the end piece 19900. The end piece 19900 can include a bore 19902 formed therein.

Each of the end pieces described herein can include a bore. The bore can be formed in a front, a rear, a left side, a right side, a bottom, or a top of the end piece. Further, the bore can extend through a center of the front, the rear, the left side, the right side, the bottom, or the top of the end piece. In other aspects, the bore can be distanced, or offset, from the center of the front, the rear, the left side, the right side, the bottom, or the top of the end piece. Moreover, the bore can extend partially through the end piece or completely through the end piece from the front to the rear, from the top to the bottom, or from the left side to the right side. Still further, the bore can be angled with respect to the front, the rear, the left side, the bottom, or the top of the end piece. Each of the end pieces described herein may be installed on any of the exhaust pipe tethers described herein. Further, in each of the embodiments that include multiple end pieces, different end pieces may be installed thereon.

Referring now to FIG. 200a through FIG. 210f, several additional bodies are illustrated and can be used with one or more of the end pieces described herein to form an exhaust pipe tether that can be used to secure a dog leash to a motor vehicle.

FIG. 200a is a front plan view of a generally hexagonal body 20000. FIG. 200b is a left/right side plan view, FIG. 200c is a top plan view, and FIG. 200d is a bottom plan view of the body 20000. One end piece can be installed on the body 20000.

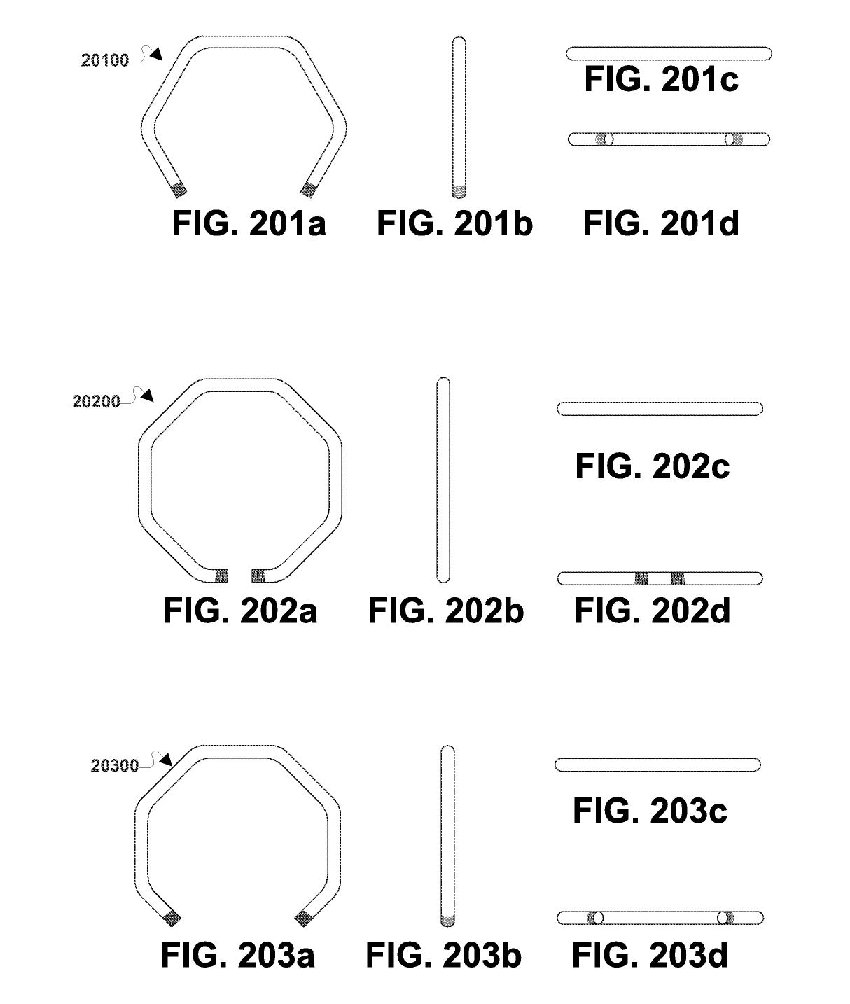

FIG. 201a is a front plan view of another hexagonal body 20100. FIG. 201b is a left/right side plan view, FIG. 201c is a top plan view, and FIG. 201d is a bottom plan view of the body 20100. Two end pieces can be installed on the body 20100.

FIG. 202a is a front plan view of a generally octagonal body 20200. FIG. 202h is a left/right side plan view, FIG. 202c is a top plan view, and FIG. 202d is a bottom plan view of the body 20200. One end piece can be installed on the body 20200.

FIG. 203a is a front plan view of another octagonal body 20300. FIG. 203b is a left/right side plan view, FIG. 203c is a top plan view, and FIG. 203d is a bottom plan view of the body 20300. Two end pieces can be installed on the body 20300.

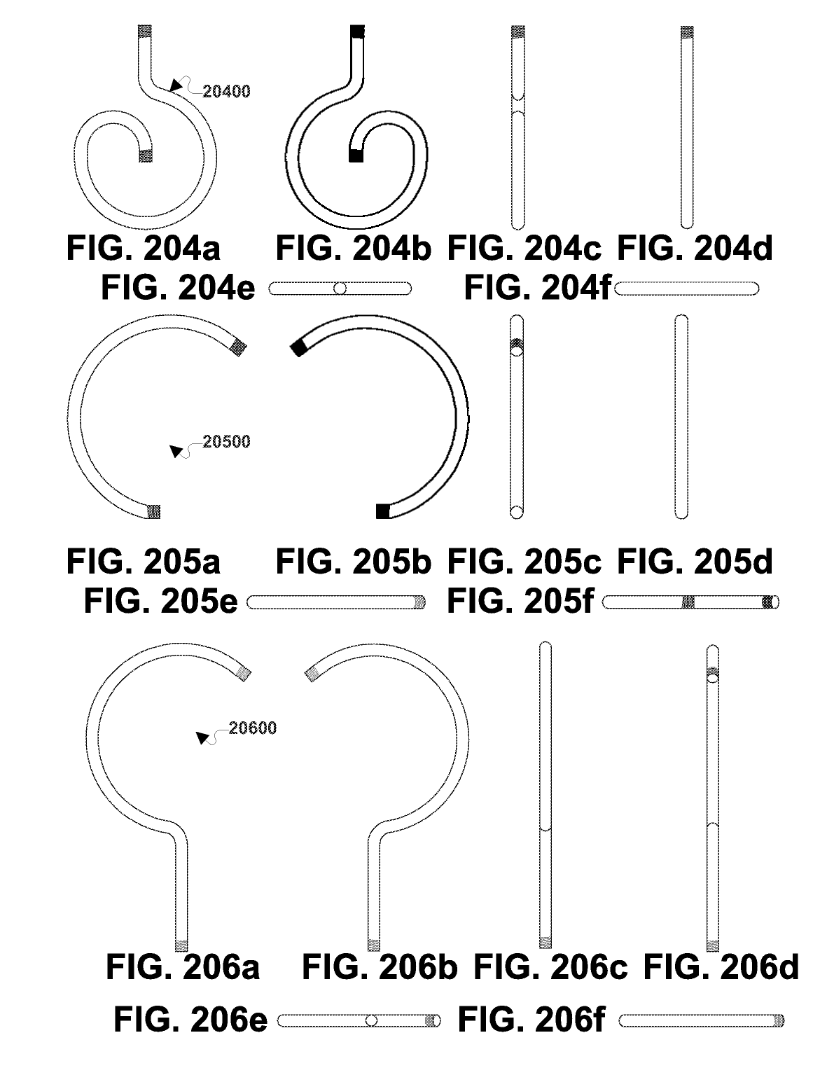

FIG. 204a is a front plan view of a body 20400 shaped as illustrated. FIG. 204b is a rear plan view, FIG. 204c is a left side plan view. FIG. 204d is a right side plan view, FIG. 204e is a top plan view, and FIG. 204df is a bottom plan view of the body 20400. Two end pieces can be installed on the body 20400. Moreover, in this aspect, the body 20400 can extend into, but not through, an exhaust tip and an end piece can be installed on the body within the exhaust tip. The body 20400 can hang vertically from a hole, or bore, formed through a bottom of the exhaust tip along a central axis of the exhaust tip.

FIG. 205a is a front plan view of a partial ring shaped body 20500. FIG. 205b is a rear plan view, FIG. 205c is a left side plan view, FIG. 205d is a right side plan view. FIG. 205e is a top plan view, and FIG. 205df is a bottom plan view of the body 20500. Two end pieces can be installed on the body 20500. One end piece can be adjacent to an outer wall of an exhaust tip and the other end piece can be distanced from the exhaust tip and can lie along a central axis of the exhaust tip.

FIG. 206a is a front plan view of a question mark shaped body 20600. FIG. 206b is a rear plan view, FIG. 206c is a left side plan view, FIG. 206d is a right side plan view, FIG. 206e is a top plan view, and FIG. 206df is a bottom plan view of the body 20600. Two end pieces can be installed on the body 20600. One end piece can be adjacent to an outer wall of an exhaust tip and the other end piece can be distanced from the exhaust tip and can lie along a central axis of the exhaust tip.

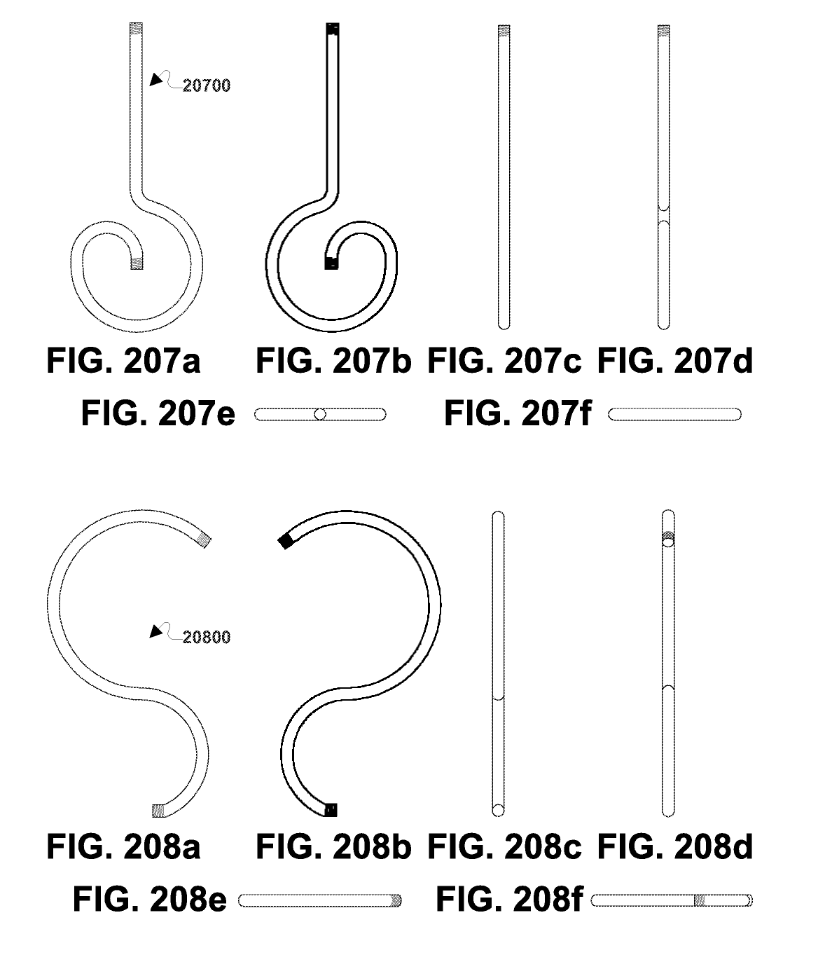

FIG. 207a is a front plan view of a body 20700 shaped as illustrated FIG. 207b is a rear plan view, FIG. 207c is a left side plan view, FIG. 207d is a right side plan view, FIG. 207e is a top plan view, and FIG. 207df is a bottom plan view of the body 20700. Two end pieces can be installed on the body 20700. Moreover, in this aspect, the body 20700 can extend vertically through an exhaust tip.

FIG. 208a is a front plan view of a partial S shaped body 20800. FIG. 208b is a rear plan view, FIG. 208c is a left side plan view, FIG. 208d is a right side plan view, FIG. 208e is a top plan view, and FIG. 208df is a bottom plan view of the body 20800. Two end pieces can be installed on the body 20800. One end piece can be adjacent to an outer wall of an exhaust tip and the other end piece can be distanced from the exhaust tip and can lie along a central axis of the exhaust tip.

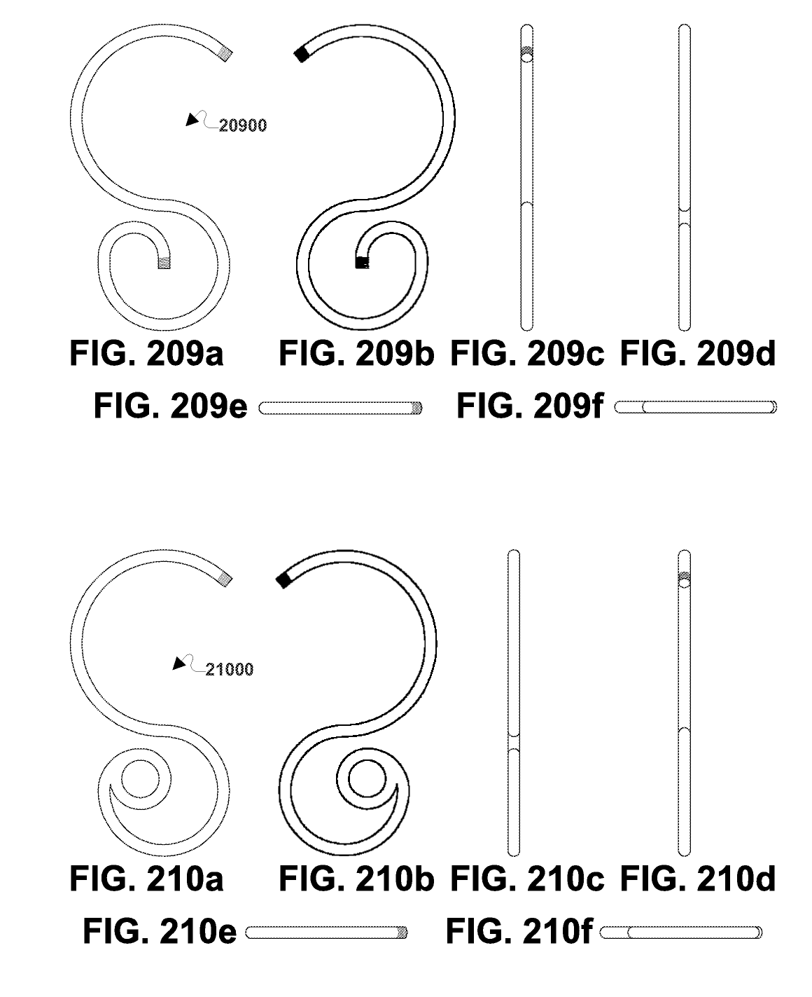

FIG. 209a is a front plan view of an extended S shaped body 20900. FIG. 209b is a rear plan view, FIG. 209c is a left side plan view, FIG. 209d is a right side plan view, FIG. 209e is a top plan view, and FIG. 209df is a bottom plan view of the body 20900. Two end pieces can be installed on the body 20900. One end piece can be adjacent to an outer wall of an exhaust tip and the other end piece can be distanced from the exhaust tip and can lie along a central axis of the exhaust tip.

FIG. 210a is a front plan view of another extended S shaped body 21000. FIG. 210b is a rear plan view, FIG. 210c is a left side plan view, FIG. 210d is a right side plan view, FIG. 210e is a top plan view, and FIG. 210df is a bottom plan view of the body 19600. One end piece can be installed on the body 21000 and that single end can be adjacent to an outer wall of an exhaust tip.

In other aspects, the exhaust pipe tethers described herein can be installed in other locations on a motor vehicle and can still be used to tether a leash thereto. For example, an exhaust pipe tether can be installed through a fender, a bumper, a driver's side mirror house, a passenger's side mirror housing, a hood, a truck, or through some other location on the vehicle.

The above-disclosed subject matter is to be considered illustrative, and not restrictive, and the appended claims are intended to cover all such modifications, enhancements, and other embodiments, which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

In addition, in the foregoing Detailed Description, various features can be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter can be directed to less than all features of any of the disclosed embodiments. Thus, the following claims are incorporated into the Detailed Description, with each claim standing on its own as defining separately claimed subject matter.

What is claimed is:

1. An exhaust pipe tether, the exhaust pipe tether comprising:
a body defining a first end and a second end; and
at least one end piece removably engaged with at least one of the first and second ends;
wherein the body comprises a dimension, d_{b}, measured through a longest portion of the body along a central axis or through a widest portion of the body along an axis perpendicular to the central axis, and d_{b} is ≧0.5 dₑₓ,
wherein dₑₓ is an exhaust pipe dimension measured through a longest portion of a cross-section of the exhaust pipe along a central axis or through a widest portion of a cross-section of the exhaust pipe along an axis perpendicular to the central axis.

2. The exhaust pipe tether according to claim 1, wherein d_{b}≦4.0 dₑₓ.

3. The exhaust pipe tether according to claim 1, wherein the body includes a cross-sectional dimension, d_{csb}, and d_{csb}>tₑₓ, tₑₓ is a thickness of an outer wall of an exhaust pipe.

4. The exhaust pipe tether according to claim 3, wherein d_{csb}≧2 tₑₓ.

5. The exhaust pipe tether according to claim 4, wherein d_{csb}≦64 tₑₓ.

6. The exhaust pipe tether according to claim 1, wherein the body includes a cross-sectional dimension, d_{csb}, and the end piece comprises a cross-sectional dimension, dₑₚ, and dₑₚ≧d_{csb}.

7. The exhaust pipe tether according to claim 6, wherein dₑₚ≧1.33 d_{b}.

8. The exhaust pipe tether according to claim 7, wherein dₑₚ≦8 d_{csb}.

9. The exhaust pipe tether according to claim 1, wherein the body includes a core and an outer coating disposed on the core.

10. The exhaust pipe tether according to claim 9, wherein the outer coating on the body comprises a metal coating, a polymer coating, a ceramic coating, or a vitreous coating.

11. The exhaust pipe tether according to claim 1, wherein the at least one end piece comprises a core and an outer coating disposed on the core.

12. The exhaust pipe tether according to claim 1, wherein the outer coating on the end piece comprises a metal coating, a polymer coating, a ceramic coating, or a vitreous coating.

13. An exhaust pipe tether, the exhaust pipe tether comprising:
a body defining a first end and a second end, wherein the body includes a core and an outer coating disposed on the core and the body includes a cross-sectional dimension, d_{csb}; and
at least one end piece removably engaged with at least one of the first and second ends, wherein the end piece includes a core and an outer coating on the core and wherein the end piece comprises a cross-sectional dimension, dₑₚ, and dₑₚ>d_{csb}.

14. An exhaust tip assembly for an exhaust pipe, the exhaust tip assembly comprising,
an exhaust tip having an outer wall formed with at least one bore, wherein the exhaust tip includes an exhaust tip dimension, dₑₓ, measured through a longest portion of a cross-section of the exhaust tip along a central axis or through a widest portion of a cross-section of the exhaust tip along an axis perpendicular to the central axis; and
an exhaust pipe tether extending through the bore in the exhaust tip, wherein the exhaust pipe tether comprises a body defining a first end and a second end and at least one end piece removably engaged with at least one of the first and second ends, wherein the body comprises a dimension, d_{b}, measured through a longest portion of the body along a central axis or through a widest portion of the body along an axis perpendicular to the central axis, and d_{b} is ≧0.5 dₑₓ.

15. The exhaust tip assembly according to claim 14, further comprising a grommet installed within the bore between the outer wall of the exhaust tip and the exhaust pipe tether.

16. The exhaust tip assembly according to claim 15, wherein the grommet comprises a polymer.

17. The exhaust tip assembly according to claim 16, wherein the polymer comprises a high temperature silicone.

18. The exhaust tip assembly according to claim 14, wherein the exhaust pipe tether is installed substantially parallel to a long axis of the exhaust tip assembly.

19. The exhaust tip assembly according to claim 14, wherein the exhaust pipe tether is installed substantially perpendicular to a long axis of the exhaust tip assembly.

20. The exhaust tip assembly according to claim 14, wherein the body includes a cross-sectional dimension, d_{csb}, and the outer wall of the exhaust tip comprises a thickness, tₑₓ, and d_{csb}>tₑₓ.
